(19) United States
(12) Patent Application Publication
(10) Pub. No.: US 2005/0222942 A1
(43) Pub. Date: Oct. 6, 2005

(54) Management of tasks required of trade subcontractors in the construction industry

(76) Inventors: Donald Stanley Pheil, San Mateo, CA (US); Patrick Eugene Finucane, Tracy, CA (US)

Correspondence Address: ALTERA LAW GROUP, LLC, 6500 CITY WEST PARKWAY, SUITE 100, MINNEAPOLIS, MN, 55344-7704, US

(21) Appl. No.: 11/095,966

(22) Filed: Mar. 31, 2005

Related U.S. Application Data
(60) Provisional application No. 60/558,646, filed on Mar. 31, 2004.

(51) Int. Cl. G06F 17/60

(52) U.S. Cl. 705/37; 705/28

(57) ABSTRACT

The management of tasks required of trade subcontractors in the construction industry data base is performed comprehensively, quickly, and with little opportunity for error or omission by the use of a novel method, preferably implemented by computer. A method, user interface, computer program, and system are described that makes as much project information available as quickly as possible to those working within a subcontractor's office, and that provides a flexible workflow process to allow for the seemingly endless possibilities and variations of demands placed on a subcontractor.

### CROSS-REFERENCE TO RELATED APPLICATIONS

This application claims the benefit of U.S. Provisional Application No. 60/558,646 filed Mar. 31, 2004 (Donald S. Pheil and Patrick E. Finucane, Management of tasks required of trade subcontractors in the construction industry), which is hereby incorporated herein in its entirety by reference thereto.

### BACKGROUND OF THE INVENTION

1. Field of the Invention

The present invention relates to the construction industry, and more particularly to managing tasks required of trade subcontractors in the construction industry.

2. Description of the Related Art

Trade subcontractors in the construction industry, such as plumbers and electricians, face a unique challenge dealing with a variety of demands placed on them by the large general contractors. Typically, each general contractor has a particular billing form to use, a different due date for receiving invoices from the subcontractors, different and complicated insurance requirements for workers compensation and liability, particular lien documents, and particular project management issues involving change orders, submittals, transmittals and requests for information, to name just a few.

Various tools are available to assist trade subcontractors in the contracting process, including software programs for service work, estimating and accounting. While these tools are useful for the specific tasks they perform, trade subcontractors must manage the overall contracting process themselves, with little assistance. The necessity of managing the overall contracting process places a considerable economic burden on the subcontractors, not only in the day-to-day management tasks, but also in learning the various demands of the contractors, as well as how best to respond to them.

### BRIEF SUMMARY OF THE INVENTION

What is needed is a method, program and system for managing the numerous and varied tasks required of trade subcontractors in the construction industry. One or more of the disadvantages mentioned above and other disadvantages are overcome by the various embodiments of the present invention, illustrative examples of which follow.

A first embodiment of the present invention is a method of managing tasks required of a trade subcontractor in the construction industry, the trade contractor having a plurality of users, the method comprising:
furnishing a plurality of bids for a job to a plurality of contractors;
upon acceptance of one of the plurality of bids by one of the contractors, converting the accepted bid to a job;
generating the tasks in response to the conversion of the accepted bid into the job;
associating each of the tasks with one of the users on the basis of the user's identity and job capacity;
displaying to each of the users when logged on respective controls for the respective task categories;
furnishing a list to the logged on user of the tasks associated therewith in one of the task categories, in response to selection of the control therefor; and
providing a capability to the logged on user to act upon the list furnished thereto in the list furnishing step.

A second embodiment of the present invention is a user interface for facilitating management of tasks required of a trade subcontractor in the construction industry by a user associated with the subcontractor, comprising:
a main menu comprising a first control;
a first list window accessible by user selection of the first control, the first list window comprising at least one record; and
a first action window accessible by user selection of the record in the first list window.

A user interface as in the second embodiment wherein:
the first control comprises a first label and a first counter, the first label indicating a first task category and the first counter indicating a number of tasks in the first task category assigned to the user.

A user interface as in the foregoing paragraph wherein:
the subcontractor has a plurality of users associated therewith; and
the first control further comprises a second counter, the second counter indicating a number of tasks in the first task category assigned to all of the users associated with the subcontractor.

A user interface as in the second embodiment further comprising:
a second control disposed in the main menu, the second control comprises a second label and a third counter, the second label indicating a second task category and the third counter indicating a number of tasks in the second task category;
a second list window accessible by user selection of the third control, the second list window comprising at least one record; and
a second action window accessible by user selection of the record in the second list window.

A third embodiment of the present invention is a method of managing tasks required of a trade subcontractor in the construction industry, the trade contractor having a plurality of users, the method comprising:
furnishing a plurality of bids for a job to a plurality of contractors;
upon acceptance of one of the plurality of bids by one of the contractors, converting the accepted bid to a job;
generating the tasks in response to the conversion of the accepted bid into the job;
associating each of the tasks with one of the users on the basis of the user's identity and job capacity;
maintaining a plurality of counters for each of the users of the tasks associated therewith in respective task categories; and
displaying to each of the users when logged on the counters maintained therefor, in association with respective controls for the respective task categories.

A method as in the third embodiment further comprising:
furnishing a list to the logged on user of the tasks associated therewith in one of the task categories, in response to selection of the control therefor;
providing a capability to the logged on user to act upon the list furnished thereto in the list furnishing step; and
adjusting the counter for the logged on user upon action thereby on the list furnished thereto.

A method as in the third embodiment further comprising:
displaying to each of the users when logged on the total number of tasks in the respective task categories, in association with the respective controls for each of the task categories.

A fourth embodiment of the present invention is a user interface for facilitating management of tasks required of a trade subcontractor in the construction industry by various users associated with the subcontractor, comprising:
a bid log control for managing a log of bids and converting successful ones of the bids into jobs, a first one of the counters being a number of active bids based on identity of a first user, and the first counter being associated with the bid log control;
a billing control for initiating progress billings for the jobs, a second one of the counters being a number of jobs requiring billing during a particular time period based on identity of a second user, a third one of the counters being a number of jobs requiring billing during a particular time period for the trade subcontractor, and the second and third counters being associated with the billing control;
an invoicing control for invoicing progress billings for the jobs, a forth one of the counters being a number of jobs requiring invoicing during a particular time period, and the fourth counter being associated with the invoicing control;
a retention control for invoicing retention billings for the jobs, a fifth one of the counters being a number of jobs requiring retention invoicing during a particular time period, and the fifth counter being associated with the retention control; and
a close out control for closing out jobs, a sixth one of the counters being a number of jobs requiring close out during a particular time period, and the sixth counter being associated with the close out control.

A user interface as in the fourth embodiment:
further comprising a main menu having a Bids and Jobs area, a Project Administration area, and an Office Administration area;
wherein the bid log control is disposed in the Bids and Jobs area;
wherein the billing control is disposed in the Project Administration area; and
wherein the invoicing control, the retention control, and the close out control are disposed in the Office Administration area.

A fifth embodiment of the present invention is a user interface for facilitating management of tasks required of a trade subcontractor in the construction industry by various users associated with the subcontractor, comprising:
a bid log control for managing a log of bids and converting successful ones of the bids into jobs, a first one of the counters being a number of active bids based on identity of a first user, and the first counter being associated with the bid log control;
a confirming correspondence control for initiating sending of correspondence confirming the conversion of the successful bids into the jobs, a second one of the counters being a number of confirming correspondence requiring sending during a particular time period based on identity of a second user, a third one of the counters being a number of all confirming correspondence requiring sending during a particular time period for the trade subcontractor, and the second and third counters being associated with the confirming correspondence control;
an insurance control for initiating insurance applications for the jobs, a forth one of the counters being a number of jobs requiring new insurance applications during a particular time period, a fifth one of the counters being a number of incomplete insurance applications during a particular time period, and the fourth and fifth counters being associated with the insurance control;
a permits control for initiating permit applications for the jobs, a sixth one of the counters being a number of jobs requiring new permit applications during a particular time period, a seventh one of the counters being a number of incomplete permit applications during a particular time period, and the sixth and seventh counters being associated with the permits control; and
a pre-liens control for initiating pre-lien documents for the jobs, an eighth one of the counters being a number of jobs requiring new pre-lien documents during a particular time period, a ninth one of the counters being a number of incomplete pre-lien documents during a particular time period, and the eighth and ninth counters being associated with the pre-lien control.

A user interface as in the fifth embodiment:
further comprising a main menu having a Bids and Jobs area, a Project Administration area, and an Office Administration area;
wherein the bid log control is disposed in the Bids and Jobs area;
wherein the confirming correspondence control is disposed in the Project Administration area; and
wherein the insurance control, the permits control, and the pre-liens control are disposed in the Office Administration area.

A user interface as in the fifth embodiment:
wherein the seventh counter is a number of incomplete permit applications awaiting a permit number during a particular time period;
further comprising a tenth one of the counters, the tenth counter being a number of incomplete permit applications requiring a check to be cut during a particular time period, the tenth counter being associated with the permit control.

A sixth embodiment of the present invention is a method of managing tasks required of a trade subcontractor in the construction industry, the trade contractor having a plurality of users, the method comprising:
furnishing a plurality of bids for a job to a plurality of contractors;
generating a plurality of tasks for each of the bids, including walk-through dates for a walk-through task category, bid dates for a bid task category, and follow-up call dates for a follow-up call task category;
associating each of the tasks with one of the users on the basis of the user's identity and job capacity;
maintaining a plurality of counters for each of the users of the tasks associated therewith in the respective task categories; and
displaying to each of the users when logged on the counters maintained therefor, in association with respective controls for the respective task categories.

A seventh embodiment of the present invention is a user interface for facilitating management of tasks required by a trade subcontractor in the construction industry by a logged-on user associated with the subcontractor, comprising:
a plurality of counters and associated controls dispersed throughout the user interface, including on various task-specific screens thereof and on a main menu screen thereof; and
a work summary area disposed on the main menu screen, the work summary area comprising a plurality of counters and associated controls generally related to personal tasks that are scheduled to be performed by the logged-on user acting in his assigned job capacity or capacities within a particular time period;
wherein the counters in the work summary area correspond to counters in the user interface outside of the work summary area; and
wherein the counters in the work summary area are associated with controls to facilitate the display of particular information and activation of the particular functionality.

A user interface as in the seventh embodiment, wherein:
a standard set of counters and controls suitable for major job capacities is displayed within the work summary area; and
a zero value is displayed on counters that are not relevant to the logged-in user or to his job capacity or capacities.

user interface as in the seventh embodiment, wherein:
a set of counters and controls that is specific to the logged-on user as an individual and in accordance with his job capacity or capacities is displayed in the work summary area; and
counters and controls irrelevant to the logged-on user are not displayed.

### BRIEF DESCRIPTION OF THE SEVERAL VIEWS OF THE DRAWINGS

FIG. 1 is a schematic diagram showing examples of different parts of a system in accordance with an embodiment of the present invention, including various parts of a user interface such as a main menu, a list window, and an action window.

FIG. 2 is a screen image of various counters.

FIGS. 3A-3W are various screen images pertaining to a new bid.

FIGS. 4A-4Z are various screen images pertaining to a new job.

FIGS. 5A-5J are various screen images pertaining to the automatic creation of an insurance task.

FIGS. 6A-6I are various screen images pertaining to the automatic creation of pre-lien task.

FIGS. 7A-7G are various screen images pertaining to job billing.

FIGS. 8A-8K are various screen images pertaining to invoicing.

FIGS. 9A-9G are various screen images pertaining to the management of collections.

FIGS. 10A-10D are various screen images pertaining to report generation.

FIGS. 11A-11C are various screen images pertaining to quick search options.

FIGS. 12A-12J are various screen images pertaining to administrative functions.

FIG. 13 is a screen image of a Main Menu screen.

FIG. 14 is a screen image of a Change Order Paperwork List screen.

### DETAILED DESCRIPTION OF THE INVENTION, INCLUDING THE BEST MODE

The management of tasks required of trade subcontractors in the construction industry data base is performed comprehensively, quickly, and with little opportunity for error or omission by the use of a novel method, preferably implemented by computer. A method, user interface, computer program, and system are described that makes as much project information available as quickly as possible to those working within a subcontractor's office, and that provides a flexible workflow process to allow for the seemingly endless possibilities and variations of demands placed on a subcontractor.

The preferably computer-implemented method maintains a data base (the term “data base” is inclusive of a single data base, distributed data base, multiple discrete data bases, and so forth) of all important information related to job bidding and job performance, including employees of the subcontractor, their areas of responsibility, general contractors, suppliers, bid and job status, and so forth, and uses the data base to guide the subcontractor through each stage of bidding and job performance. Complex queries are used to push tasks around the office and to make them visible to users based on their login names. Powerful and intuitive visual controls on a user interface, including juxtaposed individual/firm task counters and control labels, allow each user who has a role in the bidding and job performance processes on behalf of the subcontractor (usually but not necessarily employees and contractors of the subcontractor) to quickly and easily assess what needs to be done and take the appropriate action. Each user is also able to ascertain how his or her individual actions relate to the overall activity in which the subcontractor is engaged. Management may visually determine what is going on within the office and where there are bottlenecks, and adjust resources accordingly.

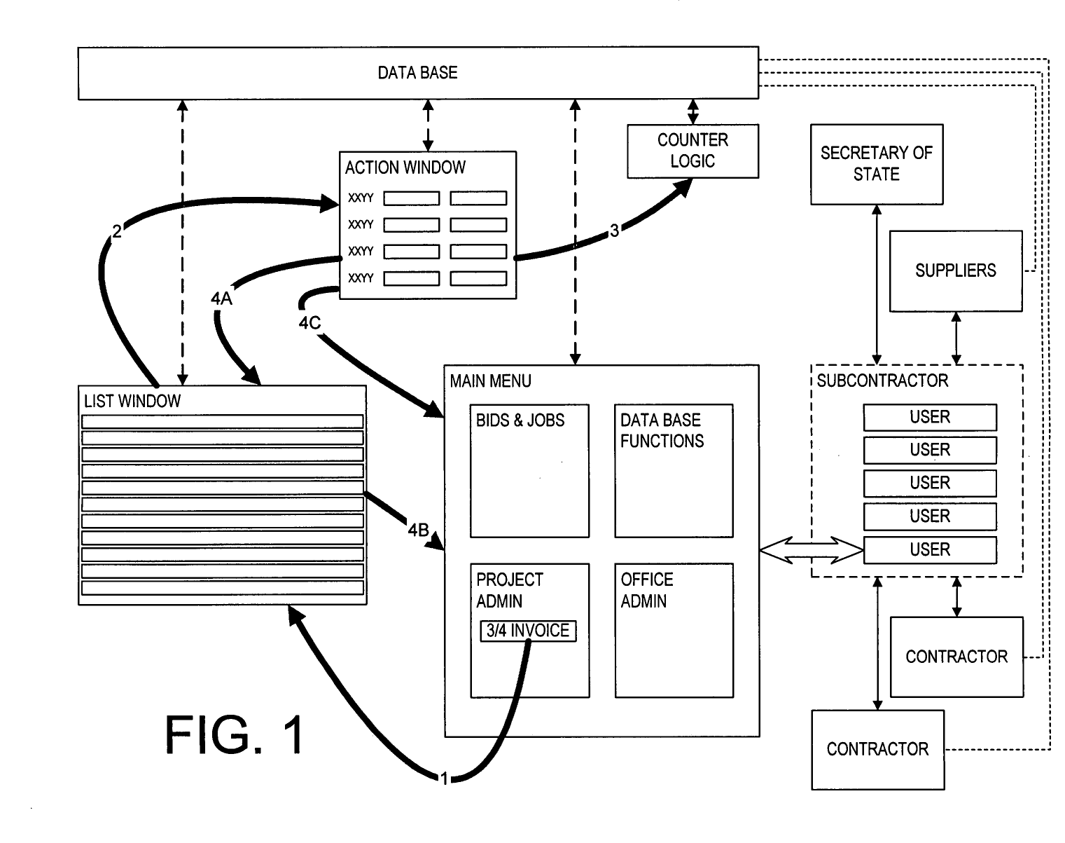

At the heart of the method is a preferably graphical user interface that preferably includes a Main Menu screen having various user-operated controls generally arranged into preferably specific operational areas. A control is any area of a user interface that can be selected or manipulated by a user to cause a desired action to be taken, and include buttons, pull-down menus, hyperlinks, and so forth. FIG. 1 is a block schematic diagram that shows an illustratively embodiment of a Main Menu that has four operational areas, namely a Bids and Jobs area, a Project Administration area, a Data Base Functions area, and an Office Administration area. Illustratively, the Bids and Jobs area contains the following controls: Job Info, Bid Log, Time & Materials, Purchase Orders, and Quotes. Illustratively, the Project Administration area contains the following controls: Tasks, Paperwork, Invoice Now!, More Billing Options, and E-Confirm. Illustratively, the Data Base Functions area contains the following controls: Quick Search, Maintenance, Customers, Employees, Job Schedules, and Shop. Illustratively, the Office Administration area contains the following controls: Create Invoice, Retention, Insurance, Permits, Close Outs, and Pre-Liens. It will be appreciated that many aspects of the Main Menu screen such as the specific character of these areas, the number of areas, the manner in which they are presented to the user, the controls they contain, and the manner in which the user interacts with the various controls may be established as desired, with many suitable techniques being well known per se in the art.

Counters are displayed in various screens of the user interface, generally visually associated with particular controls, to aid in presenting the user with relevant information in a context that also guides the user through the various tasks required of a subcontractor in a highly intuitive manner. While a preferred type of visual association is to overlay the counters on their respective controls, other types of associations such as by juxtaposition with the controls or the use of particular colors or fonts to match that of the controls are possible as well. Dual counters are used to particular advantage in, for example, the Main Menu screen. The Main Menu screen is presented to each user who logs in, and contains various counters whose values are influenced by the logon user's job capacity in some cases, and by the personal identity of the logon user in other cases. The Main Menu screen also contains various controls and a number of dual counters associated with many of the controls.

The values displayed by the dual counters also vary depending on the task represented by the controls with which the dual counters are associated. The various tasks represented by controls on the Main Menu screen are classifiable into four task types: personal, administrative, administrative with personal information and mixed personal and administrative. It will be appreciated that these task types are illustrative, and other task types may be used if desired.

A personal task is a type of task that is scheduled to be performed by a particular person acting in a particular job capacity, usually within a particular time period. Preferably, when a dual counter is used in association with a personal task type, the number on the left side of the dual counter is the number of tasks of that particular type to be performed by the logon user on the present day, while the number on the right side of the dual counter is the number of tasks of that type to be performed by all persons throughout the subcontractor's organization in the same job capacity as the logon user on the present day. Examples of job capacities are walk-through person and estimator, which relate to the bidding process, and project manager and responsible billing person, which relate to the job process. Depending on the name of the logon user, the number of tasks that are scheduled within a particular time frame, illustratively one day, are pushed to the displayed counters. In the Project Administration area, for example, the control Tasks contains a single counter of all the tasks that must be done today by the logon user. The control Paperwork contains a single counter of the number of telephone calls that must be made today for all jobs on which the logon user is assigned to. The control Invoice Now contains a dual counter whose right value is the number of all jobs that must be billed within the next three days, and whose left value is the number of jobs the logon user must bill within the next three days (where the logon user is a responsible billing person, or the number of jobs requiring a review of change orders before they can be billed (where the logon user is a project manager). The control E-Confirm contains a dual counter whose right value is the number of all items requiring email confirmation, and whose left value is the number of items requiring email confirmation by the logon user.

An administrative task is a type of task that is to be performed by any person acting in a particular job capacity. Generally, when a dual counter is used for an administrative task of a particular type, the number on the left is the number of new administrative tasks of that particular type, while the number on the right is the number of partially completed administrative tasks of that type. In the Office Administration area, for example, the control Create Invoice contains a single counter of the number of new invoices that must be sent out today. The control Insurance contains a dual counter whose left value is the number of brand new jobs that require insurance and whose right value is the number of insurance certificates requested but not yet received. The control Permits contains a three part counter whose left value is the number of new jobs requiring permit applications, whose center number is the number of permit applications that have filed but not yet paid for, and whose right number is the number of permit applications that are pending the issuance of a permit number. The control Close Out contains a single counter of the number of jobs that must be closed out today. The control Pre-Liens contains a dual counter whose left value is the number of new jobs requiring pre-lien documents, and whose right value is the number of pre-lien documents that are incomplete. The generation of pre-lien documents may be performed by the program itself, or out-sourced to a third party service organization.

In some instances, an administrative task counter may be accompanied by personal information. An example of this is the control AR Incidents. The right side value is the number of account receivable calls scheduled for today, which is an administrative task. The left side value is the number of those account receivable calls that relate to jobs being managed by the logon user where the logon user is a project manager. However, the project manager is not required to make account receivable calls, so that while the left number is informative and personal to particular logon users, it does not represent a personal task type. Nonetheless, the project manager may still click on the AR Incidents control to bring up a list of jobs he manages that are awaiting account receivable calls, and may take action himself as by making the call and suitably adding documentation to the record, updating the record, and so forth. The left side value is zero for all logon users except for project managers.

In some instances, personal and administrative task counters may be displayed together. An example of this is the control Retention in the Office Administration area. The right side value is the number of jobs requiring retention billing, which is an administrative task. The left side value is personal to the project manager and indicates the number of jobs that could be retention-billed were it not for pending change orders.

FIG. 1 also shows the general architecture of an embodiment of the user interface and an embodiment of a system and method to which it relates. Preferably, the user interface is displayed on a computer monitor and is controlled by a program that runs on a general purpose computer such as a personal computer (including tablet computers) or workstation, although as smaller computing devices such as personal data assistants and Internet appliances become more powerful and their displays larger, these other computing devices may be used as well. The program, which may be implemented in software or a combination of software and firmware, may include all necessary program components for running stand alone on a computing device, including data base management modules, or may include just a few components for maintaining the displays, receiving commands from the users, and communicating with other programs on other computers and servers for carrying out the operations of the method. An example of the former would be a program that resides on just one personal computer in the subcontractor's facility. Another example of the former would be a program that resides on a server in the subcontractor's facility, but which may be accessed by other networked computers in the facility. An example of the latter would be an Internet-based hosted service in which the main data base and most of the functional code would be maintained by the host on one or more servers, while the user would access the hosted service from a client or even in some implementations from a browser, which may be located inside the subcontractor's facility or outside of the subcontractor's facility.

The general principles built into one embodiment of the program preferably are as follows.
The program is able to access a variety of databases that exist for employees, customers, bid proposals and jobs and other areas and that are consistent with virtually all subcontractors needs.
The program fully integrates the information.
The program provides the ability for an individual to locate any piece of information relevant to a job, bid or customer very quickly. The program essentially eliminates the need to create names for files.
The program implements a unique workflow process that allows for the variations of demands placed on the subcontractor's office staff. Workflow processes are brought to the appropriate individuals via their login to the program. This way the user works with information specific to the tasks that he or she performs within a particular job capacity.
The program provides management with an immediate and visual ability to monitor office tasks. With this information they can be proactive and prevent work overload and other inefficiencies. Advantageously, counters are provided on many of the buttons. Single or multiple counters may be provided on a button, where the counters may relate to personal tasks, administrative tasks, administrative tasks and personal information, personal and administrative tasks, and so forth.
Many search and sort features are provided.

The user interface shown in FIG. 1 presents a variety of different controls relating to the bidding and job performance processes. The user is able to quickly determine what tasks he must perform from a glance at the counters associated with the various controls, and is able to take action on the tasks by selecting a desired one of the controls, preferably by clicking with a mouse. A control in the Project Administration area, for example, might be labeled INVOICE and might also includes a counter 3/4 indicating that the logon user has three invoices to generate, and that throughout the subcontractor's organization, four invoices total are awaiting generation.

Selection of a control generally causes a list window to be displayed, as shown in FIG. 1 by the path labeled 1. The list window presents more detailed information to the user, from which specific records in the list may be selected for specific action. The specific actions typically are taken by selecting one of the records in the list, again preferably with a mouse click from a graphical display.

Generally, selecting a record in the list window causes an action window to be displayed, as shown by the path labeled 2. The action window presents various choices and fields to the user in an intuitive and clear manner. While the user may directly interact with some of the items in the list windows, the action window is more effective for guiding the user through the process, and allows choices and information fields to be more clearly and unambiguously presented to the user to prevent confusion and error.

When the user takes an action that accomplishes a task, either by interacting with an item in the list window or the action window, two principle events occur. One of these events, indicated by the labeled path 3, is adjusting the state of the various counters in the system to reflect completion of the task. Completion of the task by the user reduces the counter (where, for example, the counter is either specific to the user or to the type of administrative task), but increases one or more other counters for other tasks that are dependent upon the performance of the completed task. These other tasks may, for example, be specific to the user, or may be specific to one or more other uses in the subcontractor organization, or may be specific to a type of administrative task.

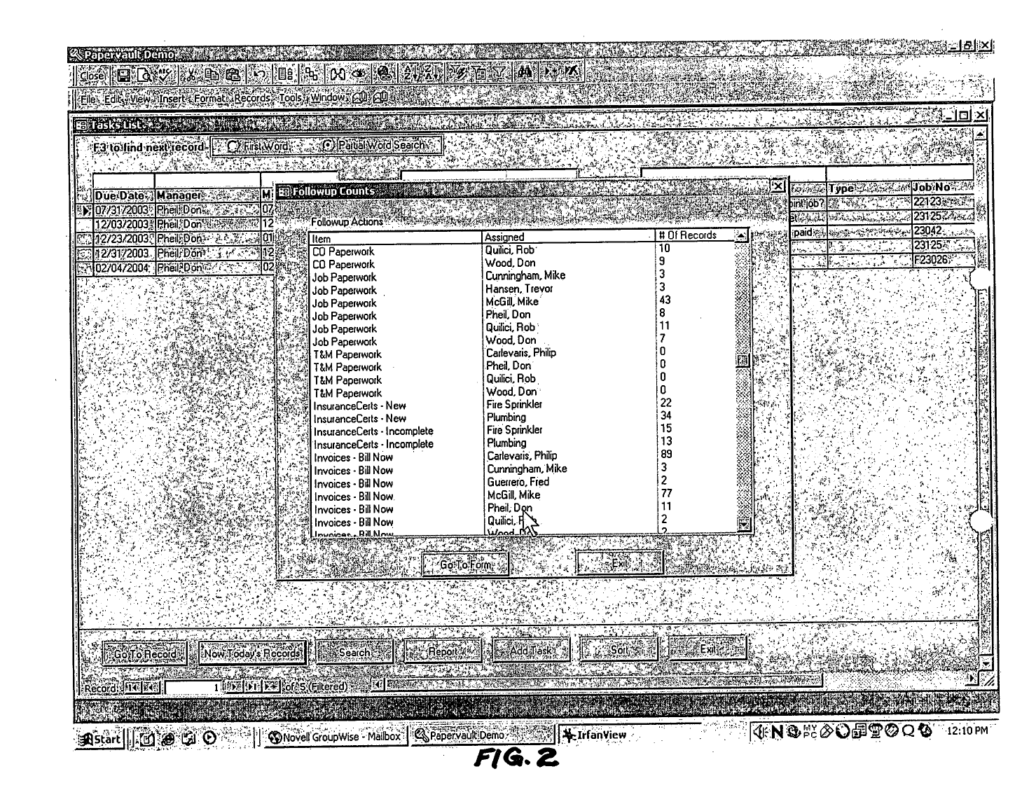

FIG. 2 is a screen image showing the state of some of various counters that are maintained in one embodiment of the program. Four of the items, for example, are administrative operations on insurance certificates, namely InsuranceCerts-New and InsuranceCerts-Incomplete. These counters would be represented on a control such as, for example, “Insurance” by the dual counter 56/28, indicating that fifty-six new insurance certificates are needed, and 28 are incomplete.

The other event which occurs when the user takes an action that accomplishes a task, indicated by the labeled paths 4A, 4B and 4C, is a return to the Main Menu, either directly as indicated by path 4C, or via the list window. If the list window is returned to, the list window preferably is updated to reflect the action taken in the action window. If the action is taken directly in the list window, then the list window preferably is updated upon completion of the action. Additional actions may be taken, either within the list window or through the action window via paths 2 and 4A, or the user may return to the Main Menu screen via path 4B.

The various operations undertaken by the system either use information from a data base, or add information to the data base, or both. These are indicated by the heavy dashed lines in FIG. 1 between the data base and the Main Menu, the list window, the action window, and the counter logic.

The method of using the system involves interacting with a number of persons and organization outside of the subcontractor organization. Some of these are the contractor and suppliers, as shown in FIG. 1. In some embodiments, data from these persons and organizations may be furnished to the data base for use in the various operations undertaken by the system, as shown by the light dash lines in FIG. 1 between the data base and the Suppliers and Contractors.

The method may begin with the creation of a bid log by an employee of the subcontractor, typically an estimator. A bid log is opened by clicking on a Bid Log control illustratively positioned in the Bids and Jobs area of the Main Menu. Each bid made the estimator is recorded in the estimator's bid log, so that one bid log may contain any combination of bid types, ranging from several bids to different contractors for the same job on the same project, to different bids to different contractors for different jobs on different projects. The estimator is able to see all bids of any type, depending on his selection criteria, so that he can refresh his memory as to past bids and check for duplicates. Essentially all of the information fields of the bid are searchable. When a bid is created, it is given a unique number and generates a written proposal based on the entered data. A scheduling tool is provided so that walk through dates and bid dates can be set—which in turn allows certain follow up dates to be generated from the bid dates—and so that the various dates can be modified.

A bid is converted to a job when the subcontractor is informed that the bid has been accepted. The conversion is as simple as finding the bid on the bid log, clicking on a Convert to a Job control, and selecting the winning contractor. Other information entered on a new job screen includes the project manager and other basic information of that type. While the contractor might inform the subcontractor of bid acceptance in writing, typically the subcontractor is informed orally, as by a telephone call with written confirmation following.

Acceptance of the bid and conversion to a job triggers numerous tasks, the execution of which is managed by the program. These include managing contract formation and execution, managing change orders, obtaining all necessary documentation such as insurance certificates and pre-lien documents, and managing progress and retention billings.

An example of a personal task is managing contract formation, and specifically confirmation of bid acceptance. This usually is a project manager's responsibility. When a bid is indicated as being accepted, the program automatically upon exit from the screen creates a confirming email (a confirming email is also created upon exit from a change order screen) and increments a counter for the project manager corresponding to email confirmation of the acceptance. When the Main Menu screen is displayed by the logon user, which in this example would usually be a project manager, the counter is displayed in the left position of a dual counter on an E-Confirm control illustratively positioned in the Project Administration area of the Main Menu to notify the project manager of the number of email confirmations he must send out. Clicking on the E-Confirm control causes a list of unsent email confirmations to be displayed, from which the individual confirmations may be selected, reviewed and sent by the project manager.

An example of an administrative task is the need for a new insurance certificate. When a bid is indicated as being accepted, the program automatically upon exit from the new job screen increments a counter corresponding to a need for new insurance. When the Main Menu screen is displayed by a logon user, the counter is displayed in the left position of a dual counter on an Insurance control illustratively positioned in the Office Administration area of the Main Menu to notify the user of the number of new insurance certificates needed. Clicking on the Insurance control causes a listing to be displayed that includes the jobs requiring new insurance certificates.

Another example of an administrative task is the need for permits. After a bid is indicated as being accepted and as or after the new job is being set up, the project manager may open up a permit form from the job screen. When the form has been filled in and closed, the program increments a new permit task counter corresponding to a need for a permit application for the new job. When the Main Menu screen is displayed by a logon user, the counter is displayed in the left position of a three part counter on a Permits control illustratively positioned in the Office Administration area of the Main Menu to notify the user of the number of new permit applications needed. The center number is the number of completed permit applications that are in need of a check to be cut; when the check is cut and the check number inserted, this counter drops by one. The right number is the number of permit applications that are awaiting the issuance of a permit number; when the permit number is added, this counter drops by one. Clicking on the Permits control causes by default a listing to be displayed that includes the jobs requiring new permit applications, as well as information entered by the project manager on the permit form that is required to process the permit applications. The filters for the listing may be adjusted to display other permit-related tasks corresponding to the other counters (such as completed applications in need of checks, and applications awaiting permit numbers), as may be desired by the user.

Another example of an administrative task is the need for pre-lien documents. When a bid over a certain threshold amount is indicated as being accepted, the program automatically upon exit from the new job screen increments a counter corresponding to a need for pre-lien documents. When the Main Menu screen is displayed by a user, the counter is displayed in the left position of a dual counter on an Pre-Liens control illustratively positioned in the Office Administration area of the Main Menu to notify the user of the number of new pre-lien documents needed. Clicking on the Pre-Liens control causes a listing to be displayed that includes the jobs requiring pre-lien documents.

Another example of a personal task is billing, which typically is the responsibility of the responsible billing person. Somewhat in advance of the billing date for a particular job, the program automatically increments a counter for the responsible billing person corresponding to the need to bill the job. When the Main Menu screen is displayed by a logon user who is the responsible billing person, this counter is displayed in the left position of a dual counter on an Invoice Now! control illustratively positioned in the Project Administration area of the Main Menu, to notify the responsible billing person of the number of billings he must process. Clicking on the Invoice Now! control causes a listing to be displayed of job change orders and other items in need of billing.

The completion of one task often leads to the need for certain persons to perform additional tasks. In the case of billing, for example, when the responsible billing person completes a billing operation, the counter for the responsible billing person is decreased by one. At the same time, a counter for the administrative task of creating invoices is increased.

Another example of an administrative task is the need for billing retention. An example of this is the control Retention in the Office Administration area. The right side value is the number of jobs requiring retention billing, which is an administrative task. The left side value is personal to the project manager and indicates the number of jobs that could be retention-billed were it not for pending change orders; that is, all billing requirements are met except that one or more outstanding change orders exist. The project manager may look into these pending change orders simply by selecting the Retention control. The left side value is zero and therefore of no meaning for logon users other than project managers.

Various information needs arise during the bidding and job performance processes. As much useful information is maintained in a data base, various functions are provided to take advantage of access to the data. One such function is a quick search function, which allows the logon user to search a variety of fields and to display the appropriate screen or documents complying with the search criteria.

Much of the data is linked in ways to simplify navigation through the data. The list window may be provided with a Documents button, which when clicked causes the display of any documents associated with the selected record on the list. If a project manager is viewing a change order list, he can select a change estimate and click on GoTo to view the written change order or other associated documents.

The method also includes management review and action. When a management person is the logon user, he can easily monitor workflow from the various counters on the Main Menu, and can investigate unusual situations reflected in the counters by simply selecting the control associated with the questionable counter.

The following is a simplified example of specific actions by various logon users of a subcontractor, such as estimators, project managers, administrative personnel, and upper management, and how their actions translate to workflow items for others.

Create a Bid. A bid is created in the bid log by the subcontractor. After several days the successful subcontractor is informed of the intent to award a contract based on the proposal letter.

Create a Job. The estimator or project manager selects the bid record and then the “CONVERT TO A JOB” button is pressed. A new job screen is presented. All information such as proposal letters are brought over to the new job record. A job number is assigned by the program. The responsible billing person and the project manager are confirmed from a drop-down list. The screen allows for managing contractor information, the GC project manager, accounting contact, field foreman info and much more. When a job is created within any subcontractor's office many tasks are set into motion. Advantageously, many tasks that are typically performed separately are automatic in an integrated manner by the program, usually upon exiting the new job screen for the first time.

Obtain Insurance Certificates. It is assumed that insurance certificates will be needed. Without them, payments will always be delayed. Without any user intervention a task is sent to the “OBTAIN INSURANCE CERTS” button on the main screen. A dynamic counter is visible. The counter just clicked up a notch. The insurance person is on it right away.

Obtain a Contract. It is assumed that a contract does not exist since a phone call was received informing the company of the new job. When the job is created in the bid conversion, a task is sent to the project manager's call area of the program. It too has several counters. Counters on the buttons tell the project manager how many calls for contracts need to be made for the day as well as calls for change orders where the paperwork has not been issued yet, and also miscellaneous time and material items. Each of these call buttons present a log and each record in the log presents very specific relevant information needed to manage the task. Follow-up dates can be set thereby lowering the number visible on the button. On the appropriate follow-up date the counter goes up again.

Upon exit from the new job screen, for example, a confirmation email is created. The text of the email may be modified if desired, and the email may be sent immediately or later, as desired. A text record is also created.

Obtain Pre-Lien Documents. It is assumed that pre-lien docs will be needed. Information needed to process the pre-lien docs is carried to the “PRE-LIEN” button automatically. The counter goes up a notch.

Generate Invoices. Three days before the billing due date the counter on the “INVOICE NOW” button will go up a notch. After the billing person sets the correct billing percent for the job or change order, he clicks the “reviewed” checkbox. The counter on his “INVOICE NOW” button drops a notch and the “CREATE INVOICE” button goes up a notch. After being properly entered into the accounting system and set as “invoiced” the counter drops. All jobs, change orders and miscellaneous time and material items will present themselves each month on the appropriate day until they are fully billed.

Bill Retention. When a job is billed 100% and all issued change orders are billed 100% the job record is presented at the “BILL RETENTION” button. After being entered into accounting the counter will drop. If a pending change order exists the job info is presented to the project manager for his review. The left side of the “RETENTION” button is specific to the logged in project manager. If he sets the pending change order to rejected, it raises the counter for the accounting department because the job is ready for retention to be billed. If it is set as verbal or even issued if the paperwork comes in the office then it behaves according to the other rules.

Process Other Tasks in a Similar Manner. Similar task exists for permits and closeout documents. In the case of the Permits control, the first position is the number of jobs needing permits, the second position is the number of permits for which a check number must be inputted, and the third position is number of permits that are being processed but have not yet issued. In the case of the Close Outs control, the single position indicates the number of jobs requiring close out documents.

Document Access. All documents within the program have a code assigned to them when they are created. This code informs us of the year, job or bid number, document type and document id number. Any document can be brought up to the screen in a few seconds using any one of the many search criteria available.

Retain Records of External Document. External documents can be easily saved into the system for retrieval. Contracts, change orders, monthly invoices packages complete with signatures, insurance certificates, faxes, email, or anything else can be stored. Indexing the documents is quick via the maintenance module, which also allows for remote indexing. This can be done at night or at anytime even away from the office.

Display Related Documents. Documents that are related to each other will display at the document list throughout the program such as the bid or job screens or even customer screens. Select a change order and click “relate” and the corresponding scanned change order is displayed. Various documents whether scanned, internally generated, or otherwise electronically available may be related to other documents by selecting a document with which a relationship is desired, then clicking the Relate Document control to establish the relationship.

Create Tasks. A task can be created from virtually any screen in the program. It can be a personal task or a task assigned to others. Set a due date and a date to follow-up. It will respond accordingly. From the task screen you can click “GO TO RECORD”. You are taken directly to the screen that initiated the task in the first place. You can start working right away with relevant information.

Note Fields Provided. There are note field throughout the programs. These have time and date stamps.

Manage Accounts Receivable. Accounts receivable incidents are easy to manage. The “AR INCIDENT” button manages calls for collection of money. Notes are maintained and follow-up dates are set. From any record in the AR log you can go to the document screen for a job and have access to all documents necessary to mange the call. View contract, scanned change orders, invoice or billing packages. You can also move directly to the job screen for more information. Information in the AR log is presented by default as “today's” records. A toggle button marked Now All Records may be selected to display all records, which then changes to a Today's Records button so that an AR log of today's records may be displayed. Another single toggle button allows the AR log to be secondarily sorted either by accounting manager or by project manager.

Additionally, a project manager or estimator may wish to accomplish other tasks, such as the following which preferably are provided by the program.

Document a Situation. Automatic email confirmation using bid, job or change order specific information are created after a record has been created. This makes it very easy to document a situation.

Provide Shop Component Function. A shop component is integrated into the purchase order module that allows tools to be tracked on a per job basis or on a purchase order basis, pick up and deliveries created and monitored for completeness, and so forth.

Document Conversion. Any document can be converted into a program template using the available fields within the program as merge fields.

Document Association. Any type of saved document, file fax or email can be saved down to the specific bid, job or customer record

The program achieves its various results by the use of complicated and well thought out queries to filter information and present it to the responsible login user. Advantageously, the user needs to spend less effort managing the incredible amount of information required to bring a project to successful completion.

The following example illustrates various capabilities of the program and aspects of the method and system through a series of screen images. It will be understood that the order of many of the processes described below is arbitrary, and the specific information furnished and information sought is illustrative.

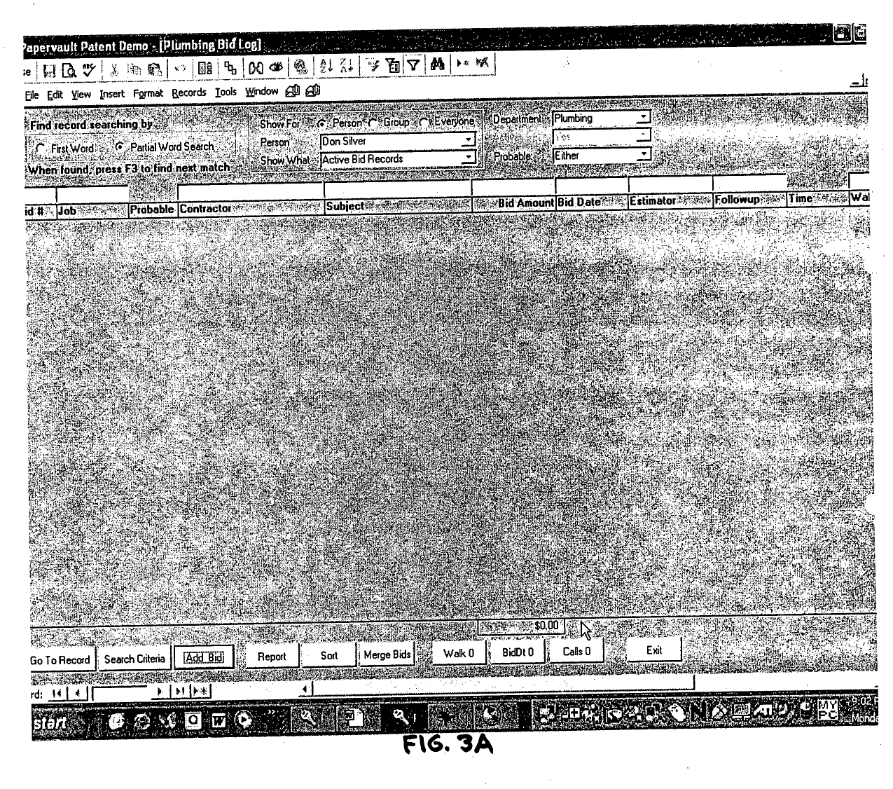

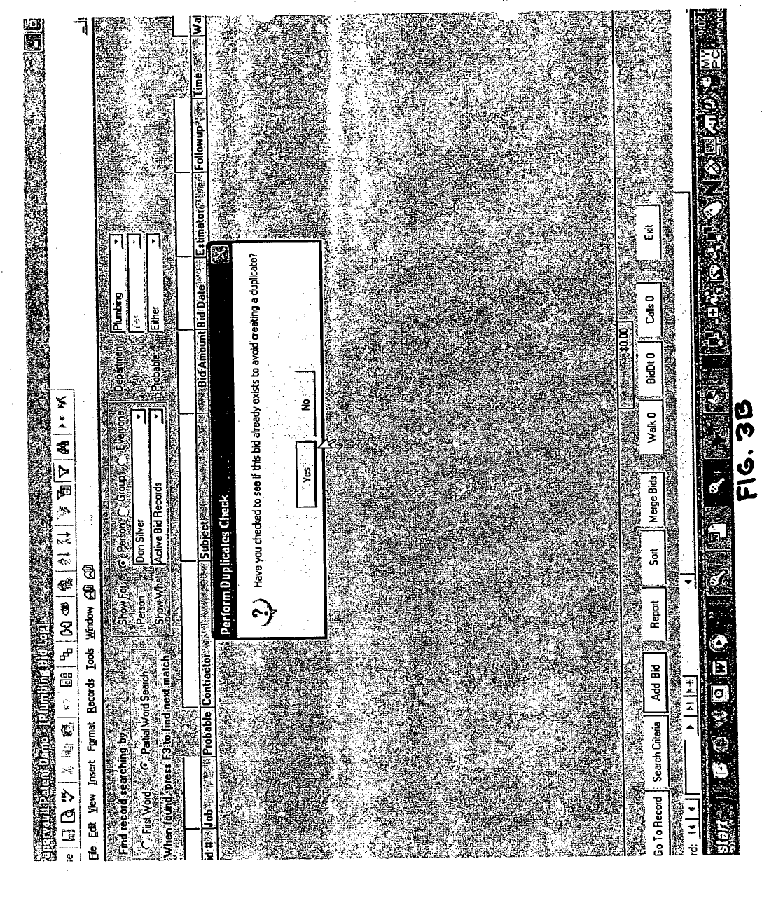

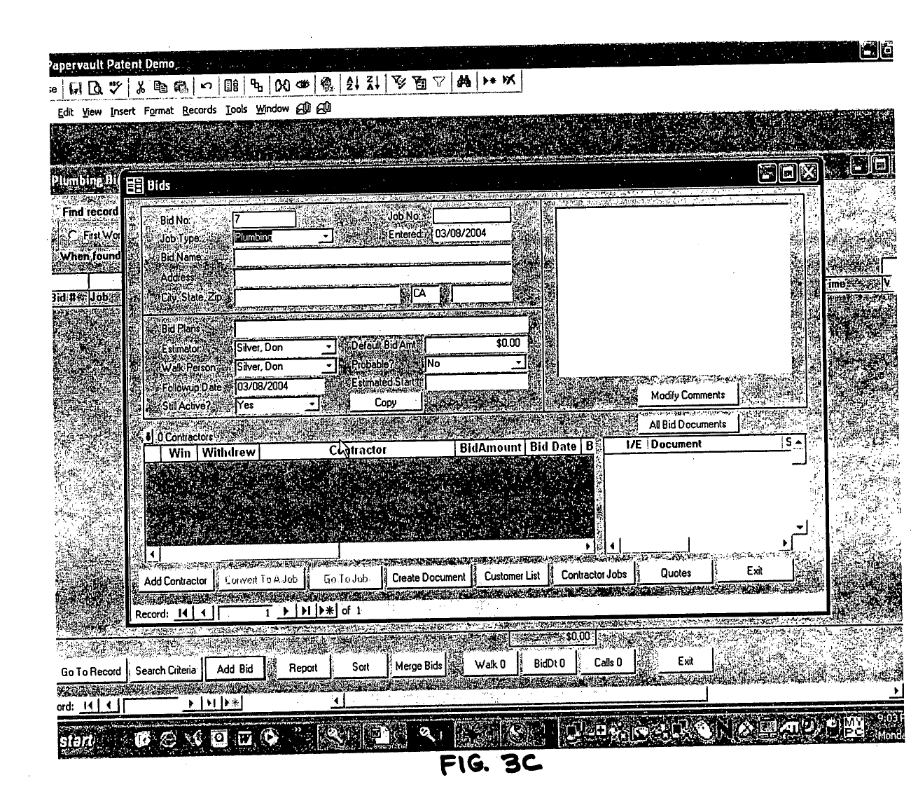

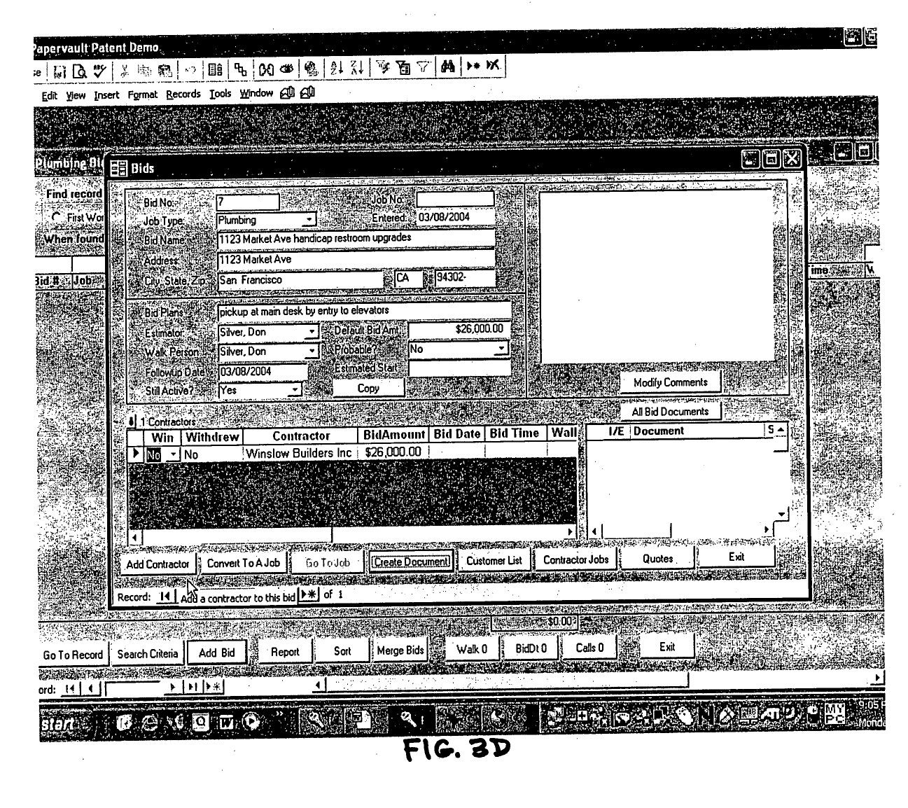

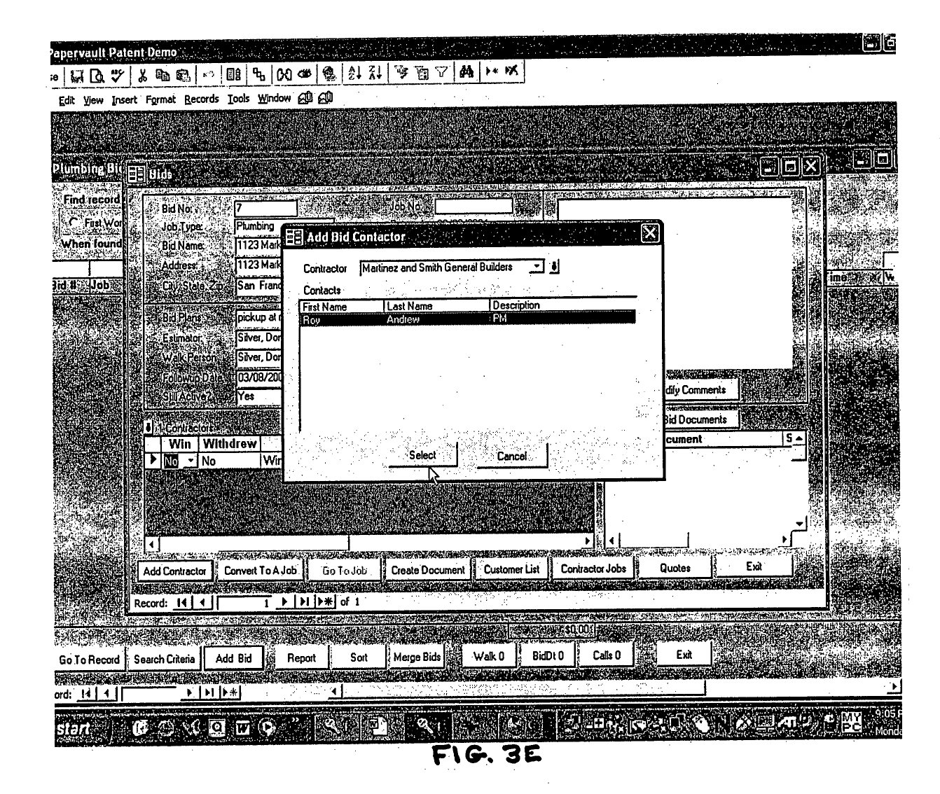

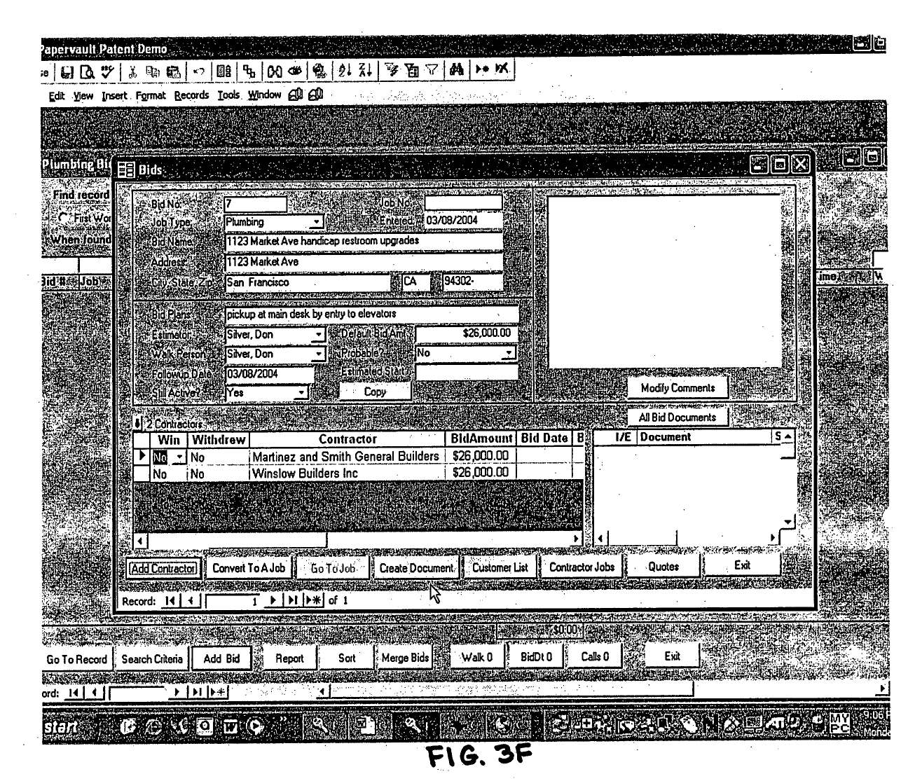

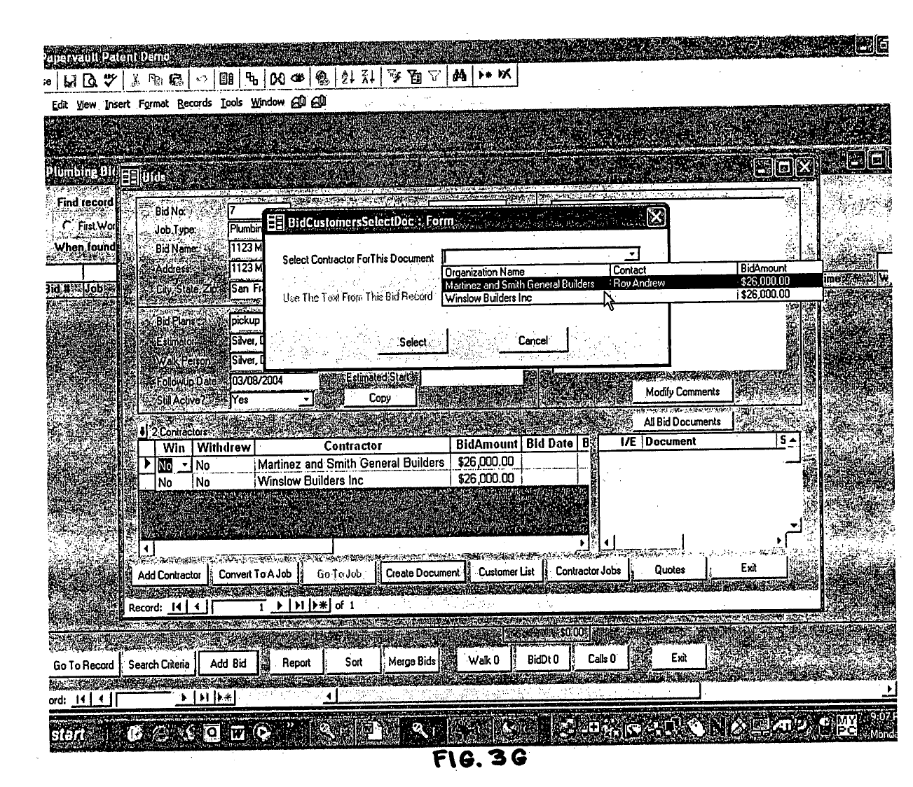

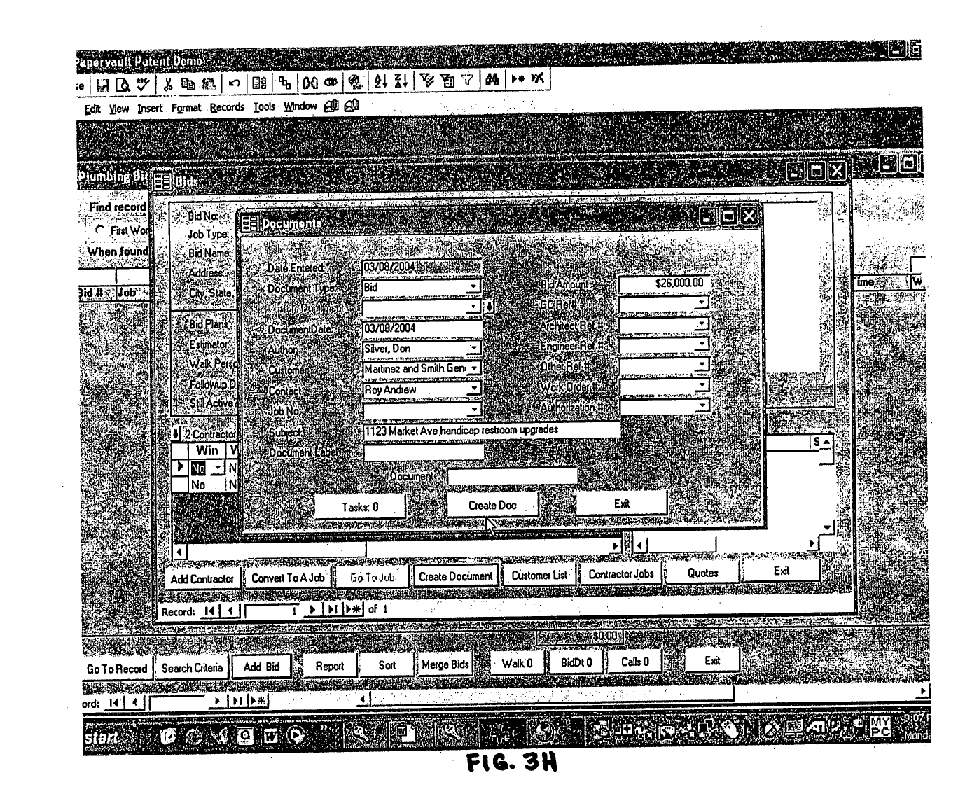

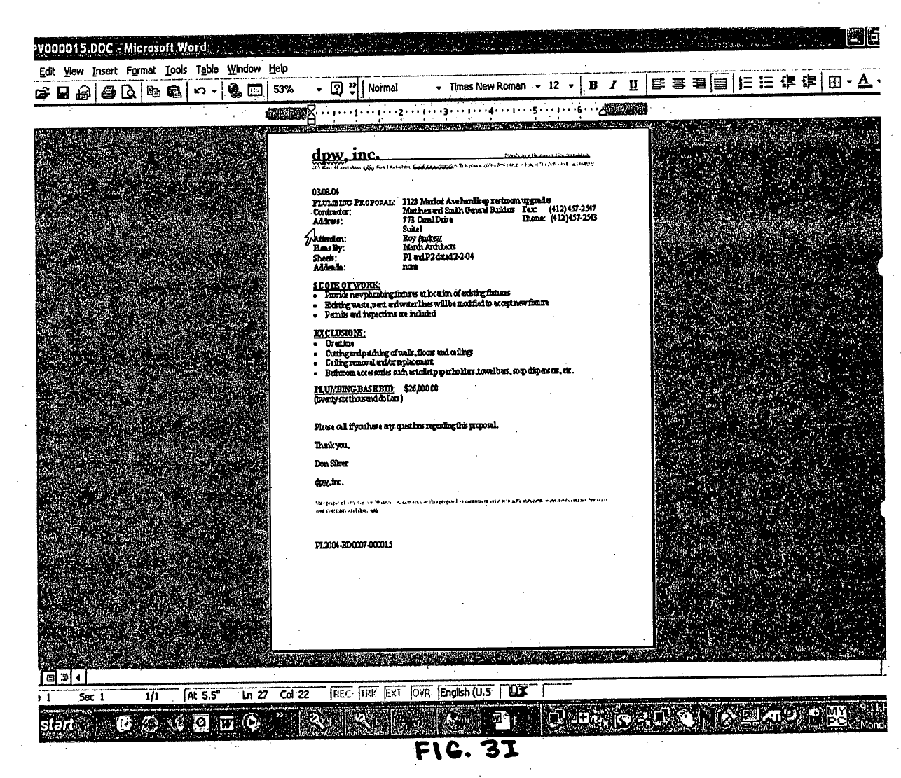

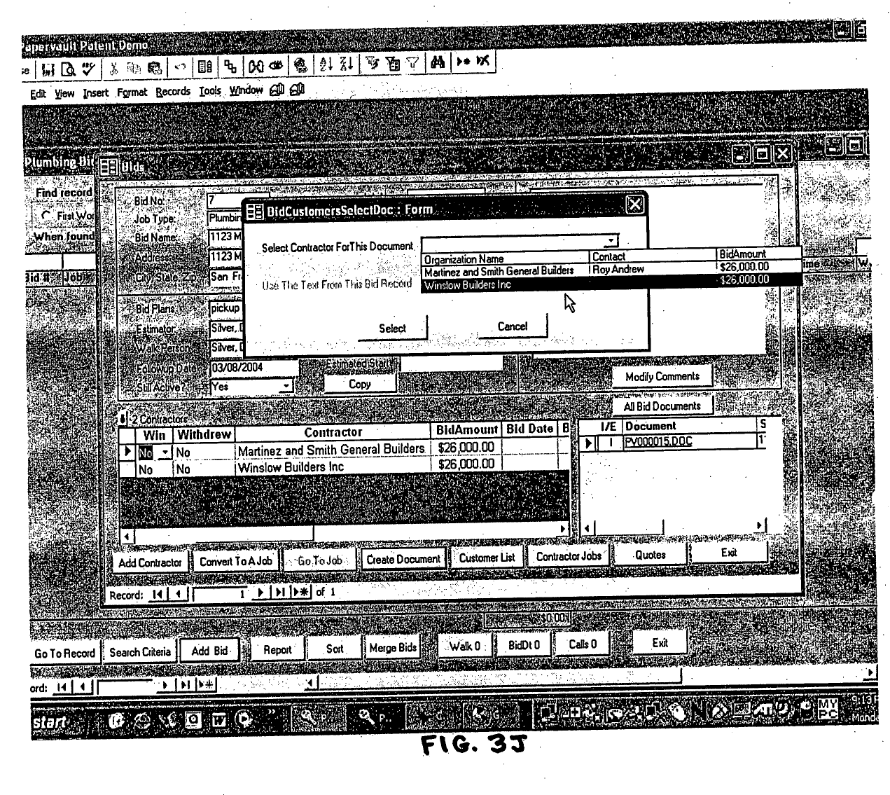

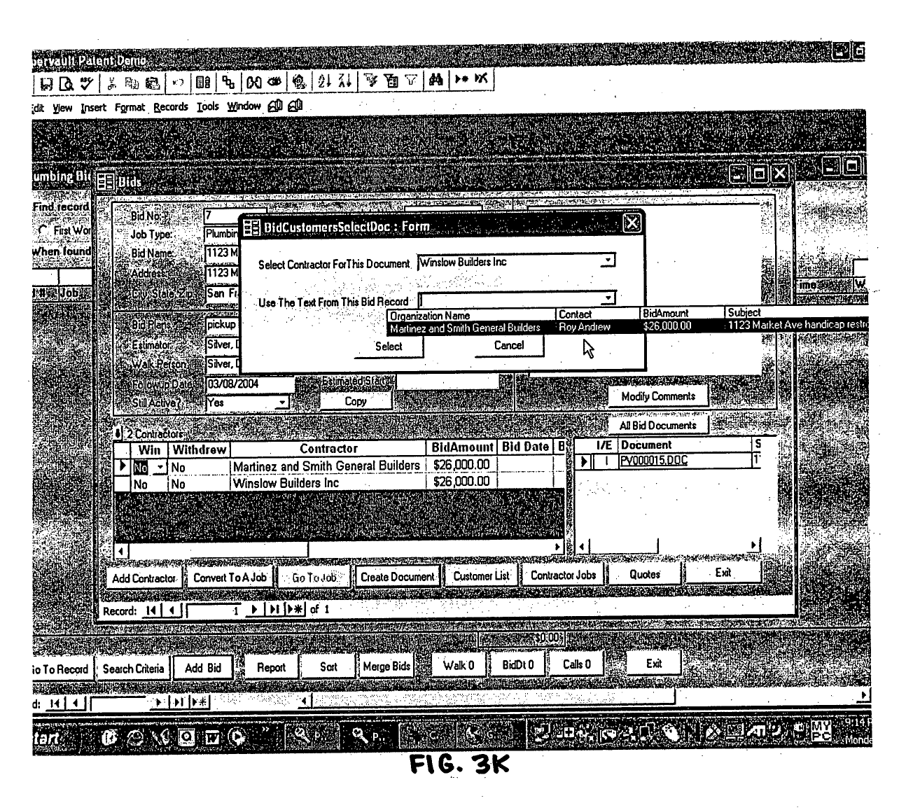

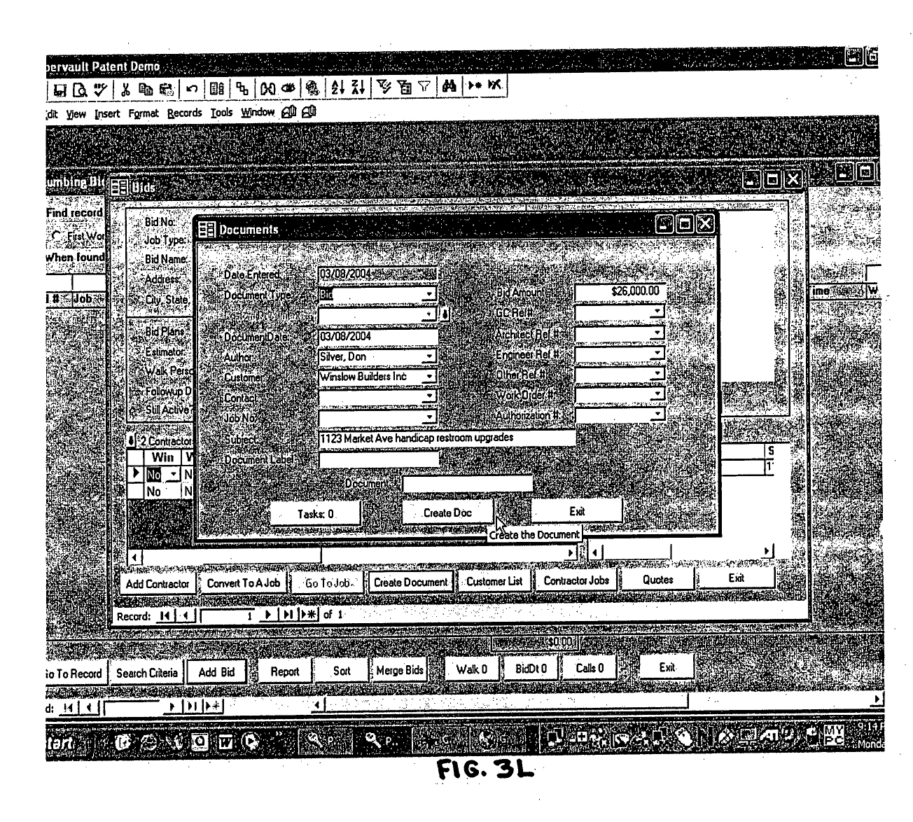

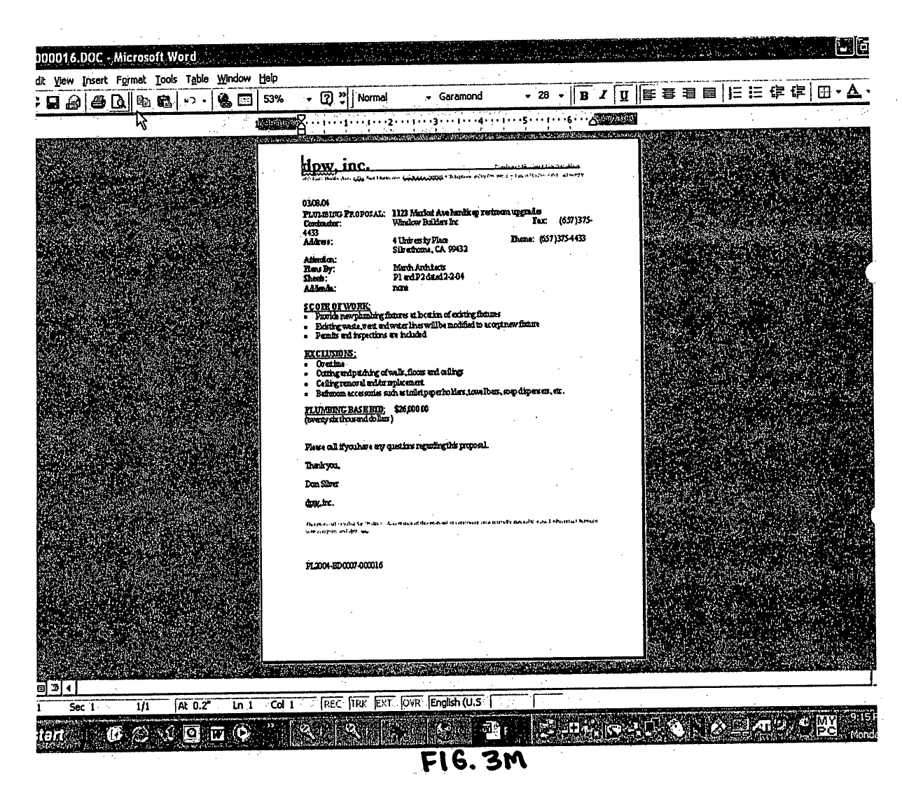

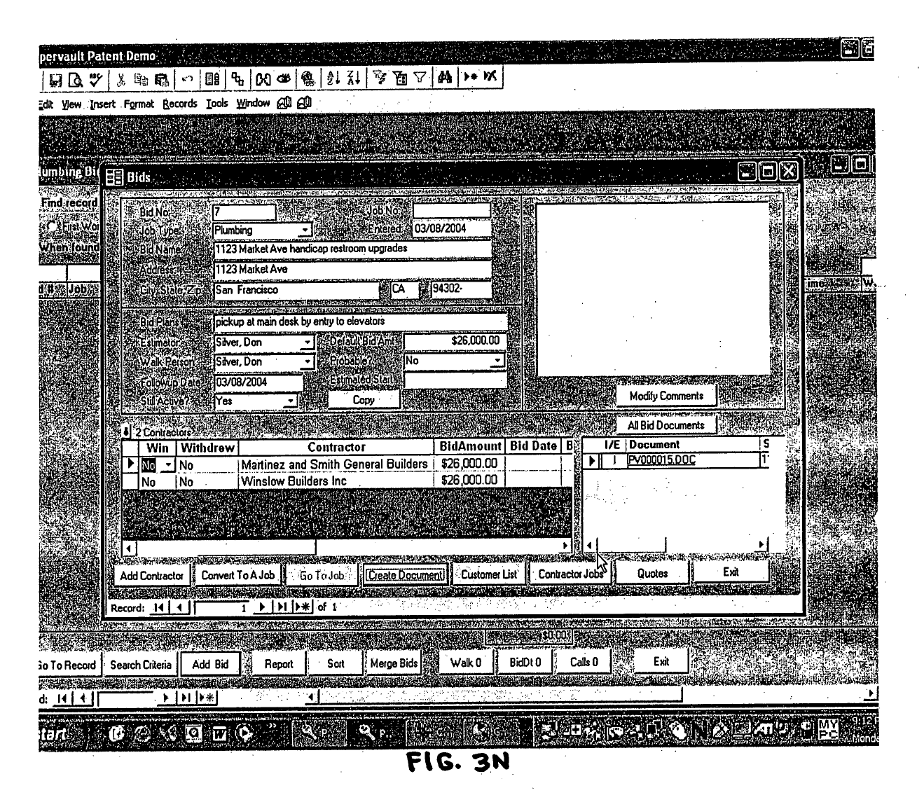

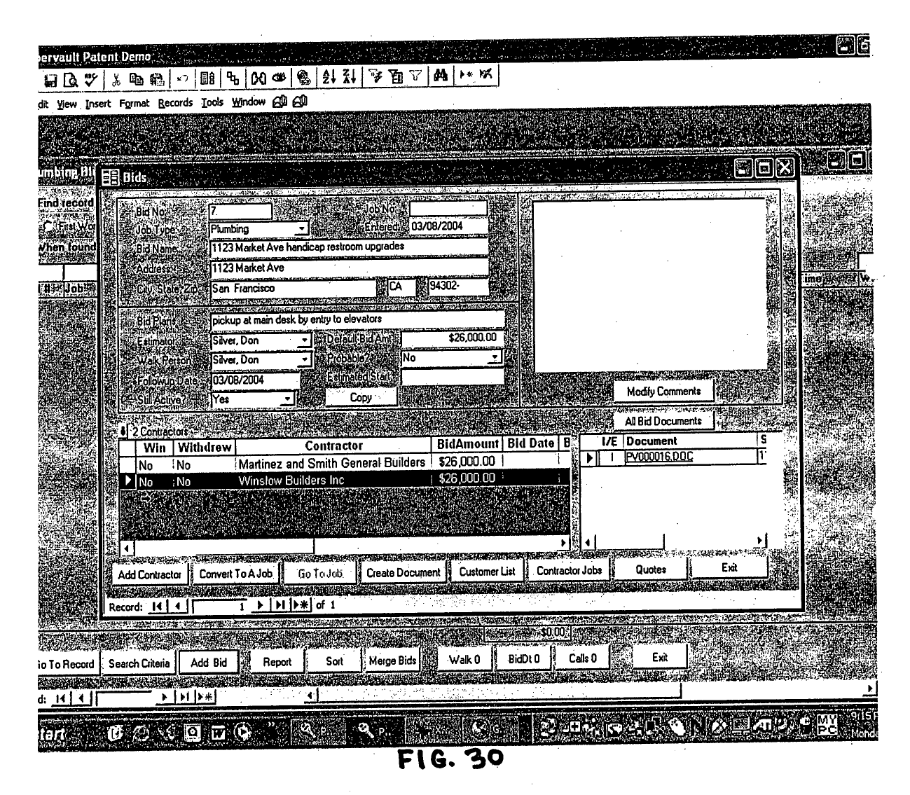

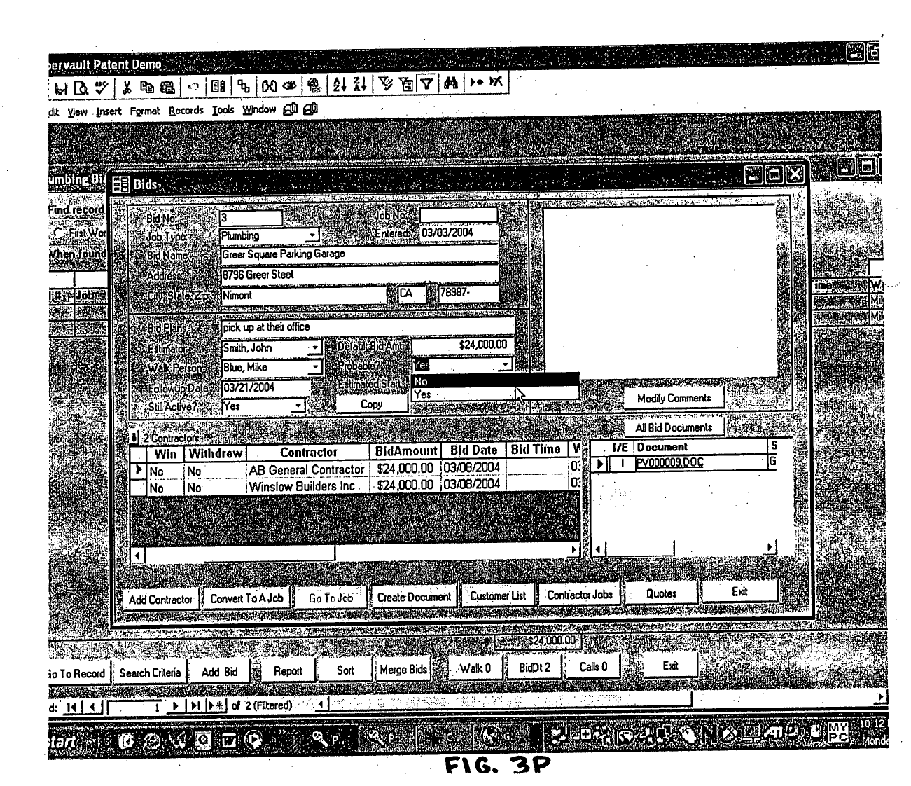

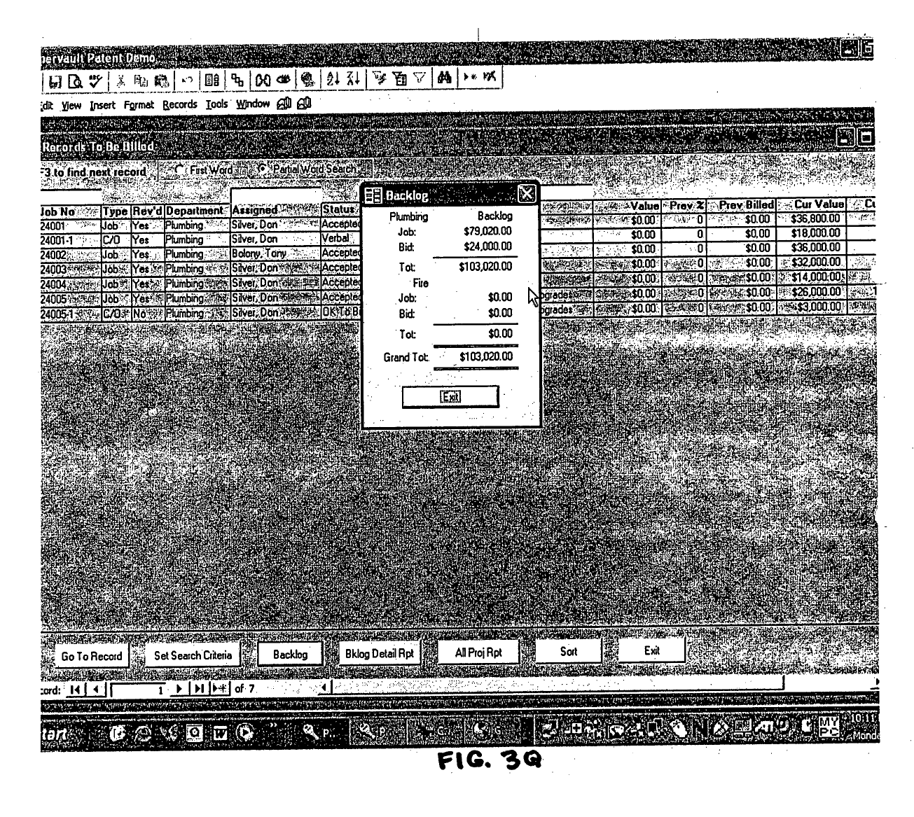

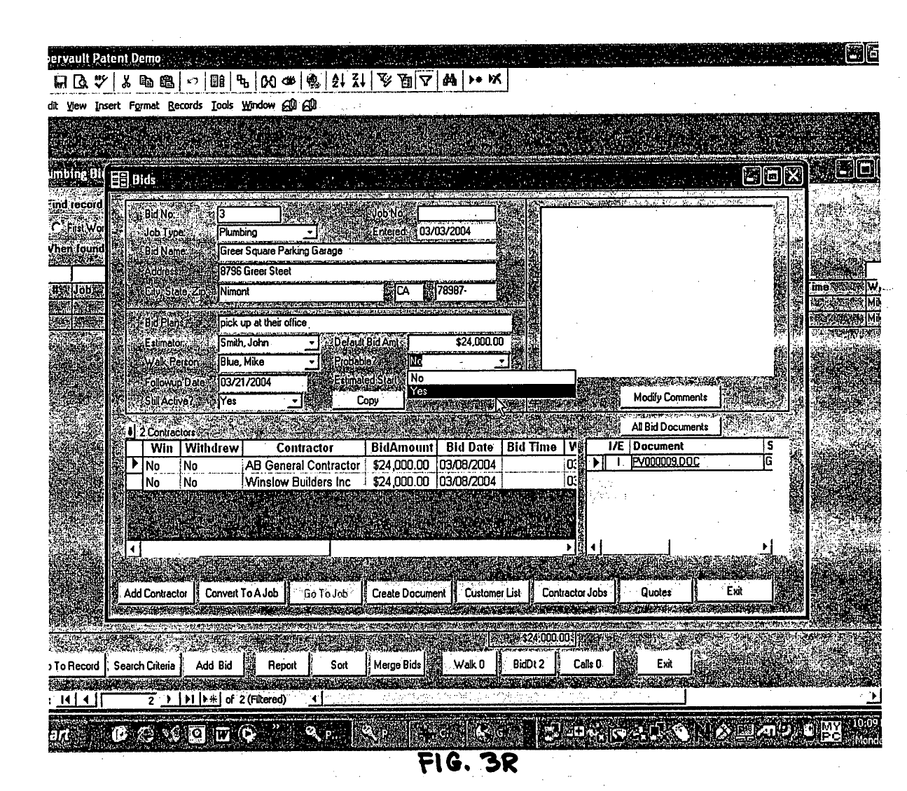

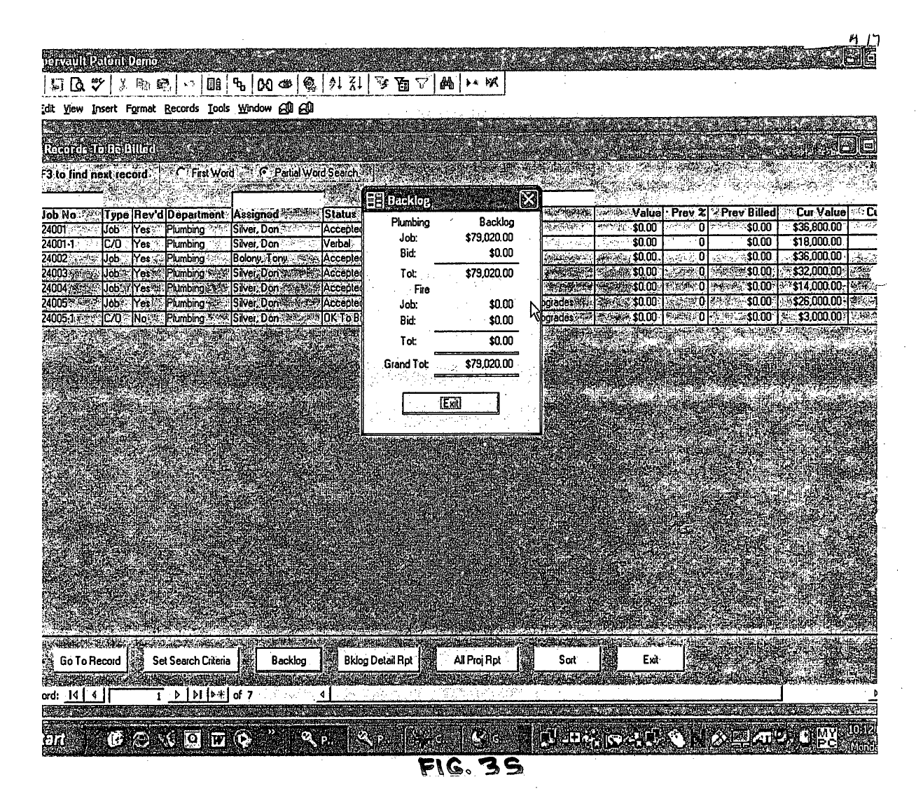

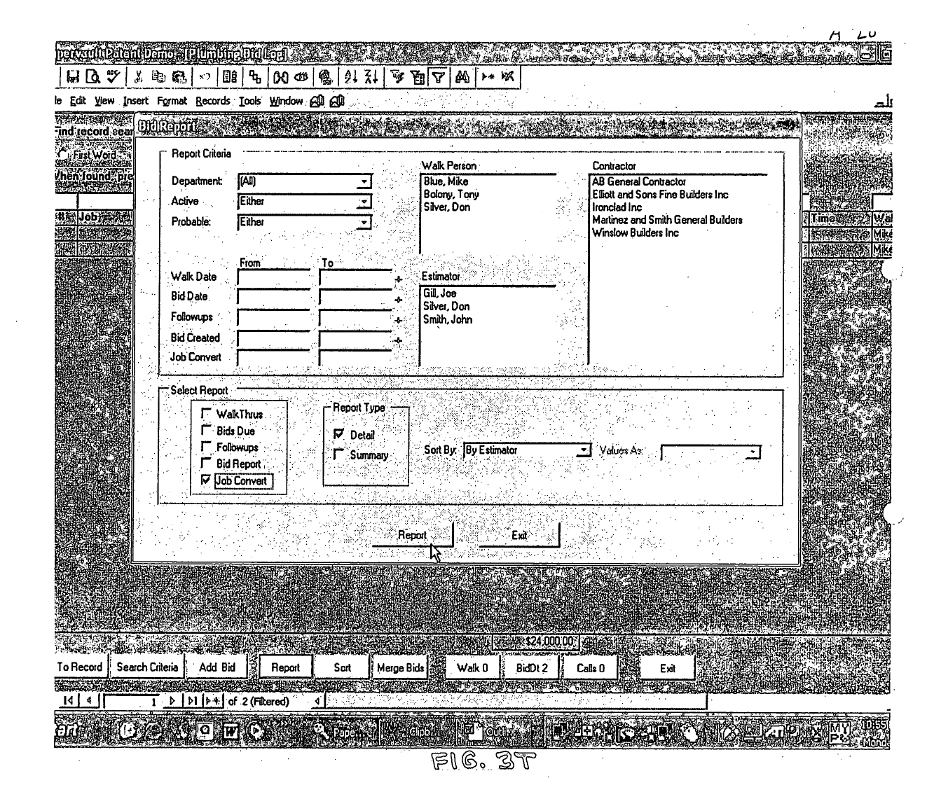

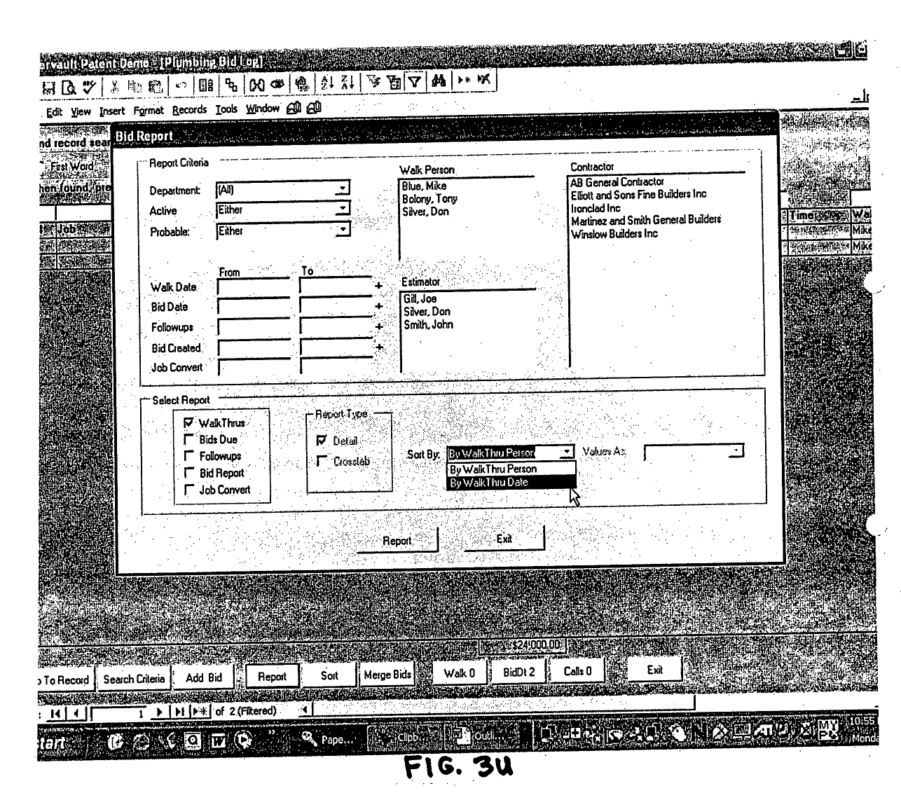

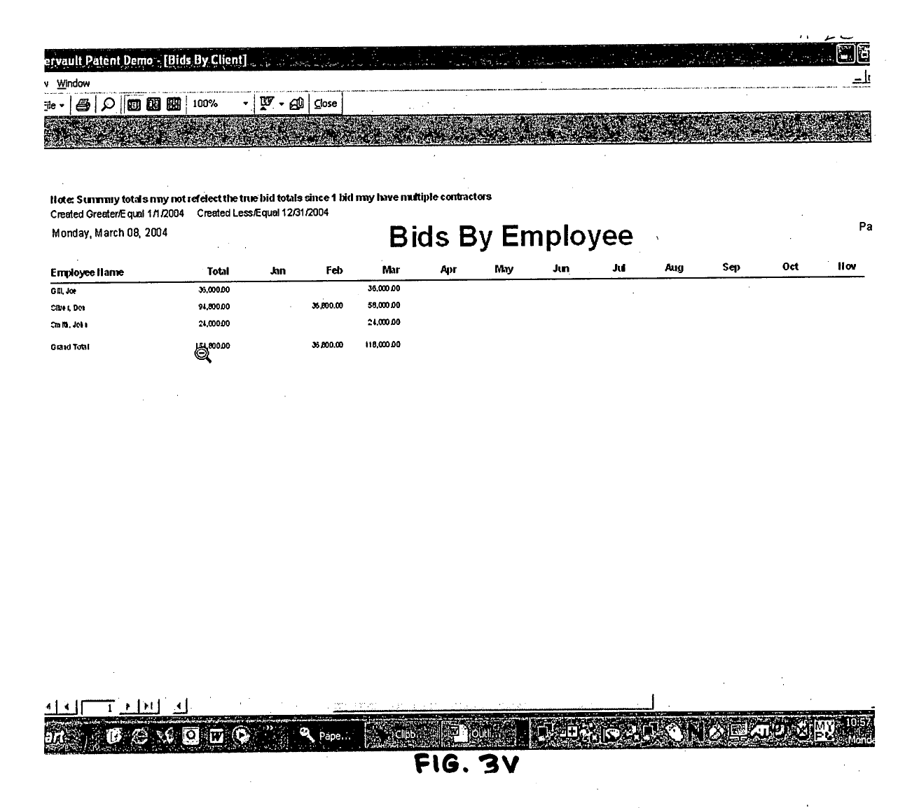

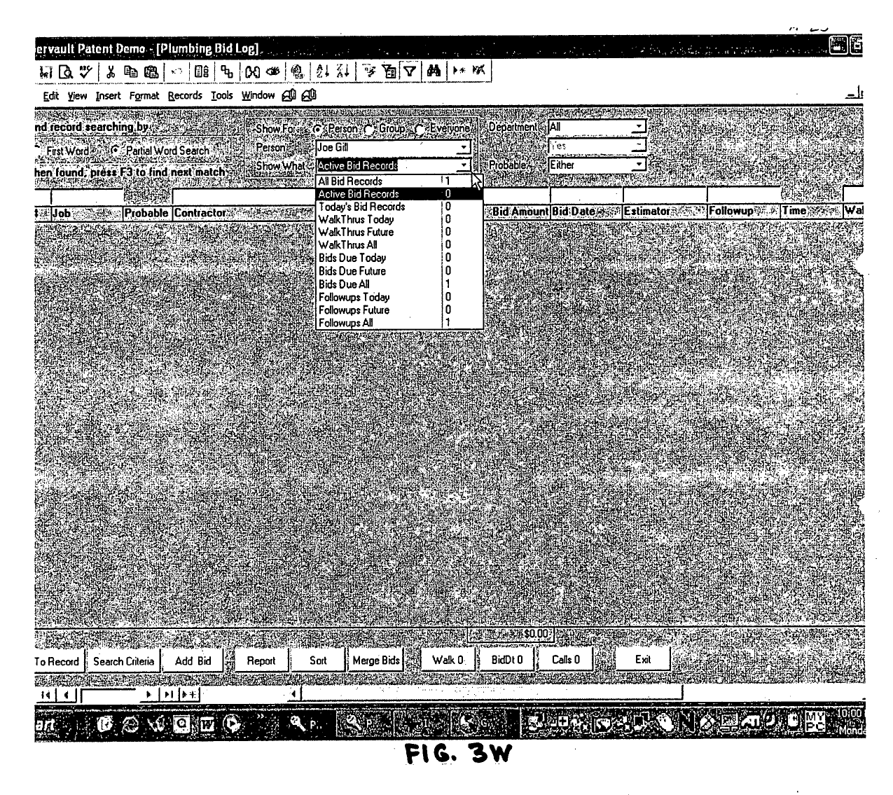

The screen images of FIGS. 3A-3S illustrate processes for creating a new bid.

FIG. 3A is a screen that shows the active bid records whether or not probable, for a fictitious estimator Don Silver in the Plumbing Department. Note the top of the screen contains the filter settings. The bid log is empty. The user may click “Add Bid” to create a new bid.

FIG. 3B shows a warning that pops up so that user is reminded not to enter a new bid more than one time. A new bid should be entered only once, since such actions as are typically required in connection with a bid are all enabled from a single bid record. Consider, for example, the need to create multiple bid letters to various contractors, which the user may do from one bid “record”.

FIG. 3C shows a bid record that is pending completion. The user simply fills in the appropriate information for this bid record.

FIG. 3D shows how the user may add contractors so that the program may create bid letters for them. This bid record already has one contractor, Winslow Builders Inc. To add another, the user clicks “add contractors”.

FIG. 3E shows that a contractor may be selected from a list of contractors. If none of the contractors in the list is the contractor to be added, the user may click the small arrow to add a new contractor.

FIG. 3F shows the addition of another contractor, Martinez and Smith General Builders, to the list of bidders. The bid amount is shown for both contractors, along with whether the contract has been won or withdrawn.

FIG. 3G shows the creation of a first bid letter. The user selects the contractor for the first letter, in this example Martinez and Smith General Builders.

FIG. 3H shows that when the contractor is selected, a form is displayed that contains the appropriate information for the bid letter. The form may be edited. When the form is completed, the user clicks “create document”.

FIG. 3I shows the creation of a bid letter using bid form information merged automatically into a bid template. The user may edit and augment the bid letter as desired for a more complete bid letter.

FIG. 3J shows the creation of the next bid letter, in this case a bid letter to Winslow Builders Inc. First the contractor for this letter is selected. Again there are only two choices in this example, although more choices may be added if desired.

FIG. 3K shows how to select the bid letter to use for the “base” of the new letter. The user has only one option in this case since it is the only other letter that exists. Multiple options would be available if other bid letters had been created or furnished as samples with the program.

FIG. 3L shows the form that is displayed, which contains the appropriate information for the second bid letter. The form may be edited. When the form is completed, the user clicks “create document” to create the second bid letter.

FIG. 3M shows the creation of a second bid letter using bid form information merged automatically into the selected bid template. The user may edit and augment the second bid letter as desired for a more complete bid letter.

The bid letters are accessible via hyperlinks in the I/E Document window. FIG. 3N shows that an arrow on the left, in this case next to “Martinez and Smith General Builders,” indicates which letter is displayed on the right side as a hyperlink.

FIG. 3O shows that when the arrow on the left points to “Winslow Builders Inc.,” the document on the right is specific to them. The user can select the “All Bid Documents” button to see both displayed.

FIG. 3P shows that if the “Probable” field is set to Yes, then the amount of the bid is added to a backlog tracking feature which is shown on the next screen.

FIG. 3Q shows a pop-up screen that displays backlog data. The screen indicates that the backlog for probable bids is now $24,000, and the total backlog, including jobs and bids, is $103,020.

FIG. 3R shows an alternative “Bids” screen for estimator John Smith. Although John Smith has a bid in for Greer Square Parking Garage, the “Probable” field is set to “No.”

The result of probable=“No” is shown in the alternative screen of FIG. 1S, which shows that the $24,000 bid is not included in the backlog. The Backlog screen is an excellent method to understand how much work is coming in the future and how much incomplete contract work is on the books.

The various screen images of FIGS. 3T-3W illustrate processes for creating several useful bid reports.

FIG. 3T shows a form for selecting a report sorted by estimator. The user may select various reports from how much was bid by (1) one or more individuals (2) in a department or in all departments, (3) within a timeframe, (4) by contractor, and (5) by a variety of other filter parameters, if desired.

FIG. 3U shows a select bid report form for bids and walk-throughs by date and by walk-through person.

FIG. 3V shows a report of Bids by Employee.

FIG. 3W shows that many different logs are available, and allows any one to be selected for viewing. A counter for each log is available.

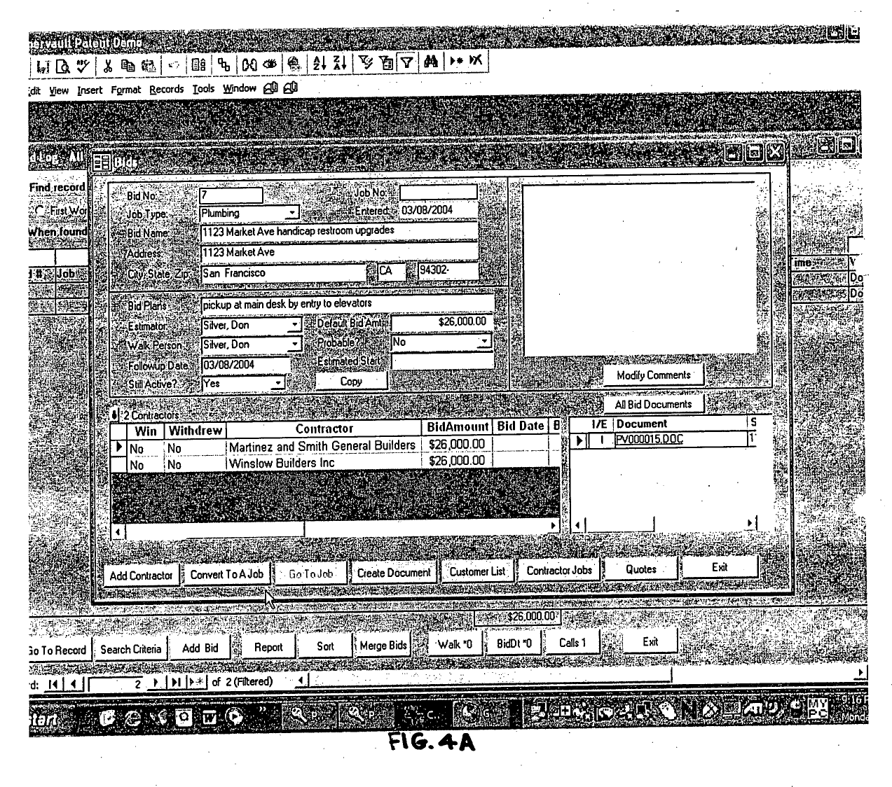

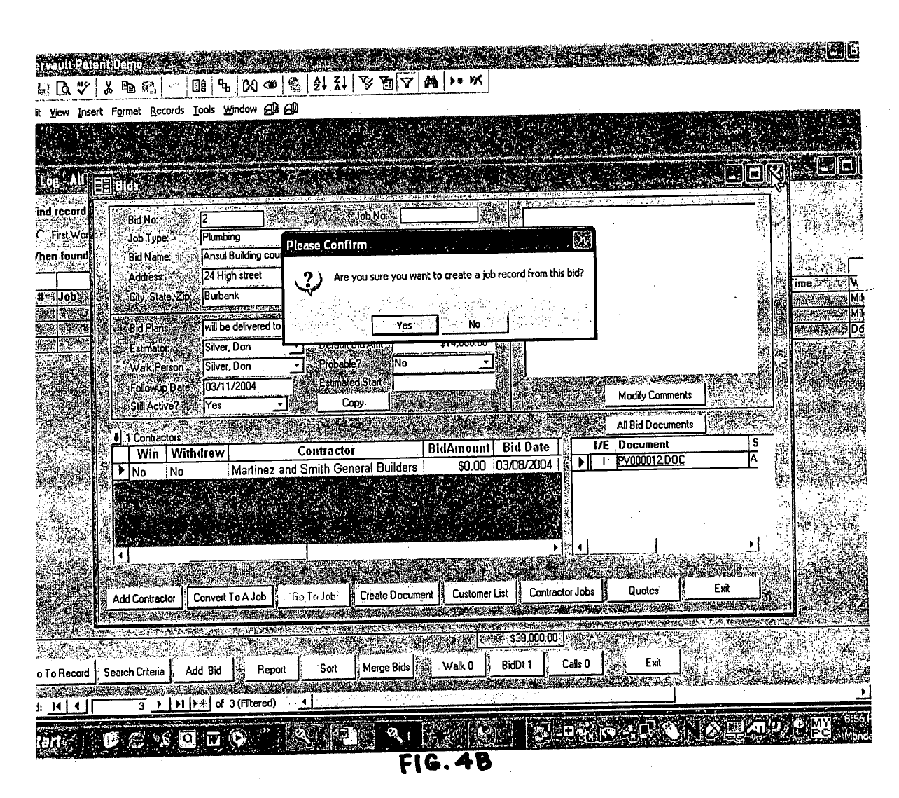

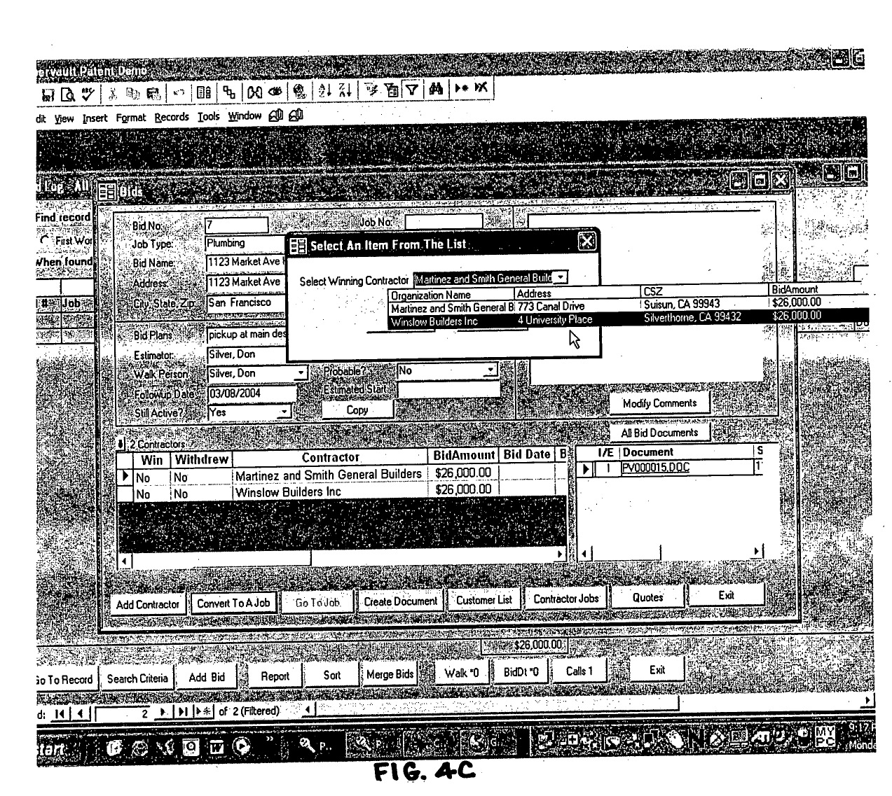

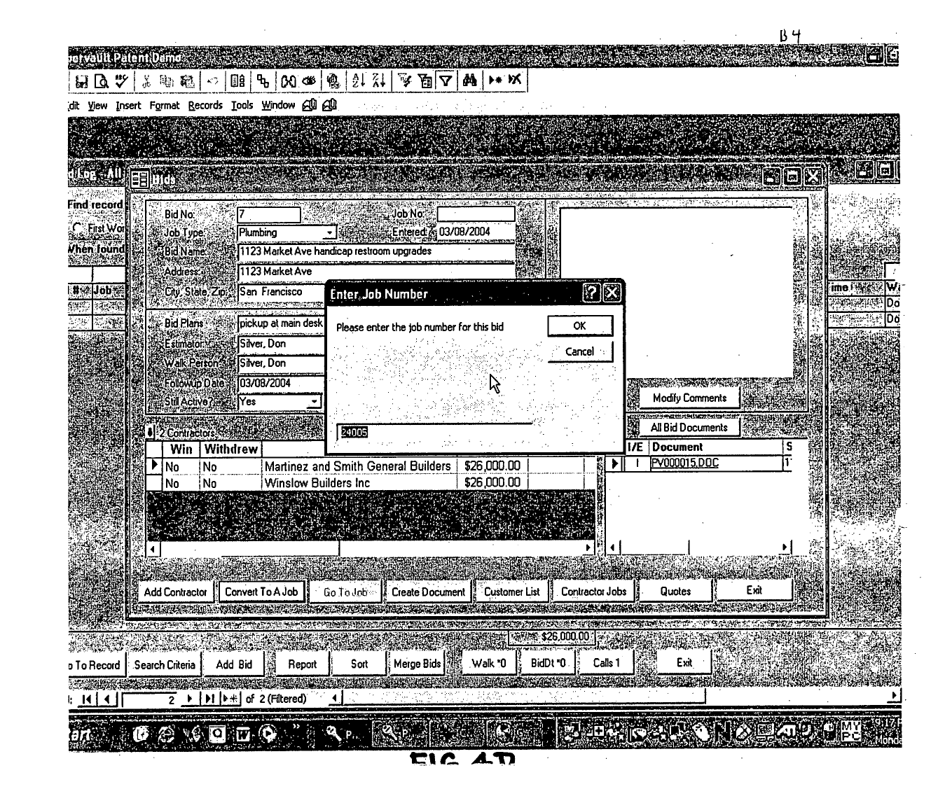

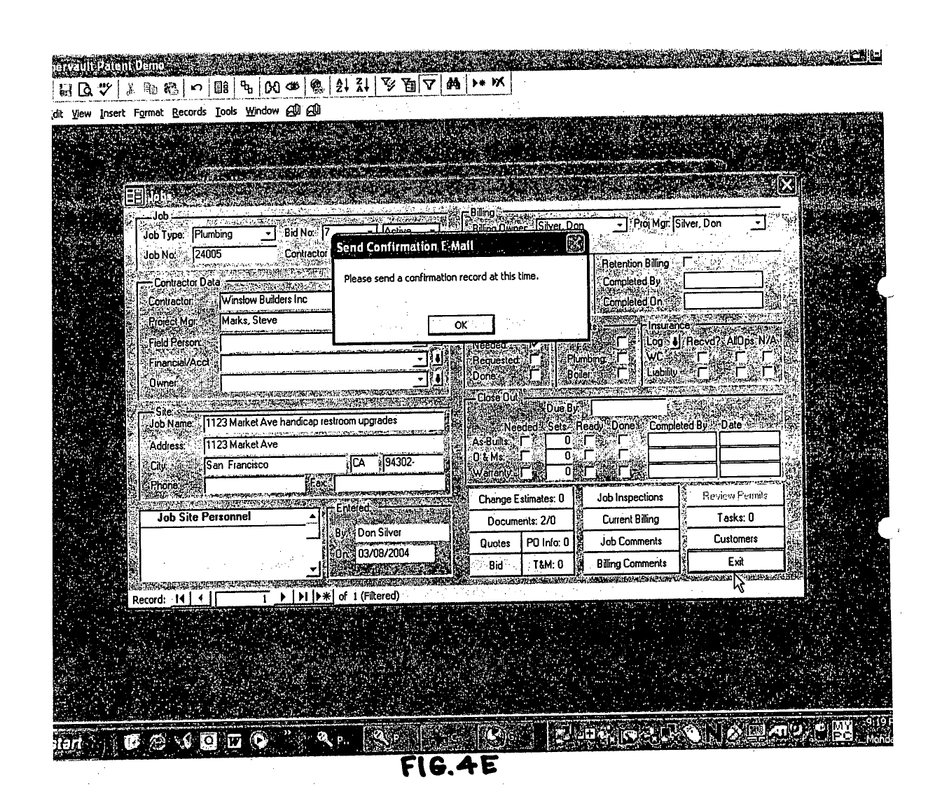

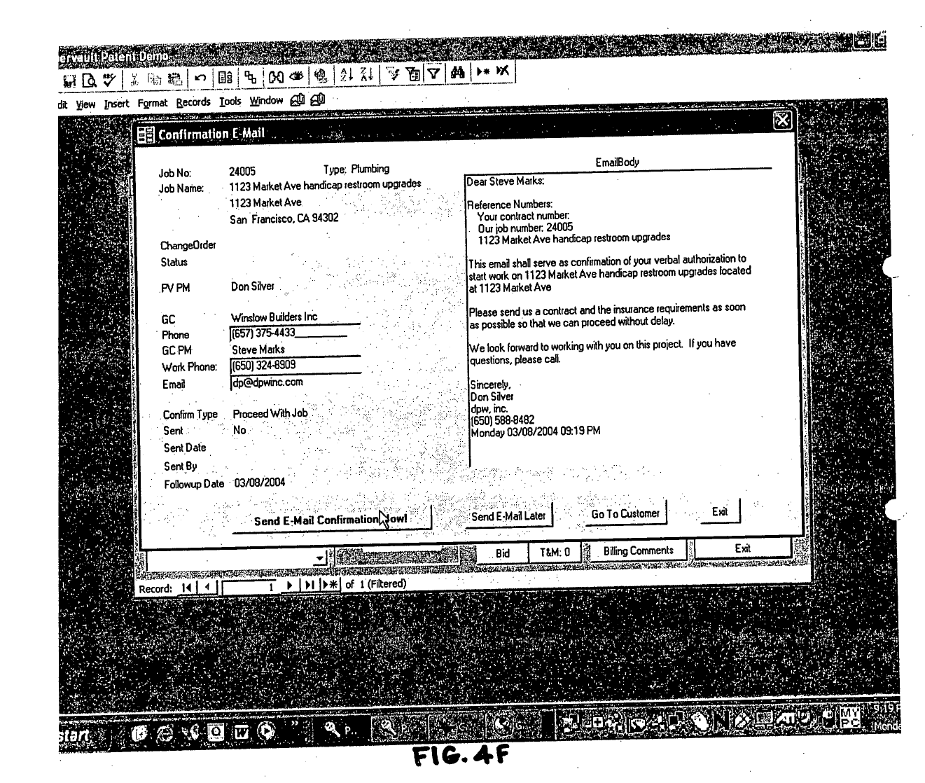

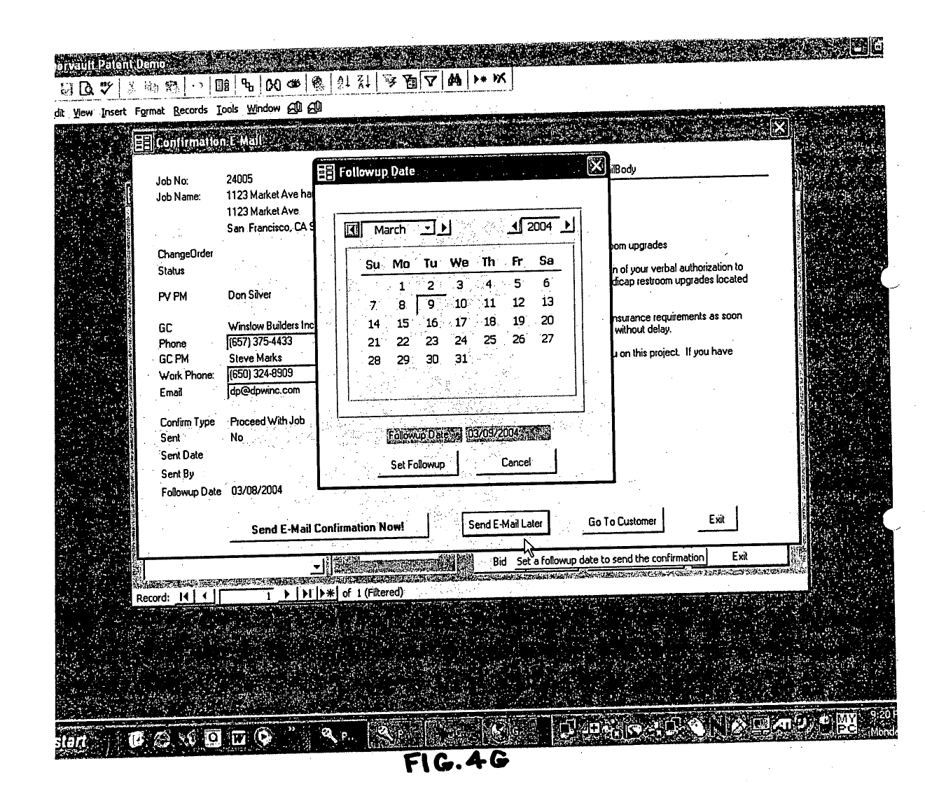

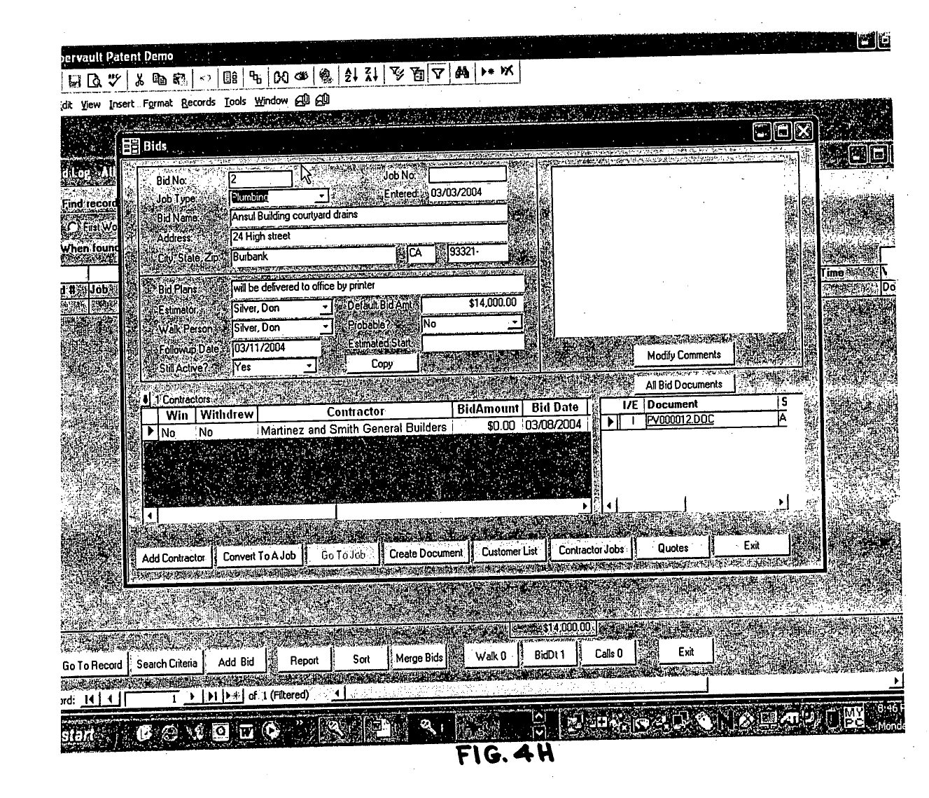

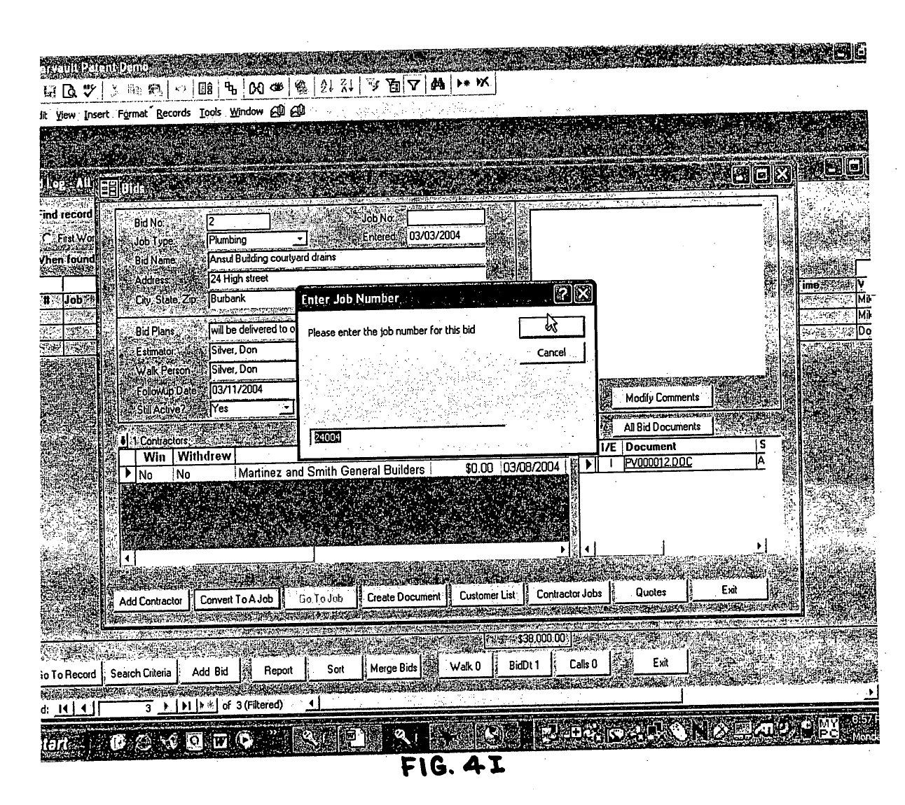

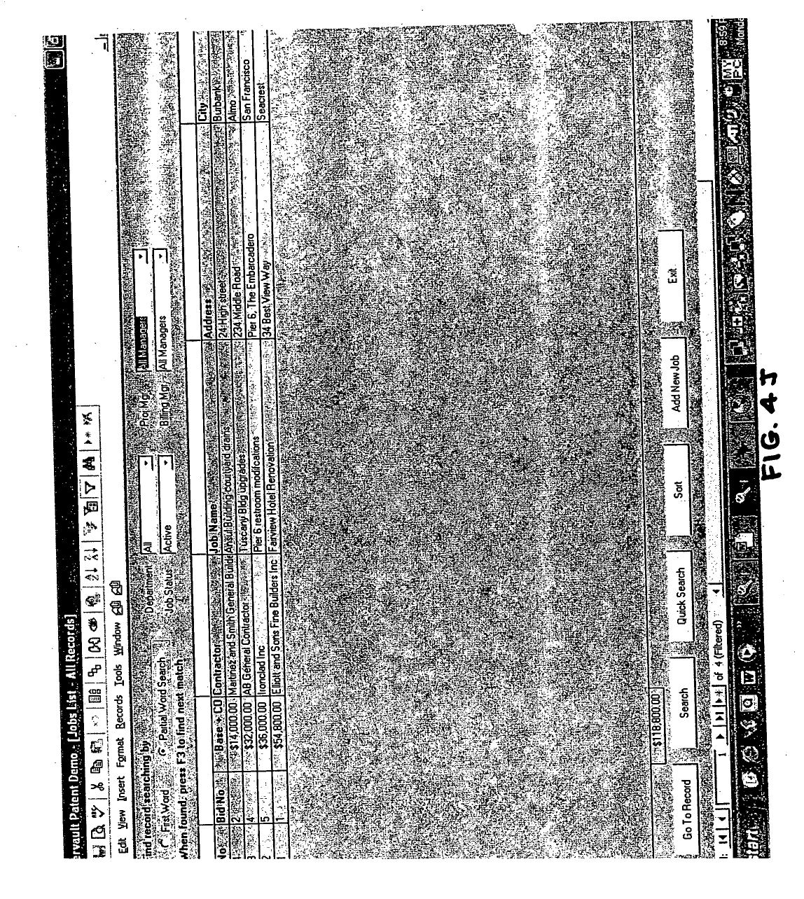

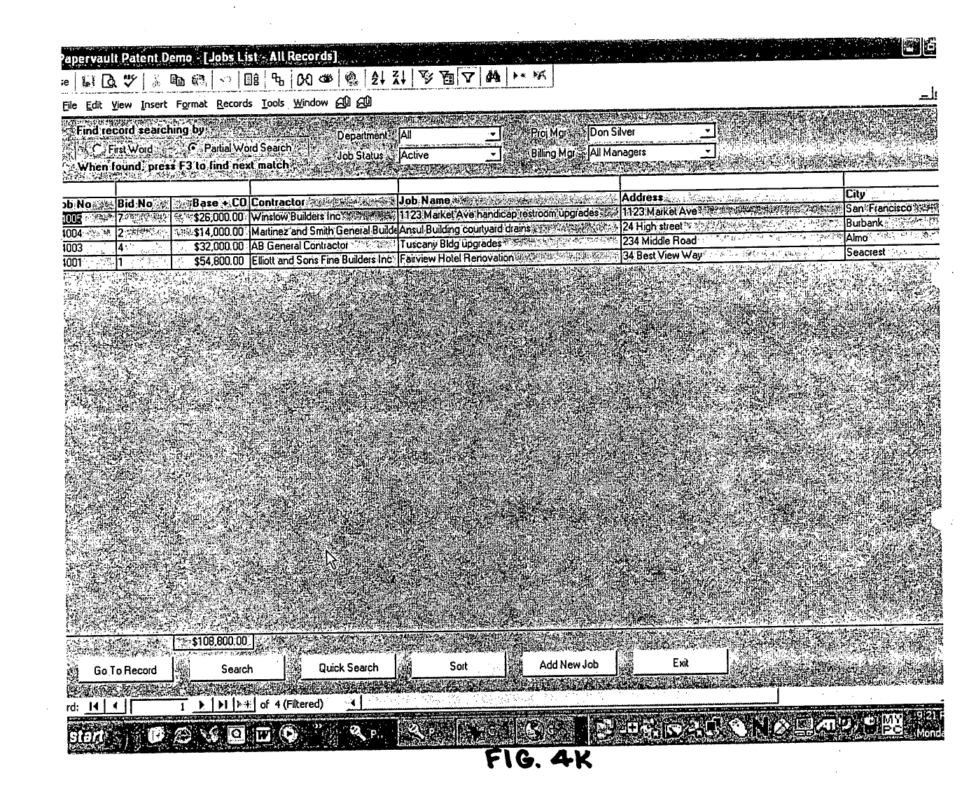

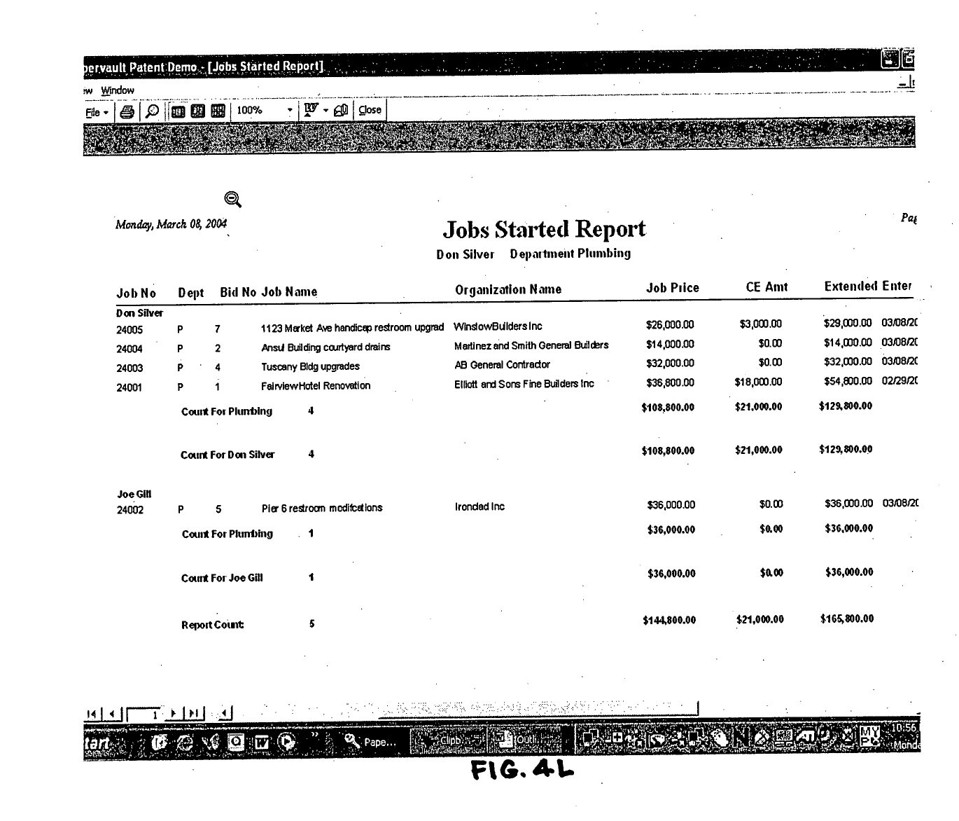

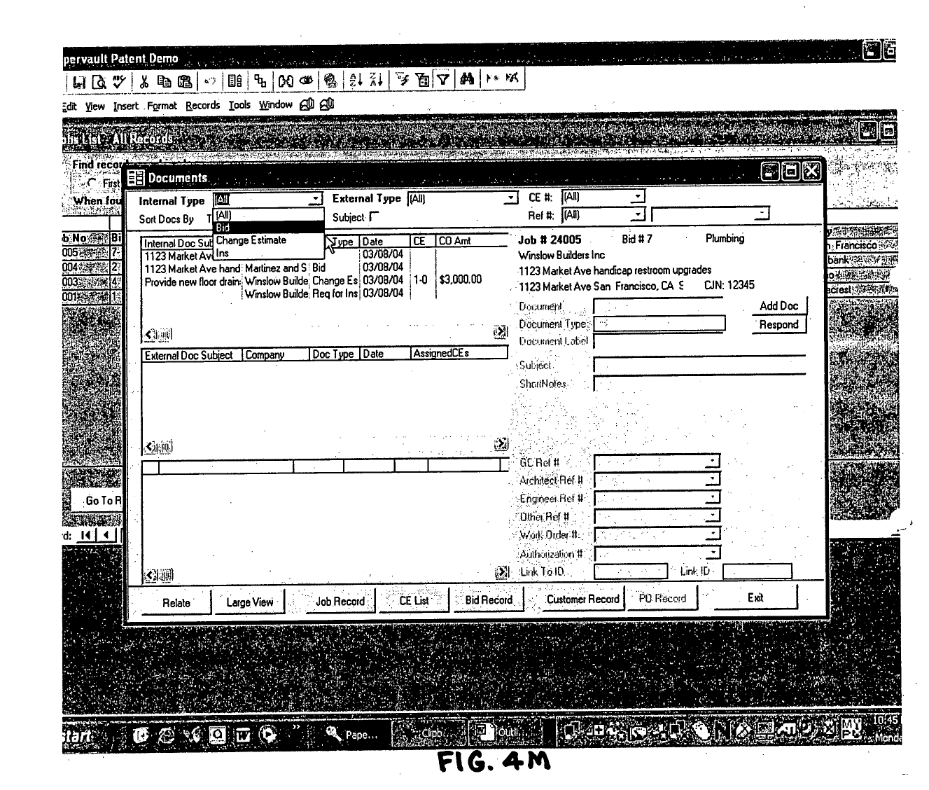

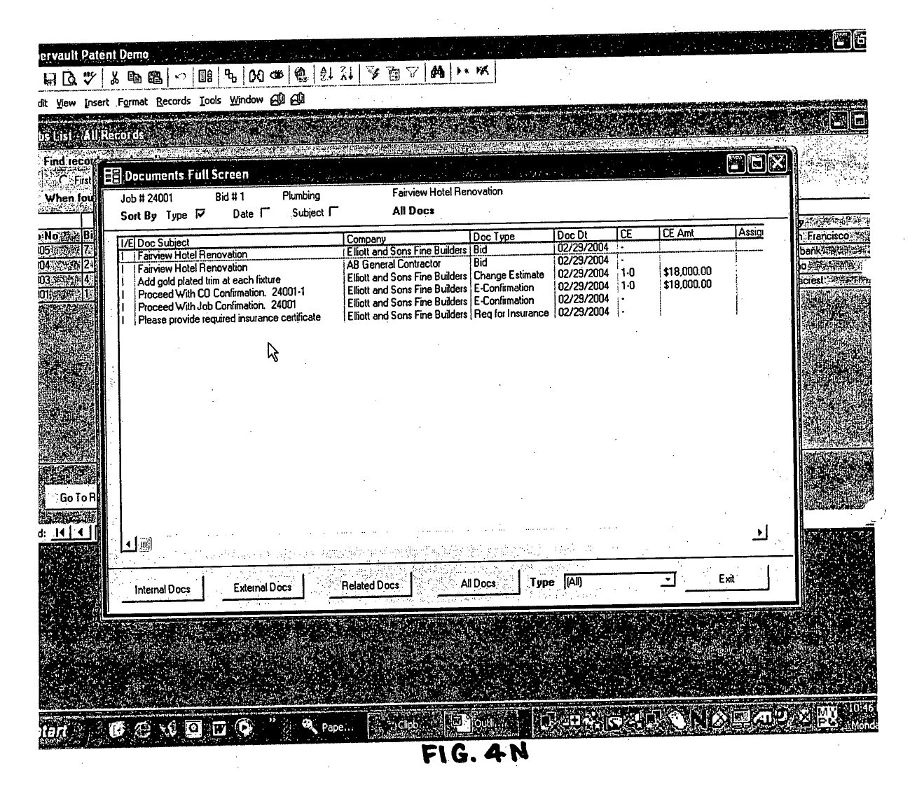

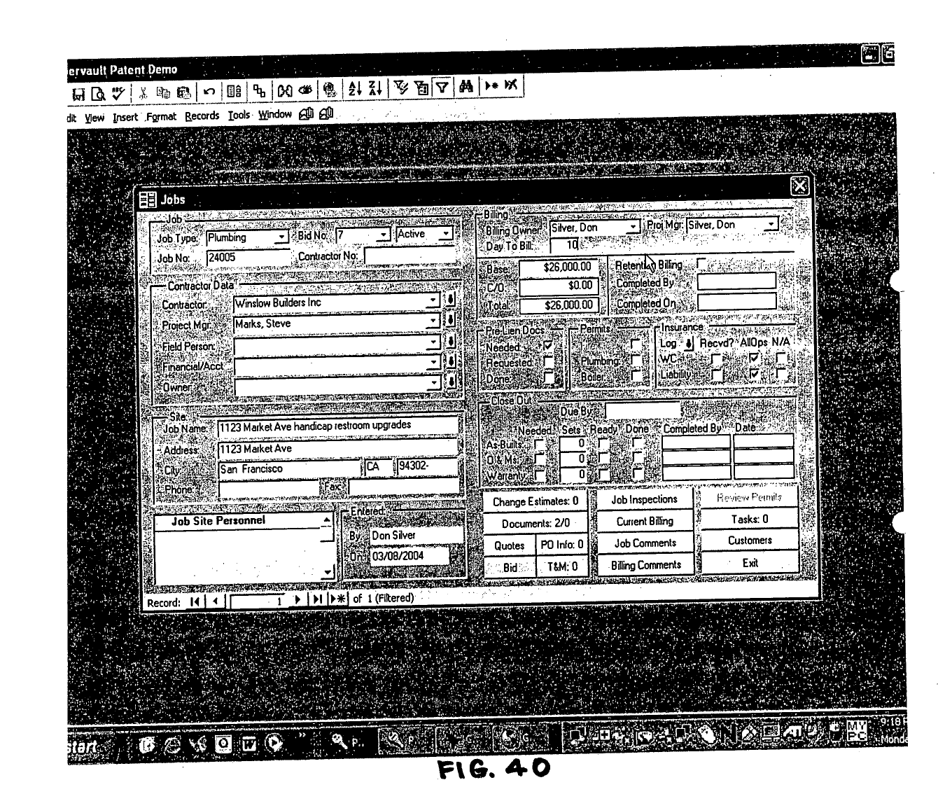

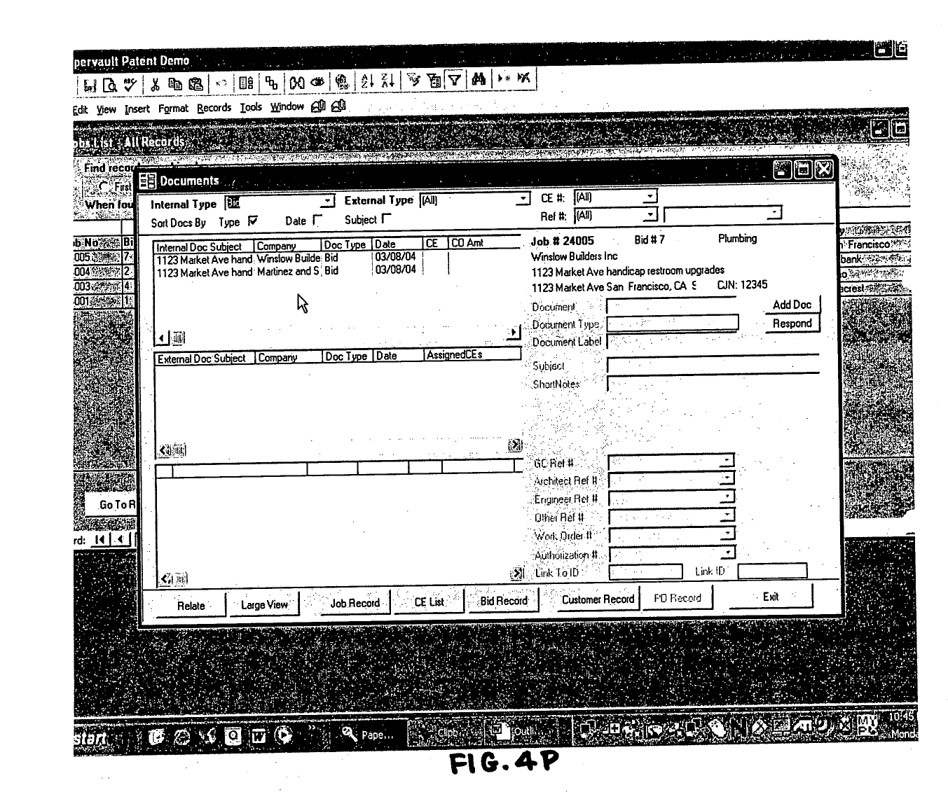

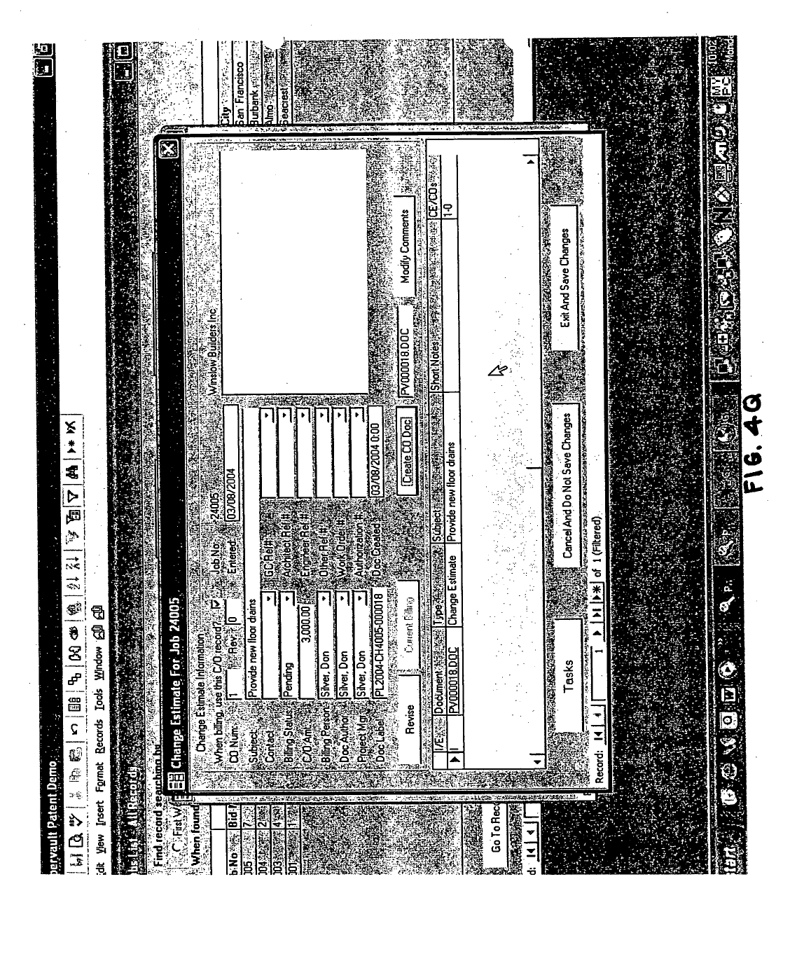

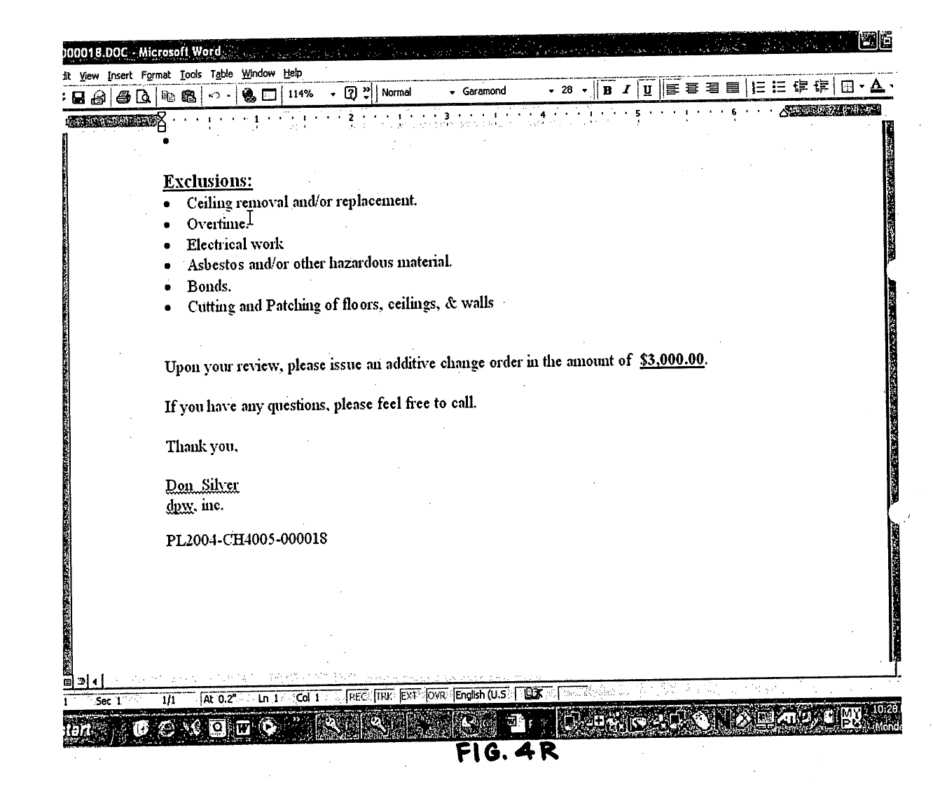

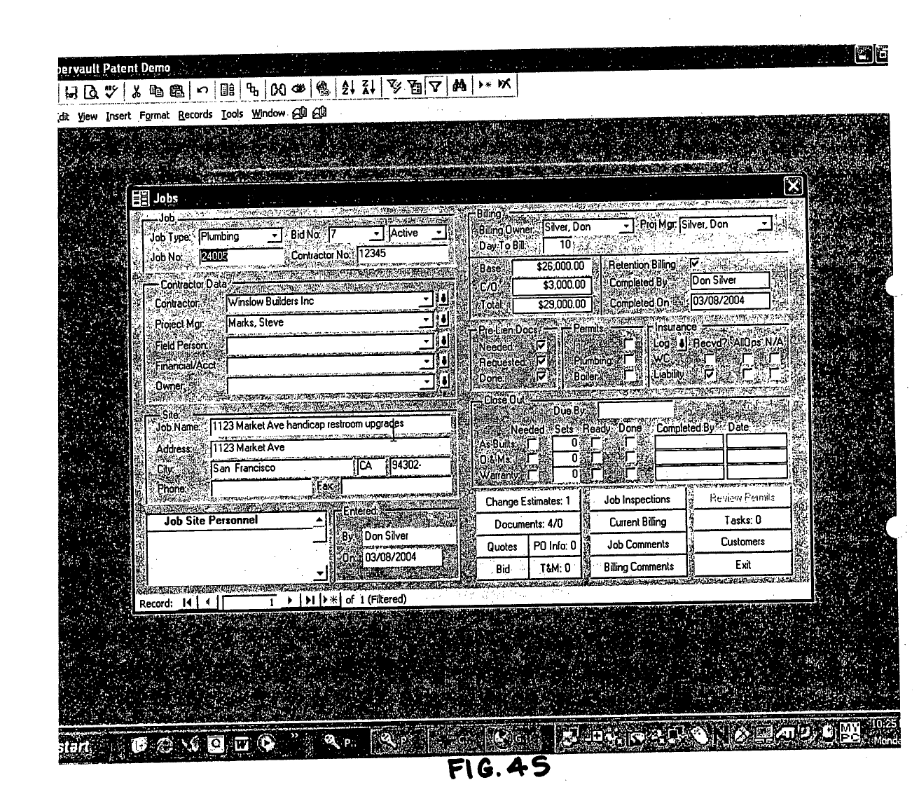

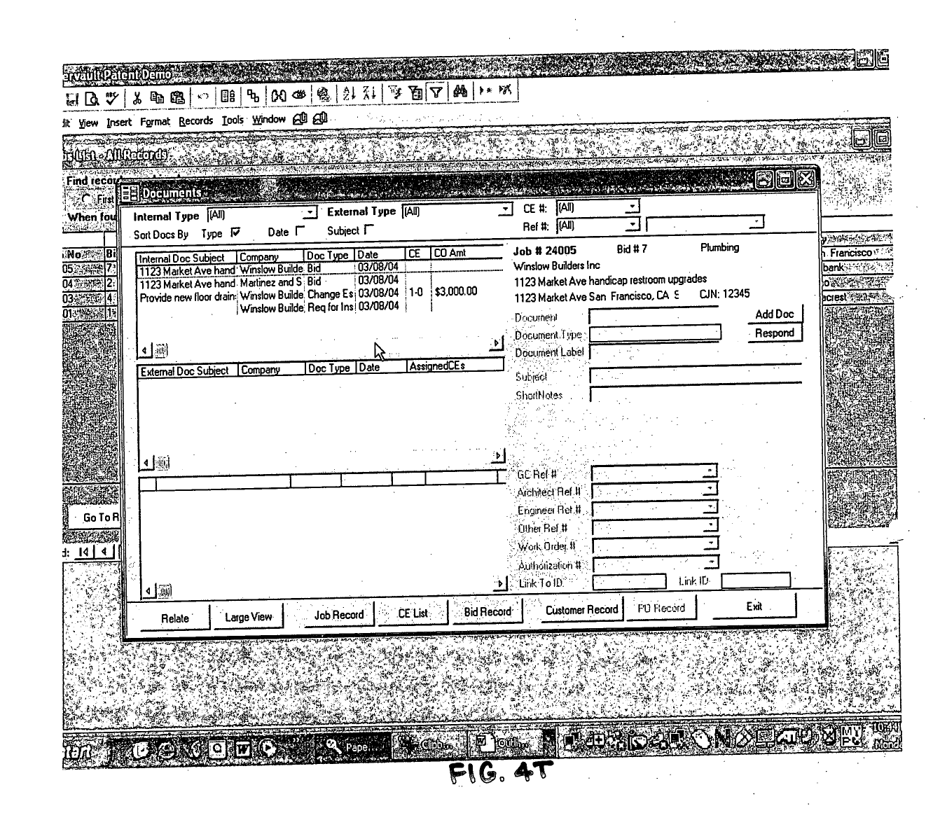

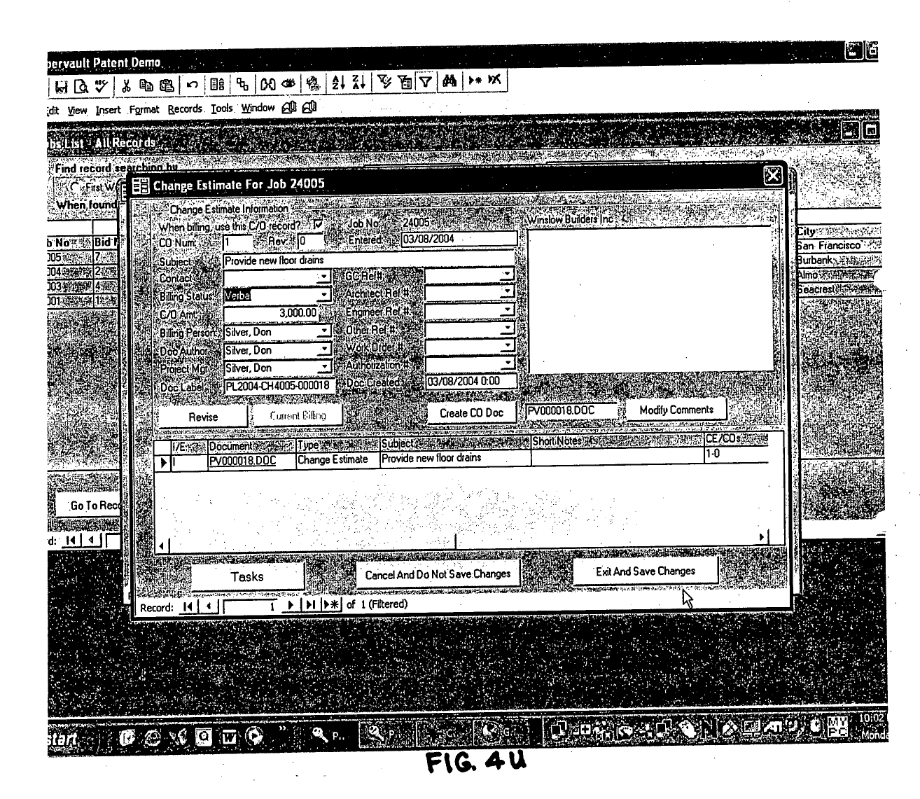

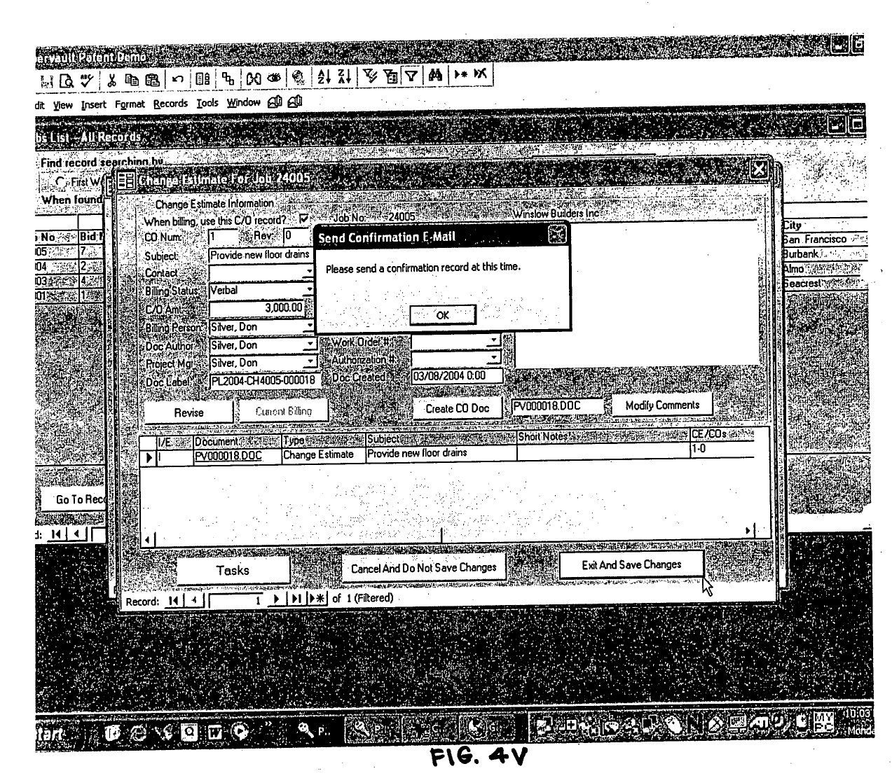

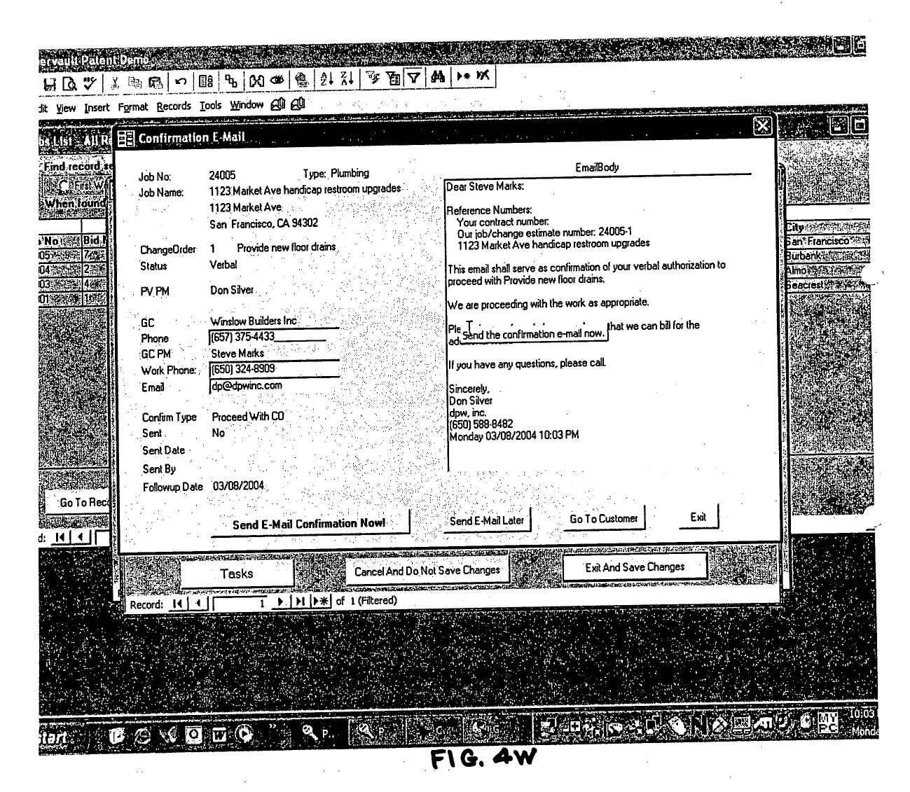

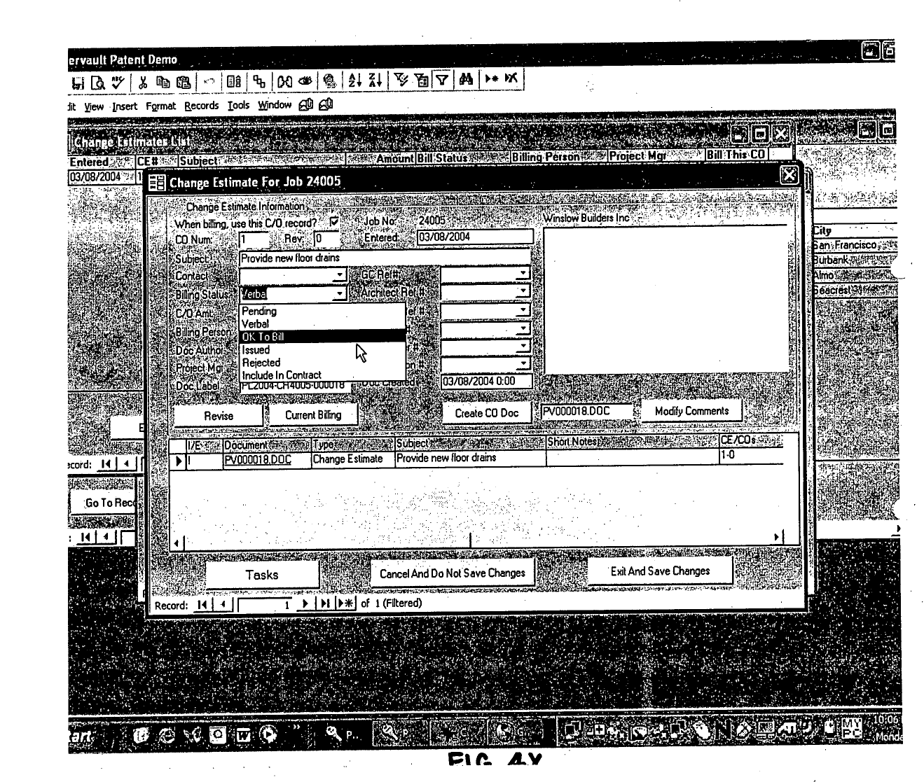

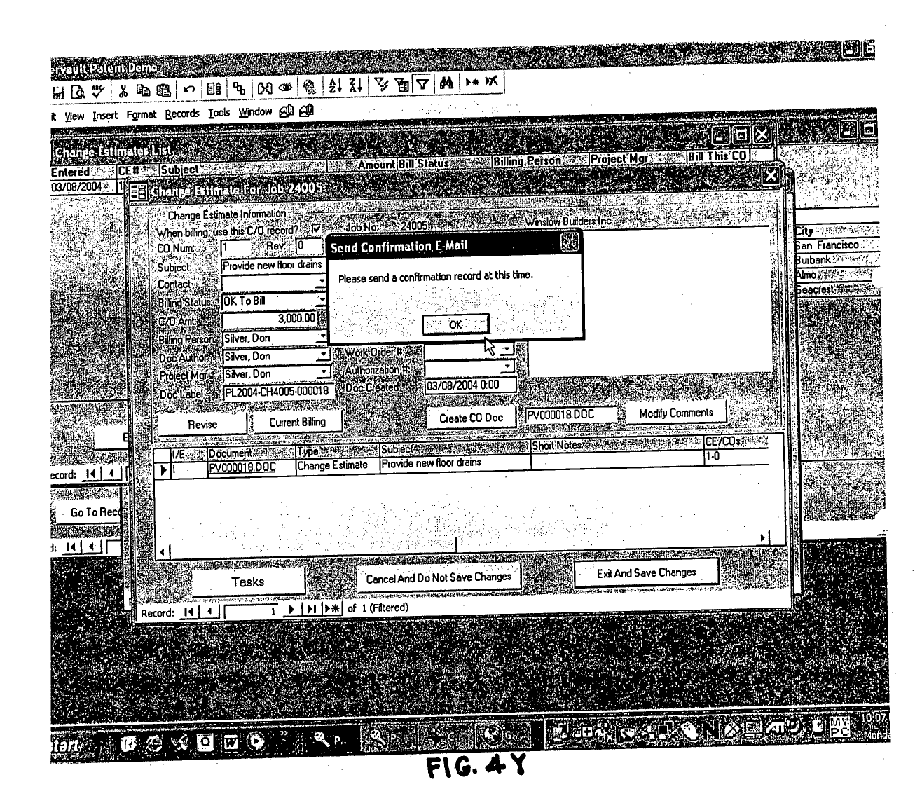

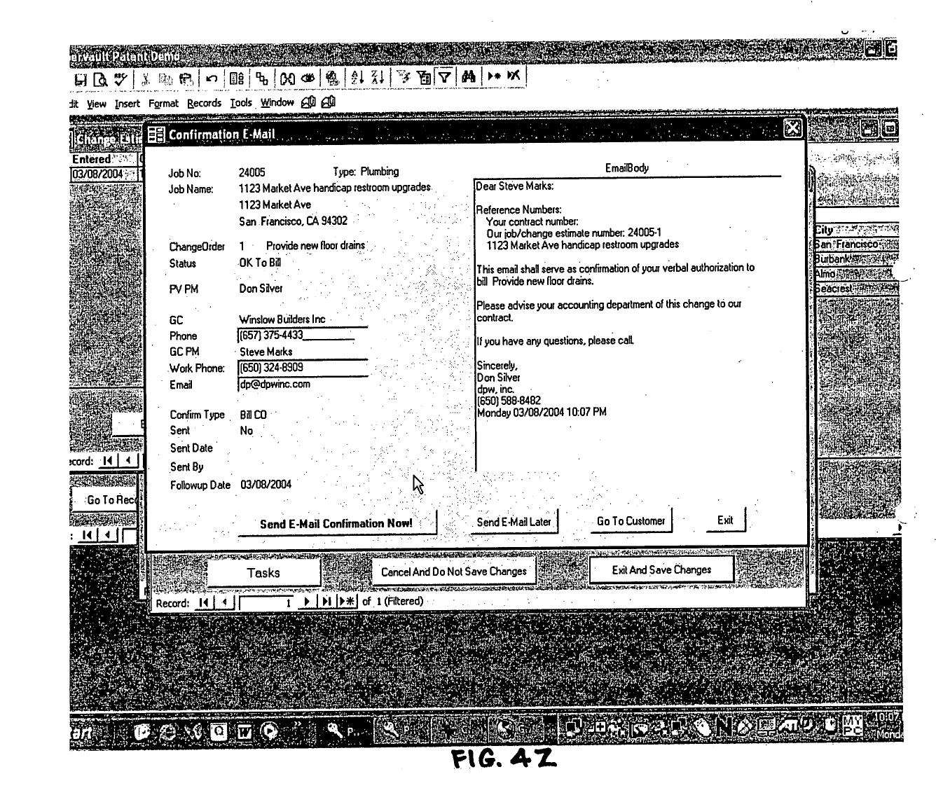

The screen images of FIG. 4 illustrate a process for showing a new job from setup to a completed job screen.

FIG. 4A shows the bid record for the “1123 Market Ave handicap restroom upgrades” bid. One of the contractors has informed the user that it has won the work. From the bid record the user selects “Convert to a Job”.

FIG. 4B shows that a message is displayed to remind the user to check whether the job has already been created, possibly by someone else.

FIG. 4C shows that when the user clicks on “Yes” a popup window is displayed from which the successful contractor may be selected. The user will be working with this contractor on this project.

FIG. 4D shows a screen that requires confirmation of the default next job number, or requests that a new job number be entered. The user completes the job screen information, after which the program is ready to be uses for project management. The user also establishes other information, such as by selecting the project manager and the responsible billing person, setting the day the invoice for the job is due to the general contractor, and confirming the bid amounts, phone numbers, faxes numbers, and so forth.

FIG. 4E shows that upon exiting a new job screen, the user is reminded that a confirming email will be sent from the project manger to the general contractor.

FIG. 4F shows the default email that is created to confirm the subcontractor's intention to start the project. The user may edit the confirming email as desired, and can send the completed email immediately or later.

FIG. 4G shows a screen that is displayed when delayed sending is desired. A calendar is displayed in a popup window to enable the user to select a date for the delayed send.

FIG. 4H shows that another job may be created at this time, if desired. Assume that Martinez and Smith General Builders has won a project. Upon being informed, the user creates another job by first displaying the bid screen and clicking “Convert to a Job.”

FIG. 4I shows that a job number is created for the new job.

FIG. 4J shows that a log of jobs may be created using the filters “all managers” and “active.”

FIG. 4K shows that a log of jobs may be created using the filters of Project Manager “Don Silver” and Job Status “Active,” as indicated by the filter settings at the top of the displayed screen.

FIG. 4L shows a report that may be produced, which shows all bids converted to jobs. The report may be sorted on any desired field, whether by date, customers, average, and do forth.

FIG. 4M shows that documents may be easily searched using various search methods at the document screen.

FIG. 4N shows a large view of the document screen from a different perspective.

FIG. 4O shows that from the Jobs screen, the user may check a variety of notes from other parts of the program that are carried over to the job screen. Illustrative examples include billing notes (available via the Billing Comments button) pre-lien documents, permits, insurance, change estimate notes (available via the Change Estimates button), and so forth.

FIG. 4P shows a Documents screen that lists the two original bid letters. Note that no change orders have been entered for this job, as indicated by the zero appearing on the CE Change Estimates counter in FIG. 4O, and by the absence of any other documents in the Internal Document list of FIG. 4P.

A change order will now be created. From the Jobs screen as displayed in FIG. 4O, selecting “Change Estimates” and “add” brings up the Change Estimate screen of FIG. 4Q. The user fills in the Change Estimate screen and sets the Billing Status as “Pending” (for this example). A change order is then created by clicking on “Create Document.”

FIG. 4R shows a change order which may be sent out as is or fine-tuned as desired. It has job specific information merged into a change order template. As is so for other documents created by the program, the change order is given a unique identification string showing year, department, job or bid number, document type and document identification number.

FIG. 4S shows the Jobs screen, as it might appear after the change order. Note that the counter has gone up a notch showing that a change order does now exist for this job.

FIG. 4T again shows the Document screen as it might appear after the change order. The new change order appears in the Internal Document list. The Internal Document list also shows a new insurance certificate request, the creation of which may have been done by a process described below.

FIG. 4U shows how the pending change estimate is converted from a pending billing status to a verbal billing status, after receipt of a verbal approval by the contractor.

FIG. 4V shows that when the billing status is changed to “Verbal,” the program indicates to the user that a confirmation record should be sent. Since we are proceeding with the work we need to confirm our intent until we have sufficient paperwork to allow us to bill.

FIG. 4W shows a suitable confirming email generated by the program.

FIG. 4X shows that the billing status is changed from “Verbal” to “OK to Bill” when the user is given authorization to bill a change estimate prior to having a signed change order form the general contractor.

FIG. 4Y shows that the confirmation email may be sent either now or on a later date.

FIG. 4Z shows the text of the email confirming the verbal authorization to bill. The text may be sent as is or edit in any desired manner, and may be sent now or later.

A great many other capabilities are provided by the program as part of the Job creation process. Illustratively, the user may view contracts and change orders, insurance certificates or any other document type whether created in-house of scanned to the system. Any document may be converted to a program template, and any program template may incorporate any one or more of the program fields and be made accessible throughout the program. These custom templates may be filled in with job or bid specific information, and schedules of values or lump sum job values can be set.

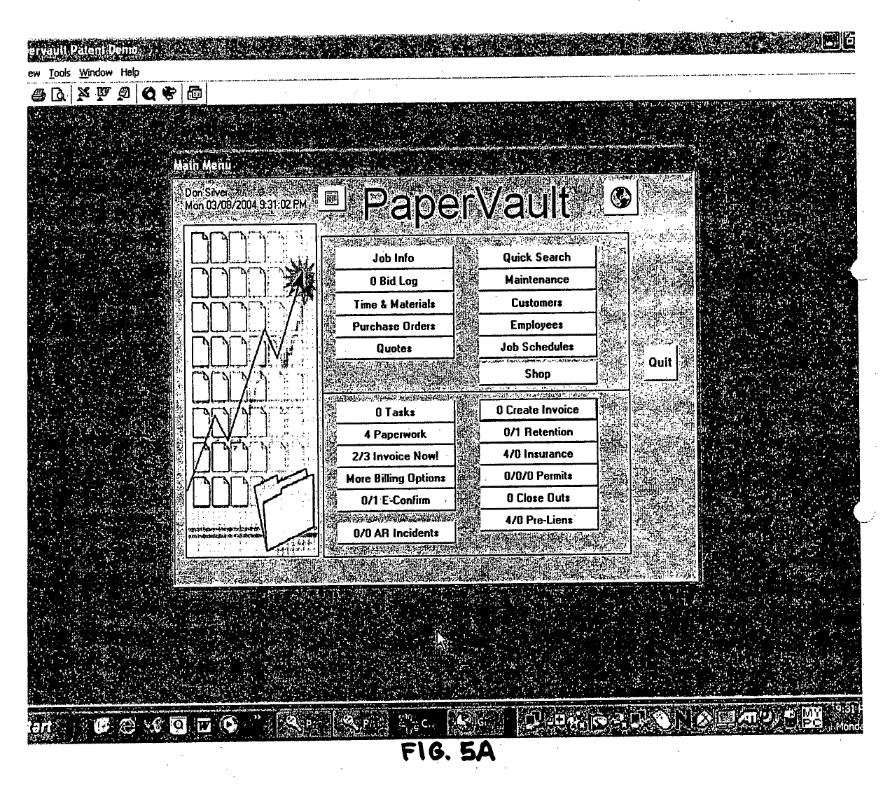

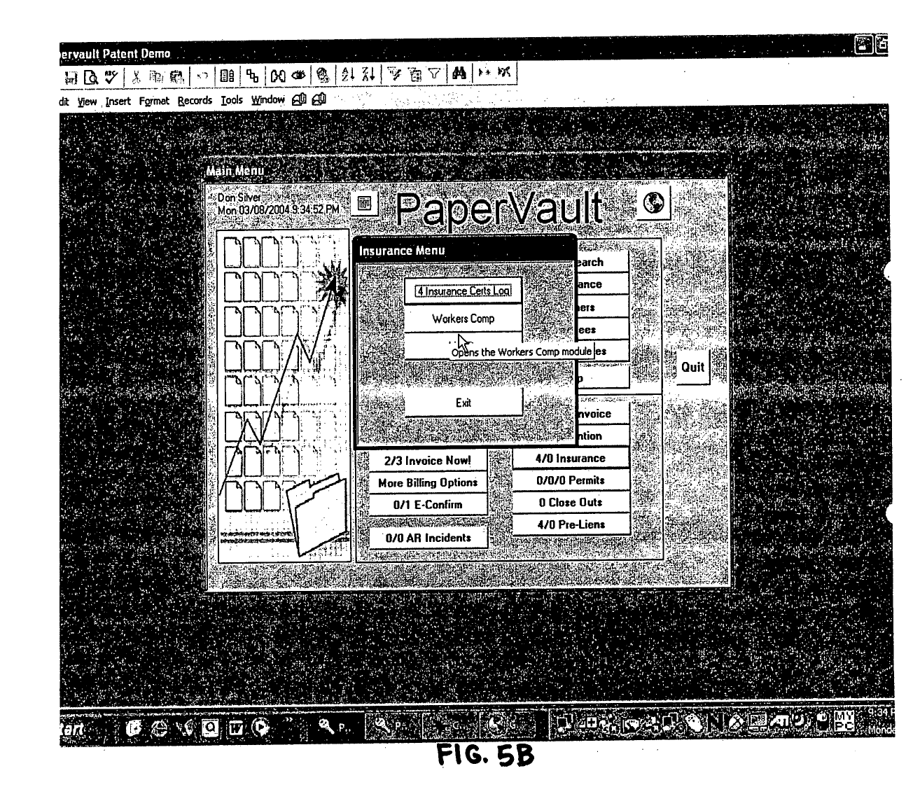

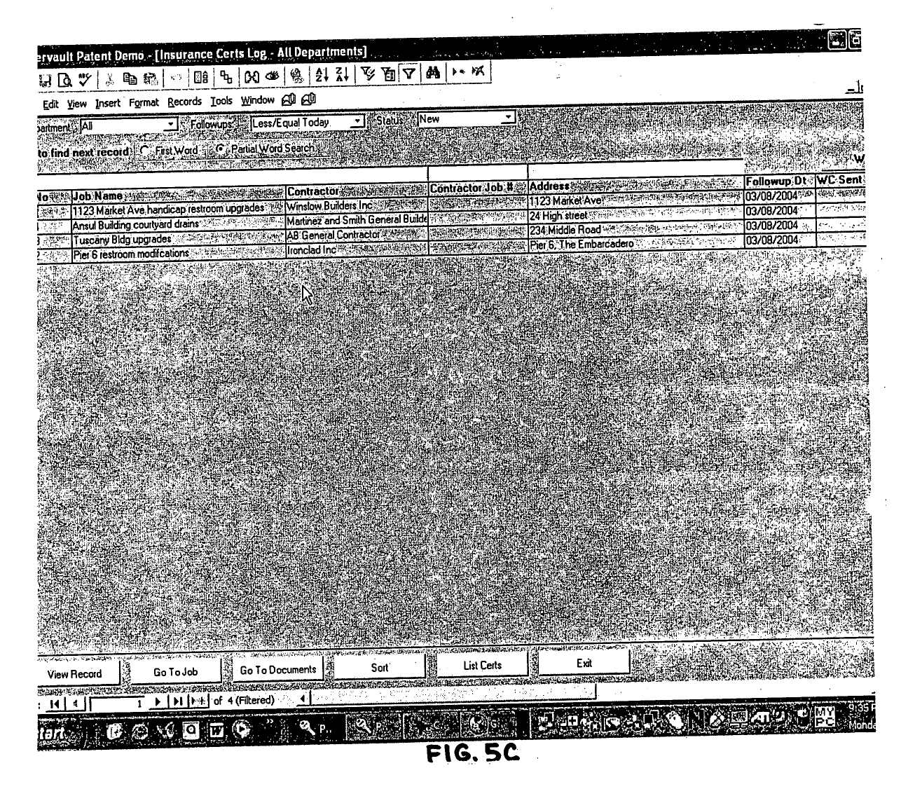

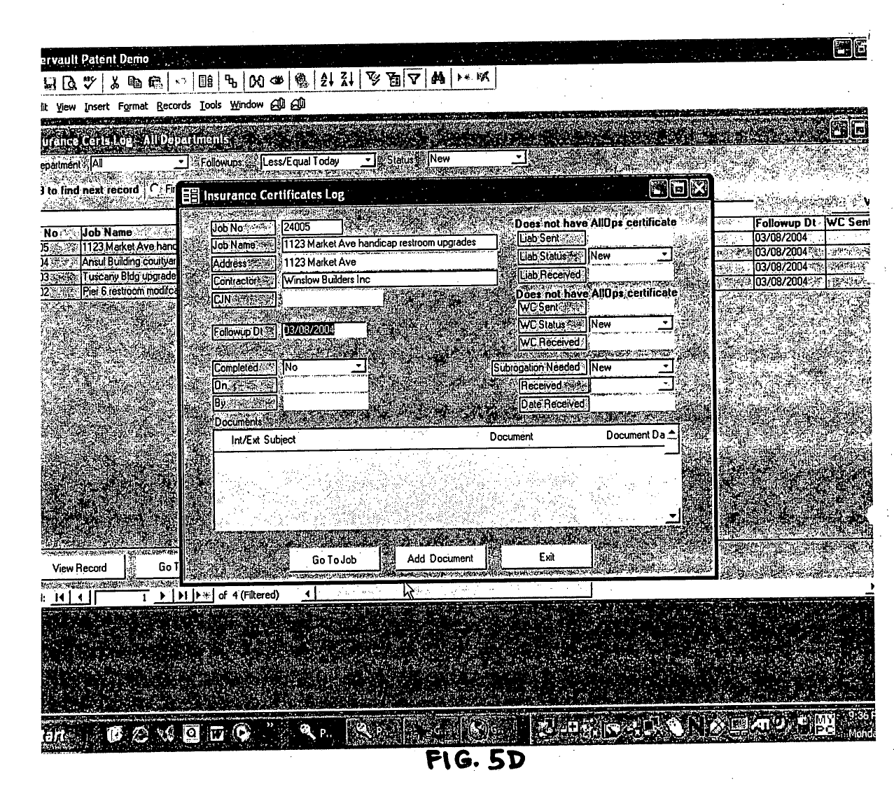

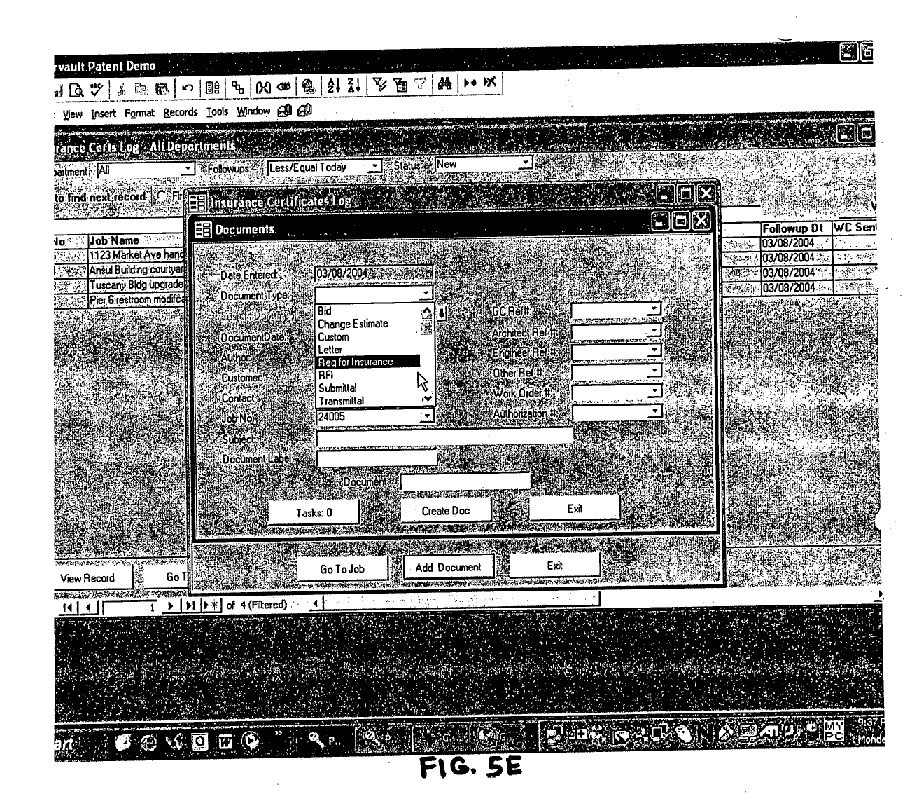

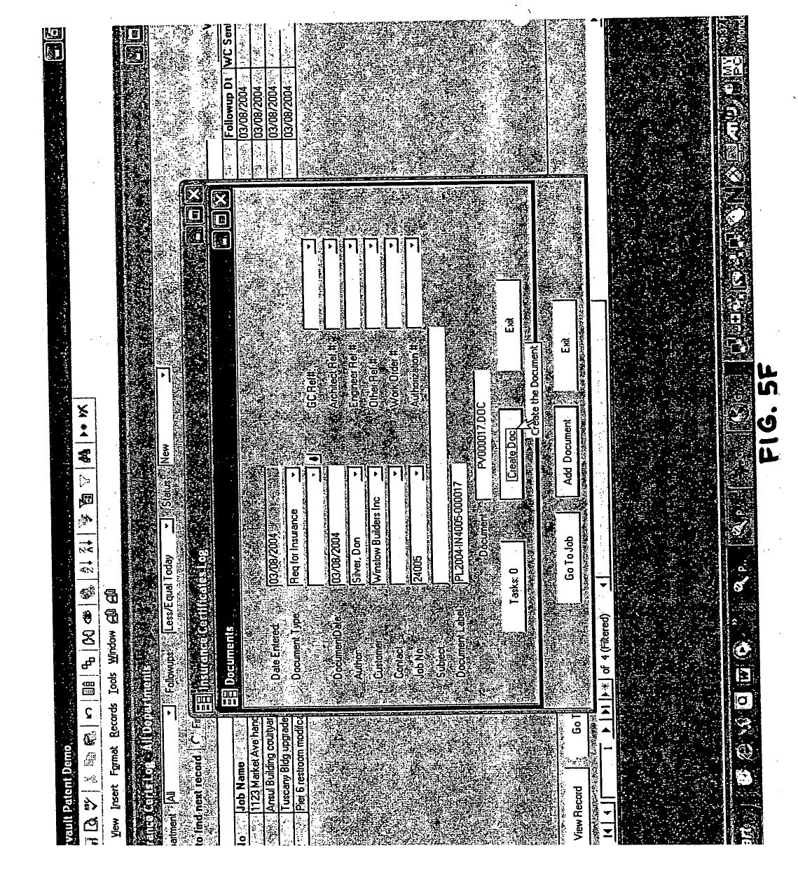

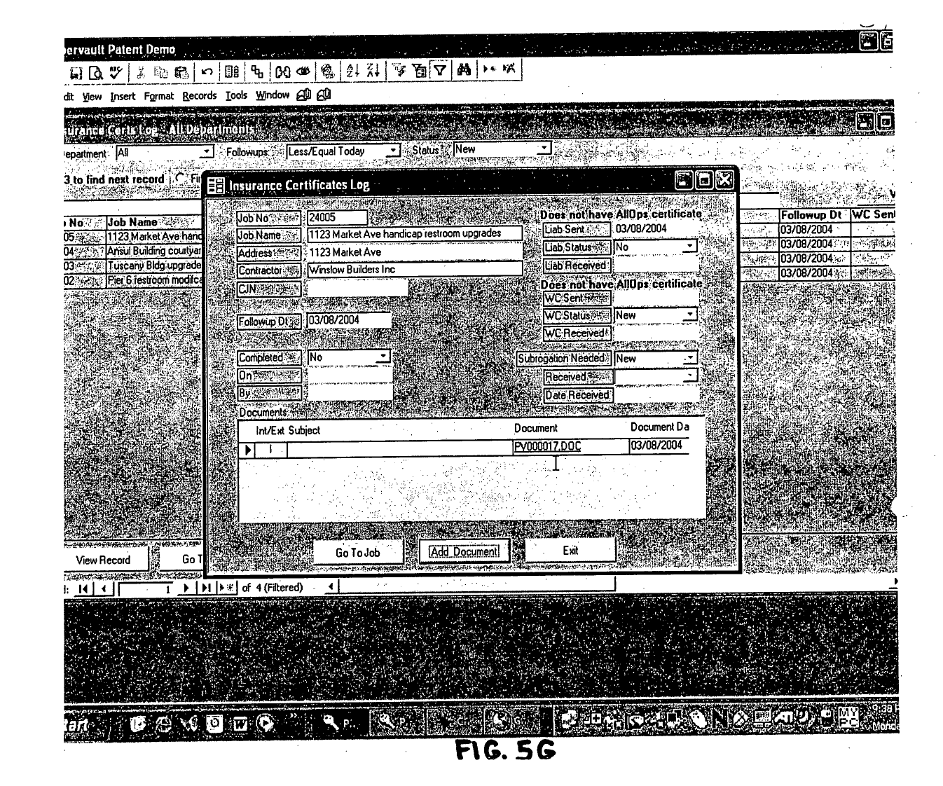

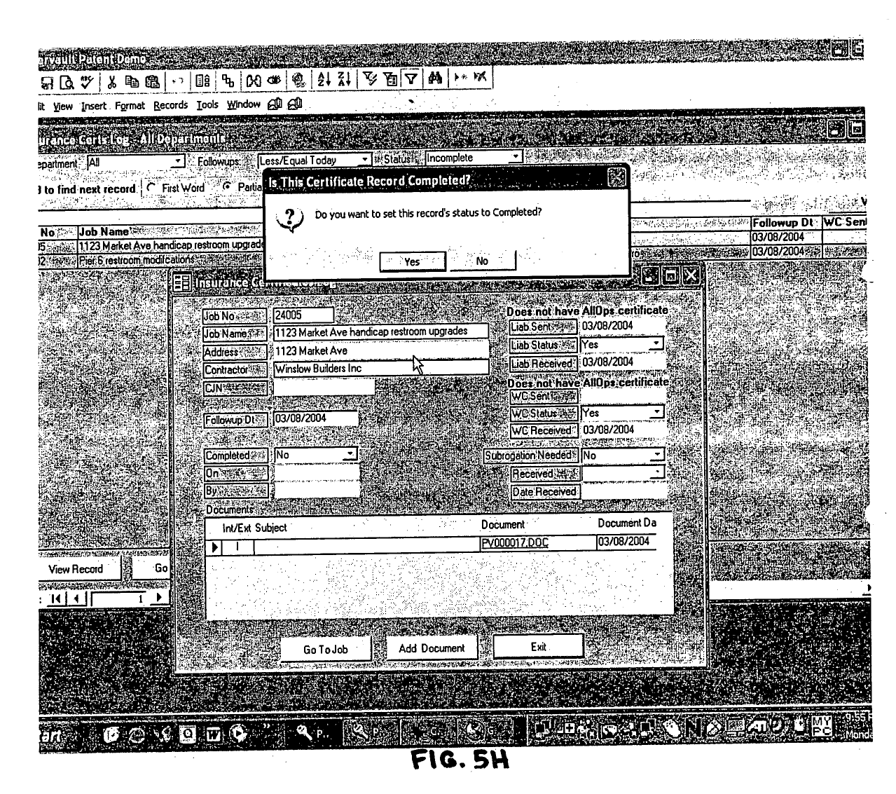

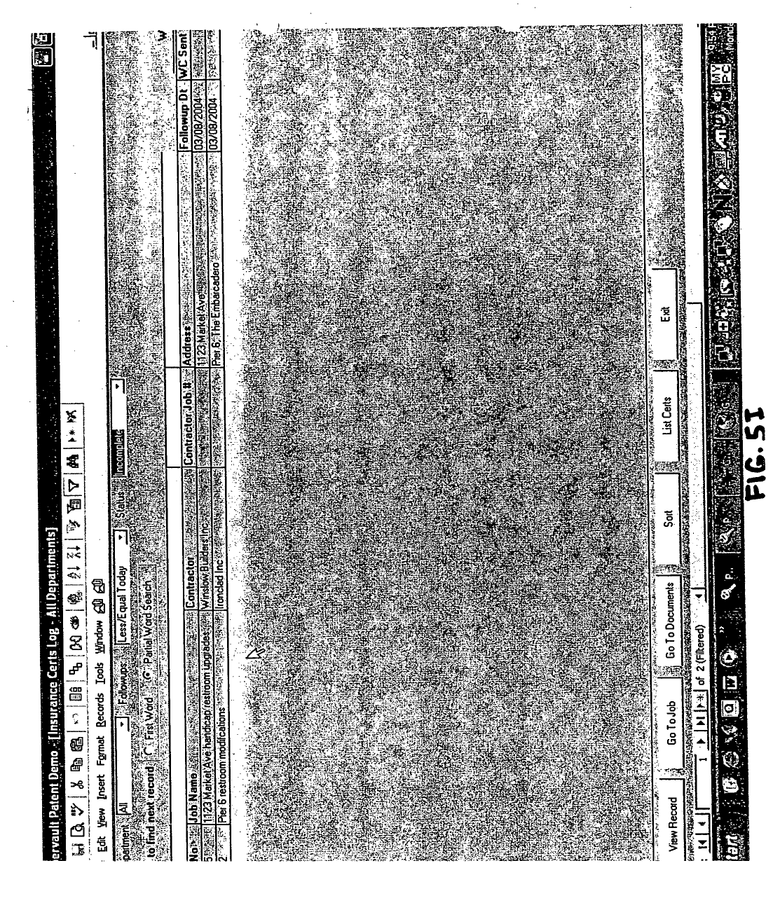

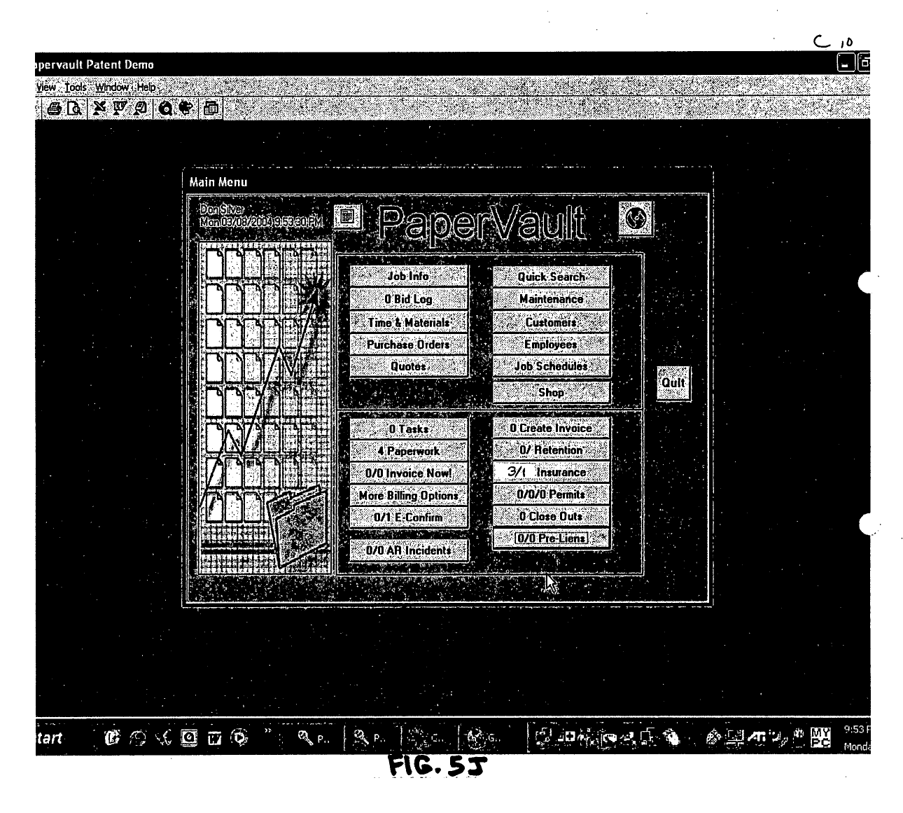

The program automatically creates a number of tasks for each new job. The screen images of FIG. 5 illustrate a process for the automatic creation of an insurance task.

FIG. 5A shows that an insurance task may be initiated from a Main Menu screen created at “exit” from the new job screen. The user observes from the counter 4/0 that there are four new jobs in need of insurance certificates, and no incomplete insurance certificates pending.

FIG. 5B shows that when the Insurance control is selected, a popup window is displayed with three options. Select the “Insurance Certs Log” control.

FIG. 5C shows the resulting screen, which displays the four jobs that are in need of insurance certificates.

FIG. 5D shows an Insurance Certificates Log screen that pops up upon the selection of any of the jobs, illustratively when the job “1123 Market Ave handicap restroom upgrades” is selected. The liability status field Liab Status, the workers compensation status field WC Status, and the waiver of subrogation field Subrogation Needed are set to “new” to indicate that these are new requirements for the person designated as responsible to order insurance certificates.

FIG. 5E is a popup Documents screen, which enables the selection of an insurance template for use in producing an insurance request letter for the carrier. The insurance request letter may contain specific information merged from the job record.

FIG. 5F shows other fields of the Documents screen that are completed, and selection of the Create Doc control for creating insurance request letter and sending it out.

FIG. 5G shows that after creation of the insurance request letter for the carrier, the liability status is set to NO to indicate that the insurance certificates have not yet been received. This action is reflected when the Main Menu screen is displayed, in that the right side value of the dual counter on the Insurance control is increased by one.

FIG. 5H shows that after the insurance certificates arrive, the liability status is set to Yes to indicate that the insurance certificates have been received. A pop up window prompts the user to accept the dialog box and set this job as complete with regards to the insurance certificates. If the user sets the record's status to Completed by selecting the Yes control and displays the Main Menu screen, the counter on the Main Menu screen will be decreased by one, i.e. will become 3/0.

FIG. 5I shows a report of Incomplete insurance certificates. The Insurance Certificate Log keeps track of complete, pending (i.e. incomplete) and new certificates, thereby enabling any desired report to the generated. The user may also bring up a job and see the certificates or view the request letters that were sent out.

FIG. 5J shows that when the user returns to the Main Menu, the right side of the counter shows three jobs in need of insurance certificates, and one job with an incomplete insurance certificate.

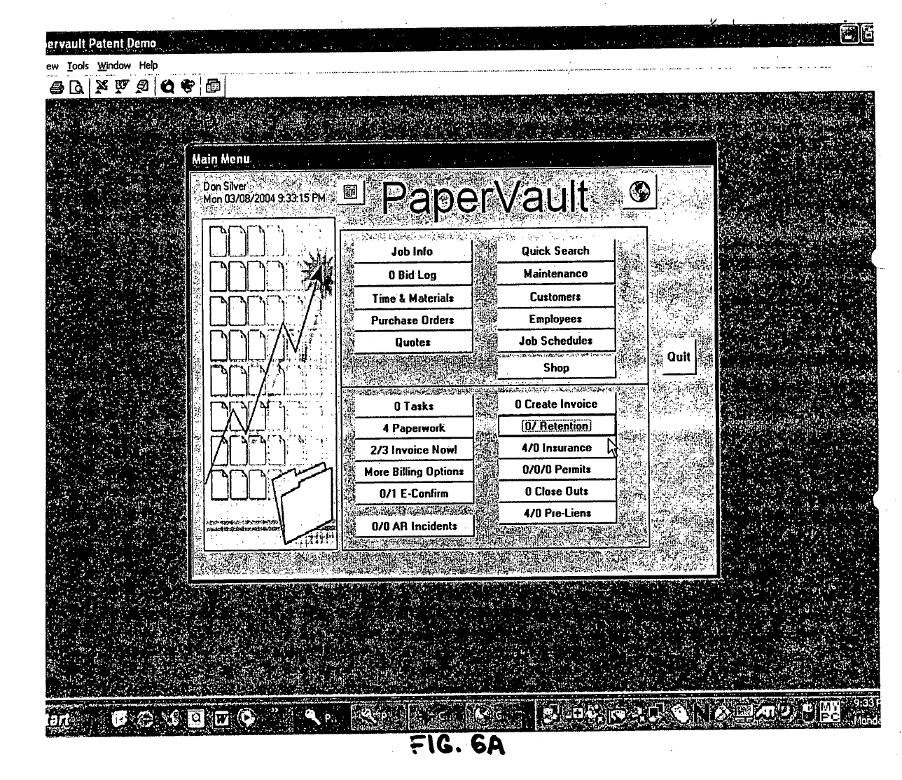

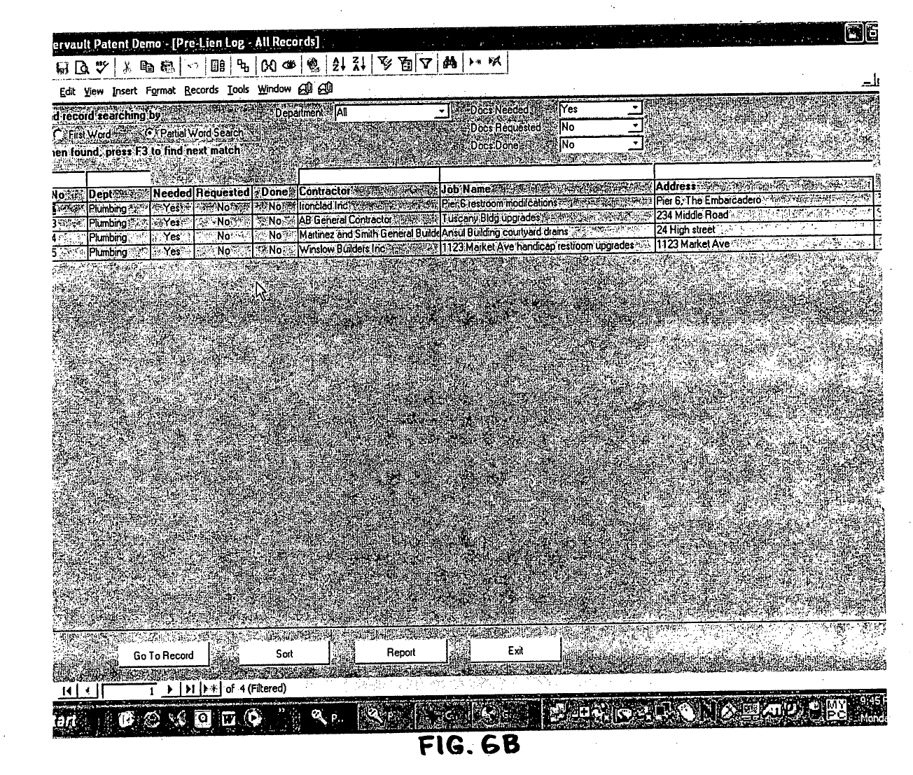

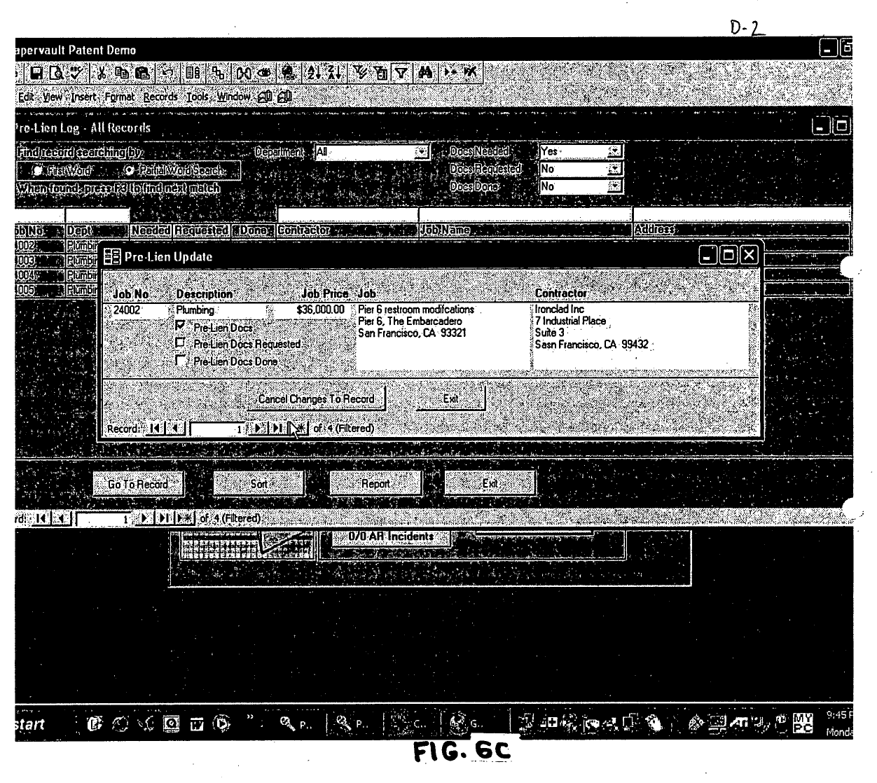

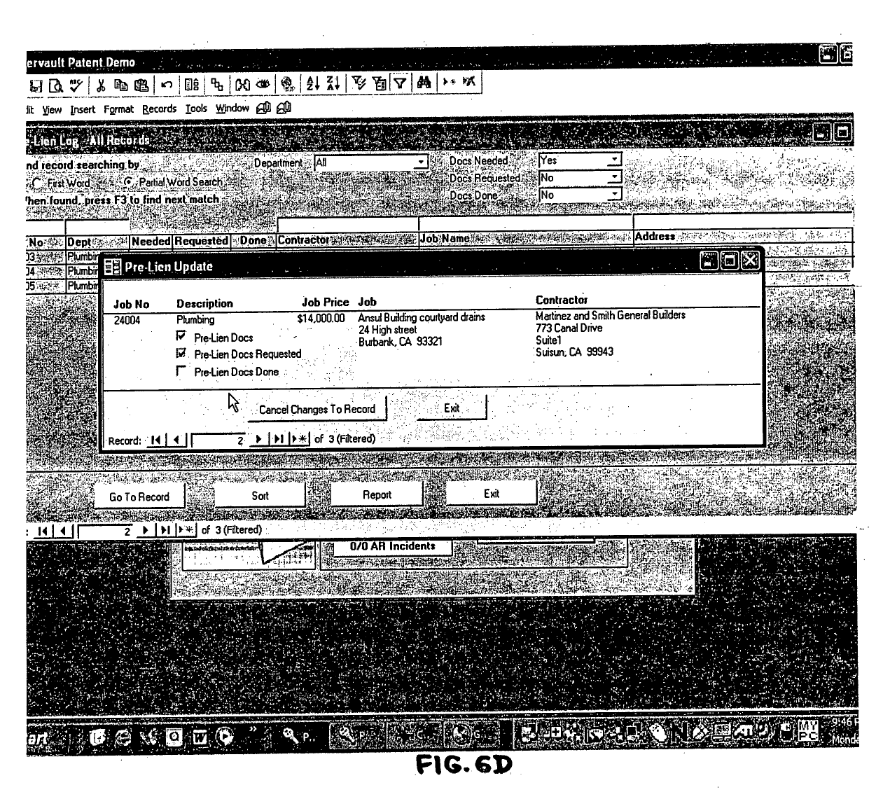

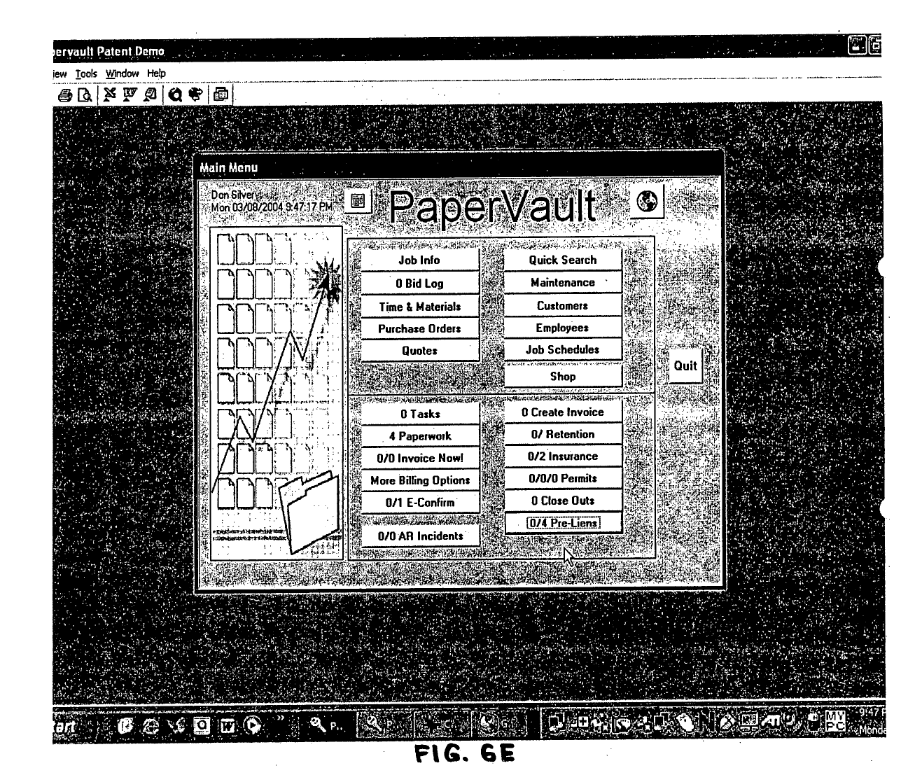

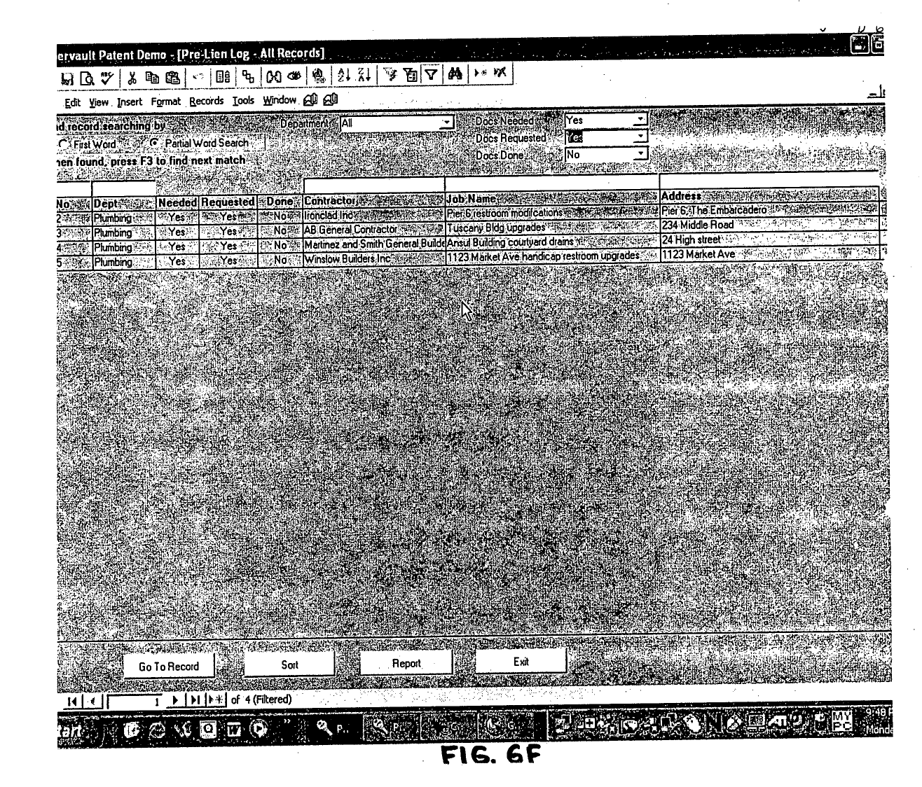

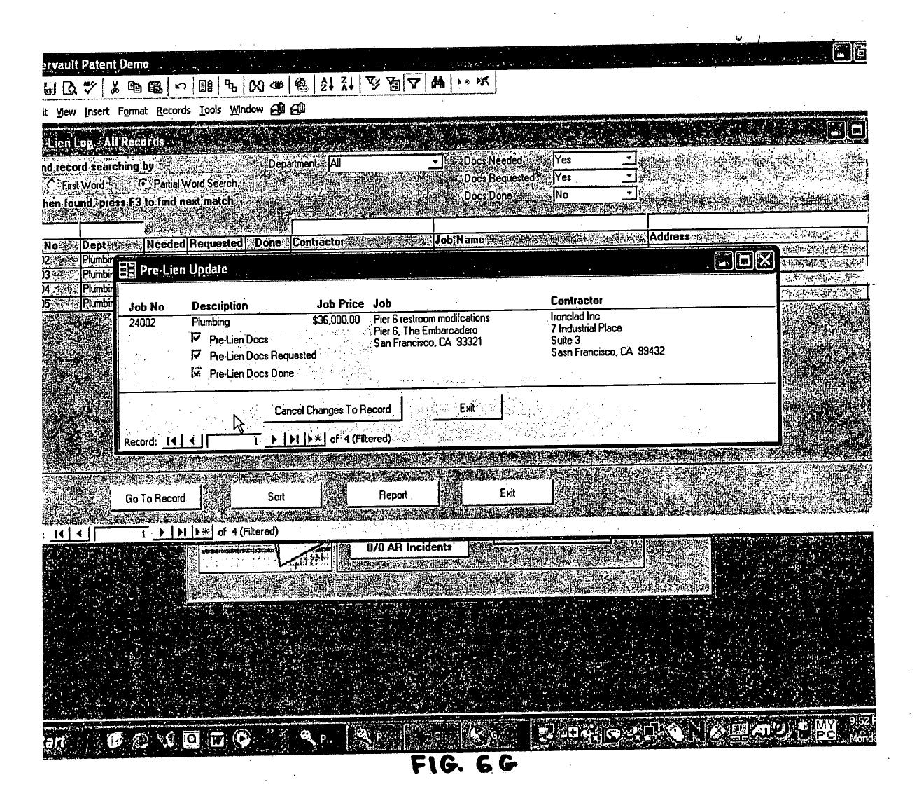

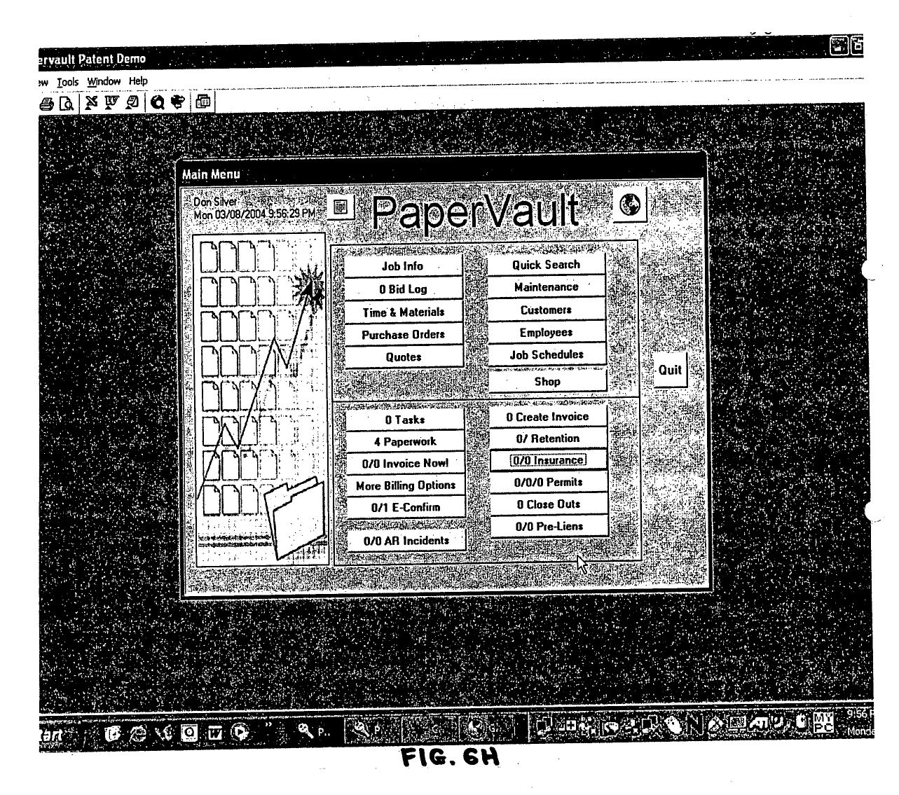

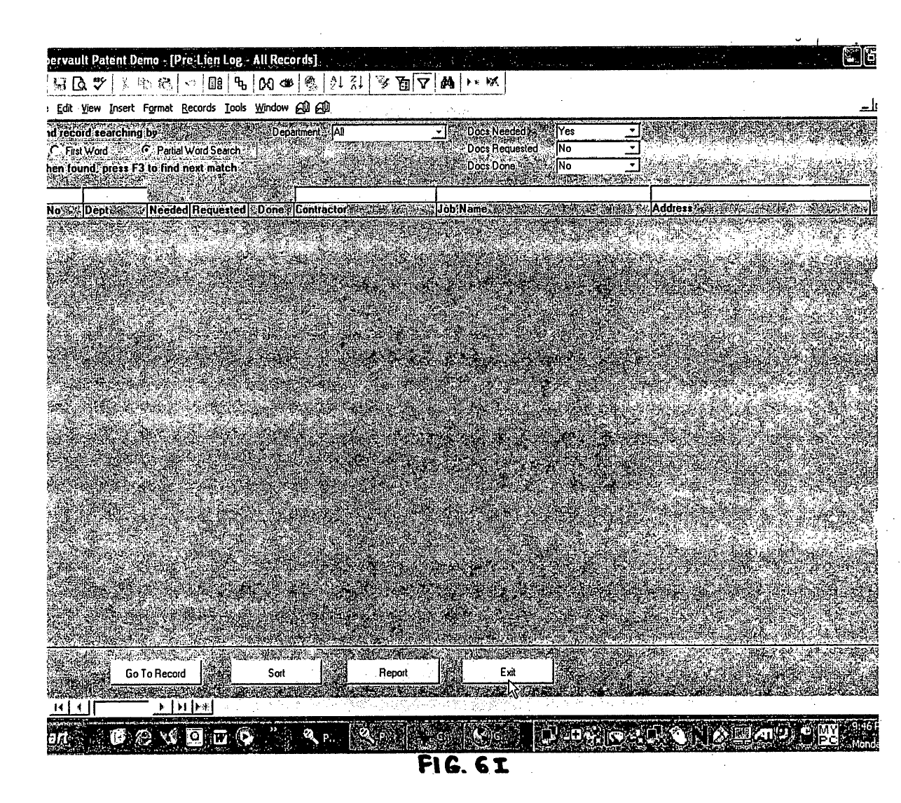

The screen images of FIG. 6 illustrate a process for the automatic creation of pre-lien tasks.

FIG. 6A shows a Main Menu screen that indicates with the counter 4/0 in the control Pre-Liens of the General Tasks area that four new jobs need to have pre-lien documents created, but that no pre-lien documents are incomplete.

FIG. 6B shows a screen that results from selecting the Pre-Lien control. A Pre-Lien Log window is displayed, showing the pre-lien documents that are needed but not yet ordered.

FIG. 6C shows that upon selection of any record in the Pre-Lien Log, a Pre-Lien Update popup window is displayed showing new pre-lien requirements to work on. The user observes that pre-lien documents have not been ordered for Job No. 24002. The required pre-lien documents may be ordered from a third party, or may be created by the program if desired.

FIG. 6D shows that when pre-lien documents are ordered, a corresponding box in the Pre-Lien Update popup window is checked to show this. When the user exists from the popup window, the record falls off of the Pre-Lien Log because it no longer matches the filter criteria. The counters keep track.

FIG. 6E shows that after the pre-lien documents are ordered for all four of the jobs, the counter shown on the Main Menu is 0/4, which indicates by the left side zero that no new jobs need to have pre-lien documents created, and further indicates that four jobs now have incomplete pre-lien documents because they have been ordered but not yet received.

FIG. 6F shows a screen that results when the Pre-Liens control is selected. The screen shows that pre-lien documents have been requested but not received yet, as represented by the digit “4” on the right side of the counter in the Main Menu screen of FIG. 6E.

FIG. 6G shows completion of the Pre-Lien Update popup window when the pre-liens are received and logged in.

FIG. 6H shows a Main Menu screen after the pre-liens are received and logged in. The counter on the Pre-Lien control is 0/0, which indicates that the pre-lien documents are complete.

FIG. 6I shows that Pre-Lien Log offers a variety of searching criteria.

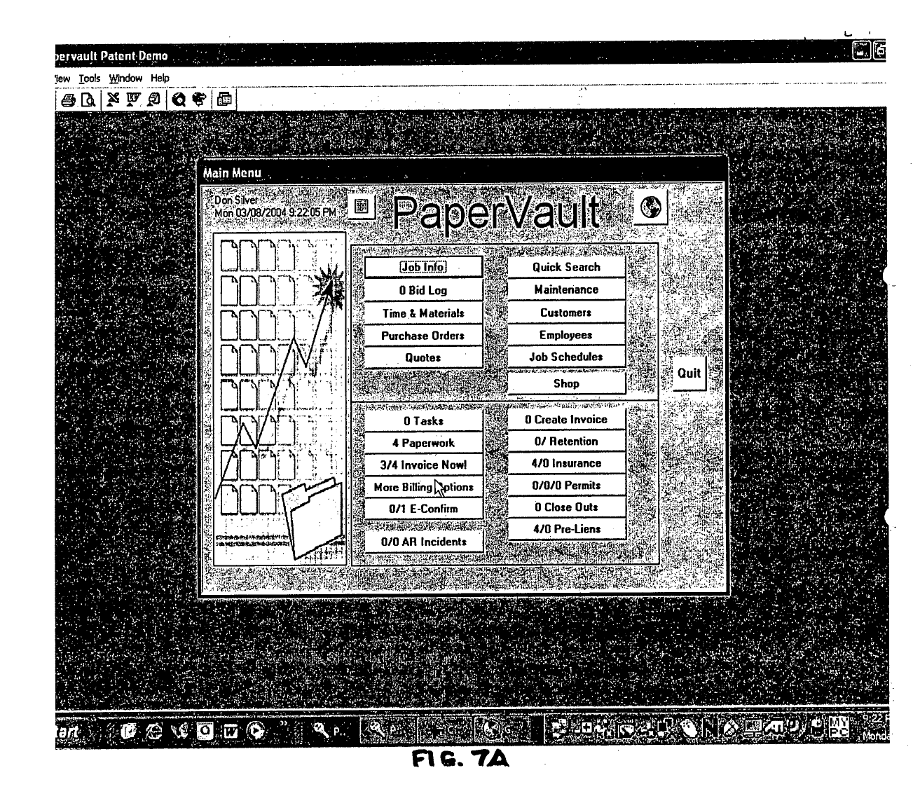

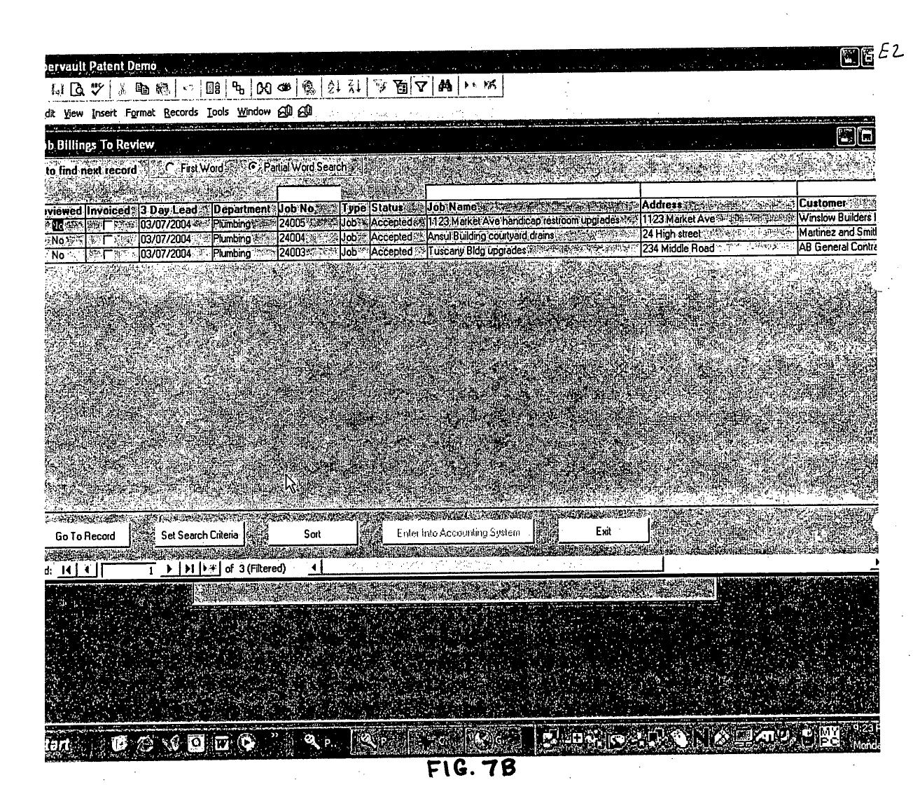

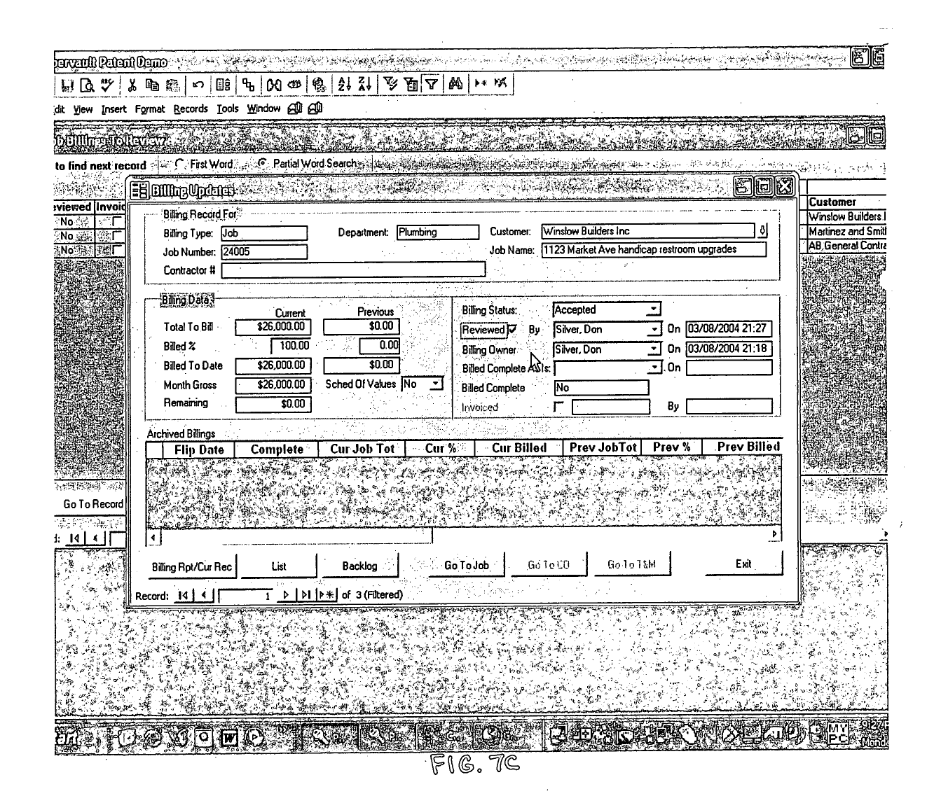

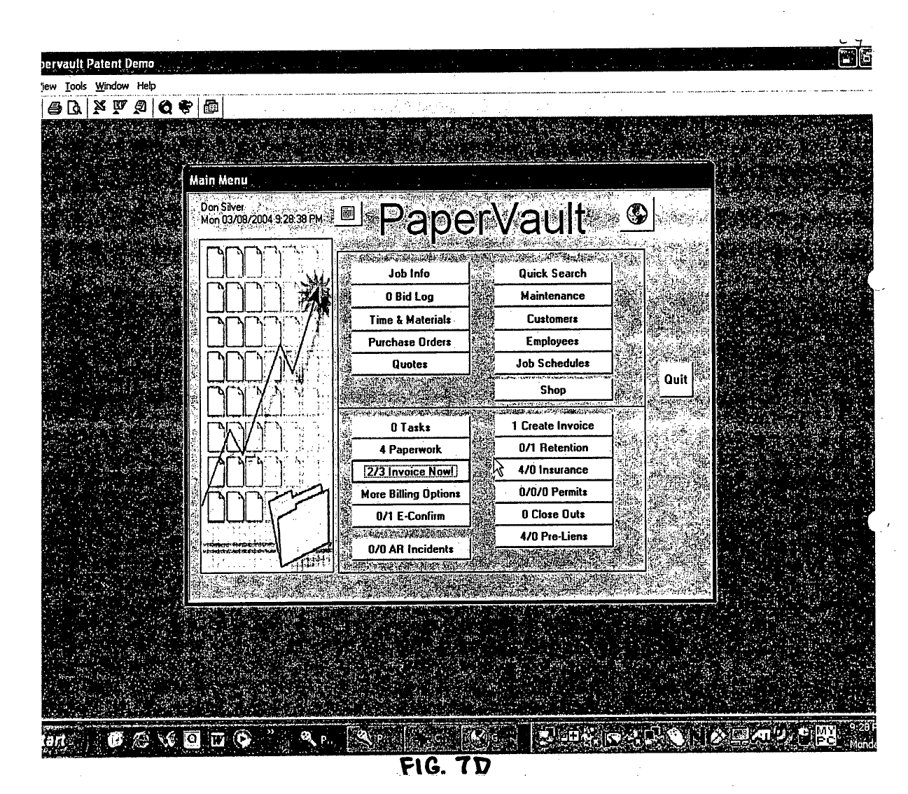

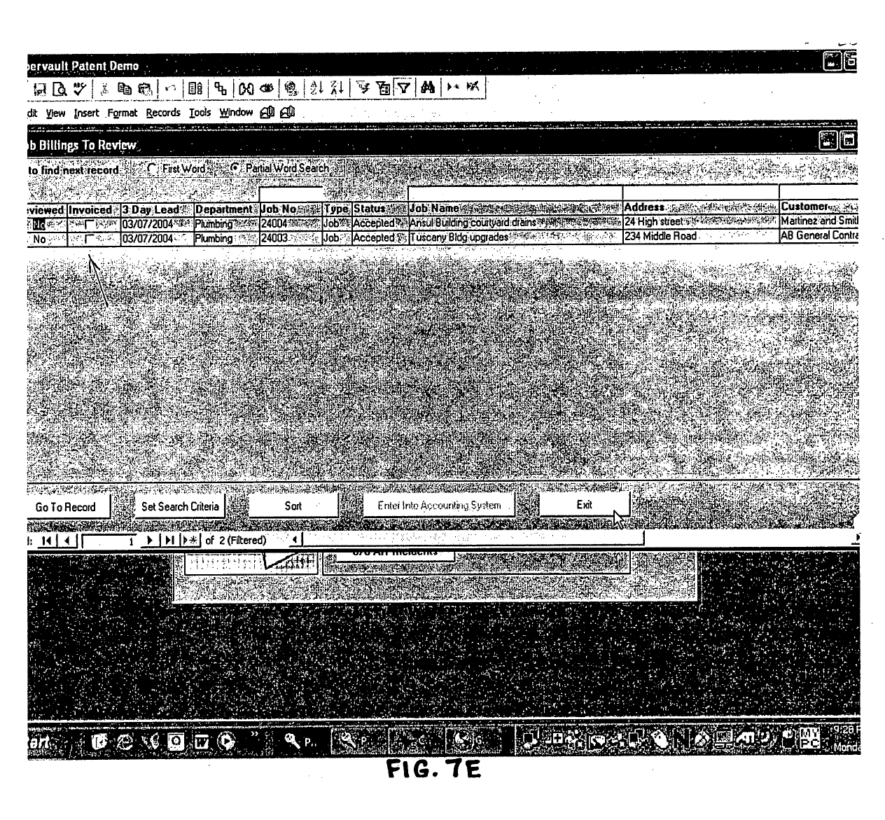

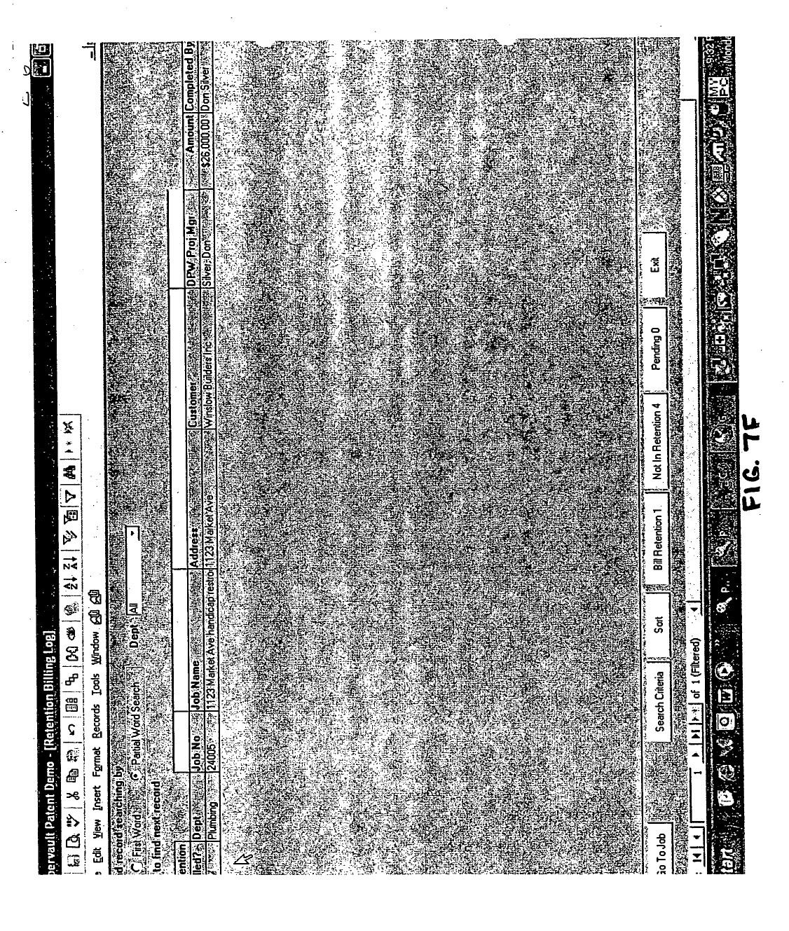

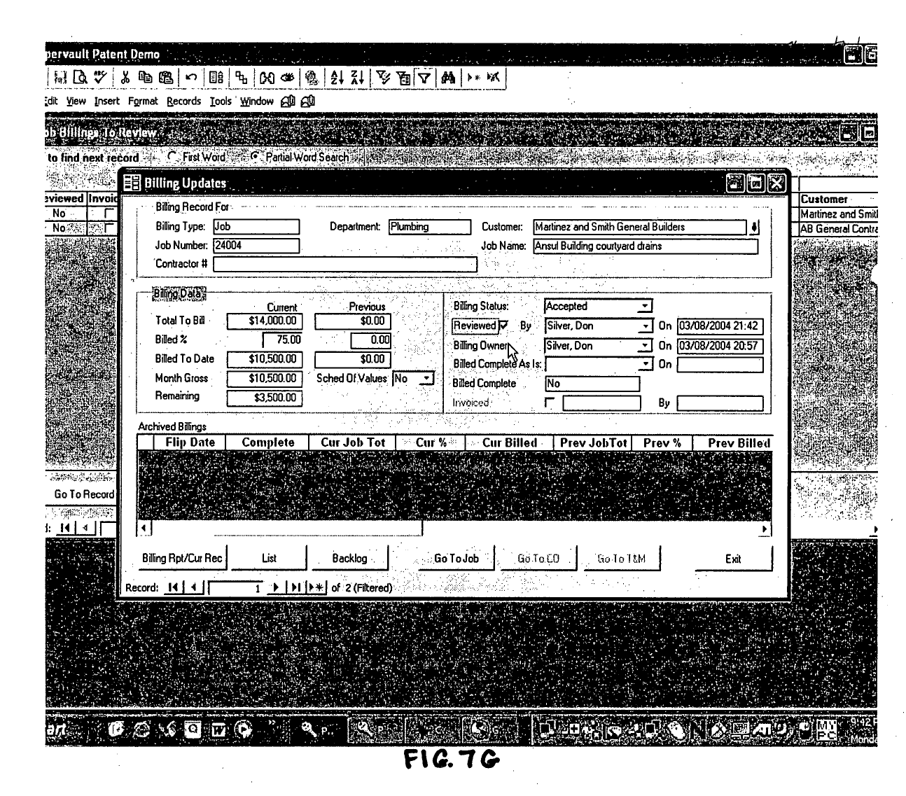

The program also permits billing personnel to quickly, easily and intuitively bill each job, as shown by the illustrative screen images of FIG. 7.

FIG. 7A shows a Main Menu screen having a counter 3/4 in the Invoice Now! control, which indicates that the logon user has 3 jobs of the 4 total number of jobs presently in need of billing within the next three days. The number 3 on the left is a logon user specific count, while the number 4 on the right is for the entire accounting department.

FIG. 7B shows a screen Job Billings to Review that results from selection of the Invoice Now! control. The screen is a list of the three items in need of billing by this logon user, who is the responsible billing person.

FIG. 7C shows a popup window Billing Updates that results from selection of job 24005 from the Job Billings to Review screen of FIG. 7B. The user requests that a bill be generated by entering the percentage to be billed and clicking on the reviewed checkbox. The logon user's counter is decreased by one to indicate that the billing has been reviewed and a requested initiated, while the accounting department counter is increased by one to indicate that an additional bill must be generated.

FIG. 7D shows a Main Menu screen after the billing update. The numbers on the Invoice Now! control is are 2/3, reflecting the decrease in the logon user's counter and the increase in the accounting department counter. In the Office Administration Area, the numbers on the Retention control now are 0/1, wherein the left number of zero indicates that the logon user, here a project manager, has no pending change orders that would prevent retention from being billed, and that the company has a retention invoice to bill because the job meets the requirement to bill retention (billed 100%, all issued change orders billed 100% and no pending change orders exist). If there had been pending change orders relating to the project manager's jobs, the counter on the left would contain a number corresponding to the number of those pending change orders. The pending change orders are retired by changing their status from pending to rejected or verbal, which causes the left number to decrease and the right number to increase, and allows the process to continue.

FIG. 7E is a Jobs Billing to Review screen that is displayed when the logon user has entered the percentage to be billed and has clicked on the reviewed checkbox, and shows the two jobs remaining in need of invoicing by the accounting department.

FIG. 7F is a Retention Billing Log screen that results when the accounting department personnel checks off the job as having been entered into the accounting program.

FIG. 7G shows a popup window Billing Updates that results from selection of job 24004 from the Job Billings to Review screen of FIG. 7E. As for the Billings Update screen of FIG. 7C, the user requests that a bill be generated by entering the percentage to be billed and clicking on the reviewed checkbox. The logon user's counter is decreased by one to indicate that the billing has been reviewed and a requested initiated, while the accounting department counter is increased by one to indicate that an additional bill must be generated.

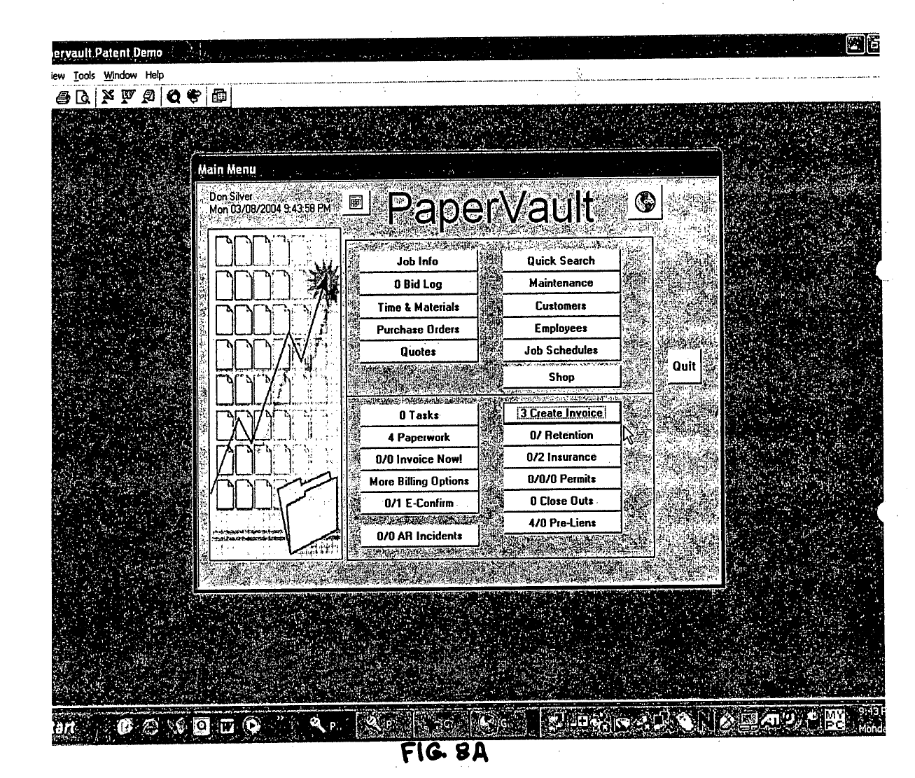

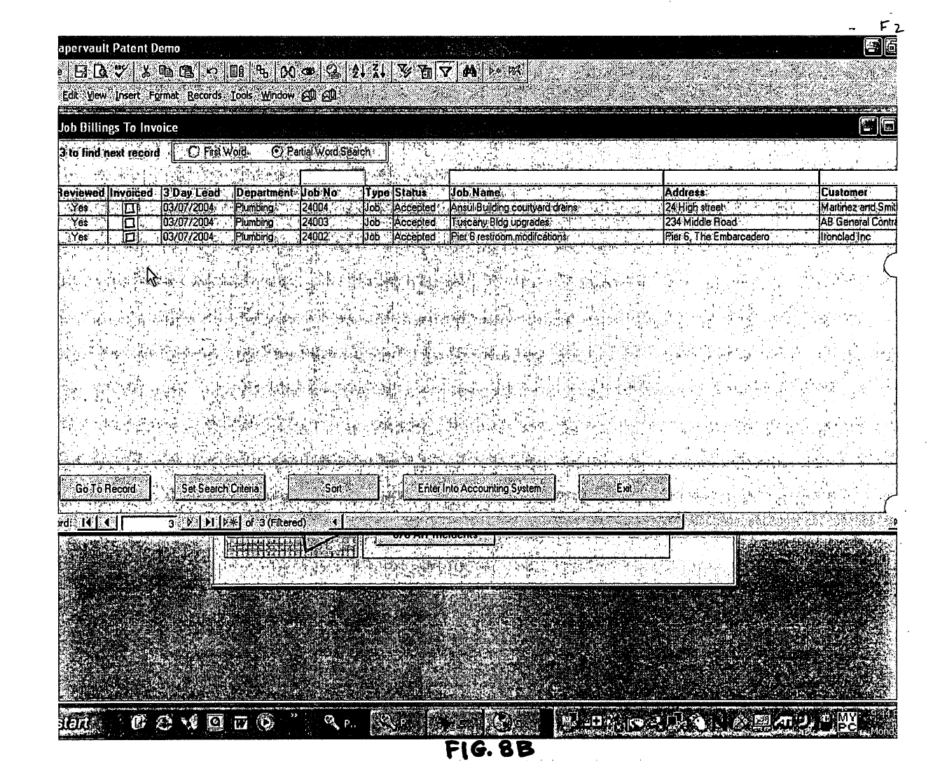

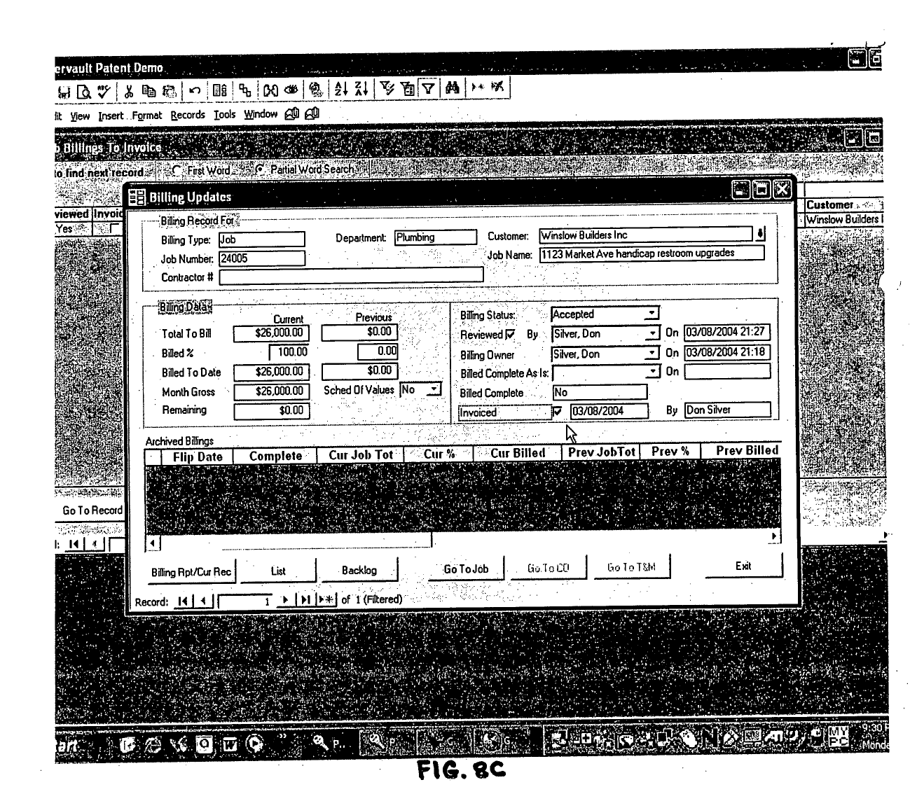

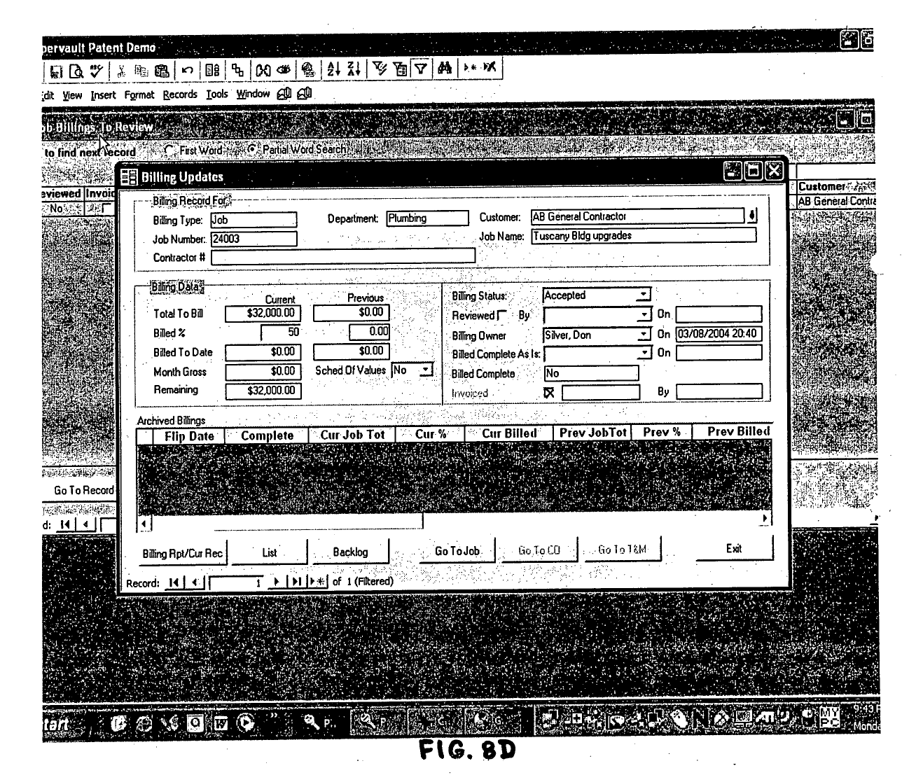

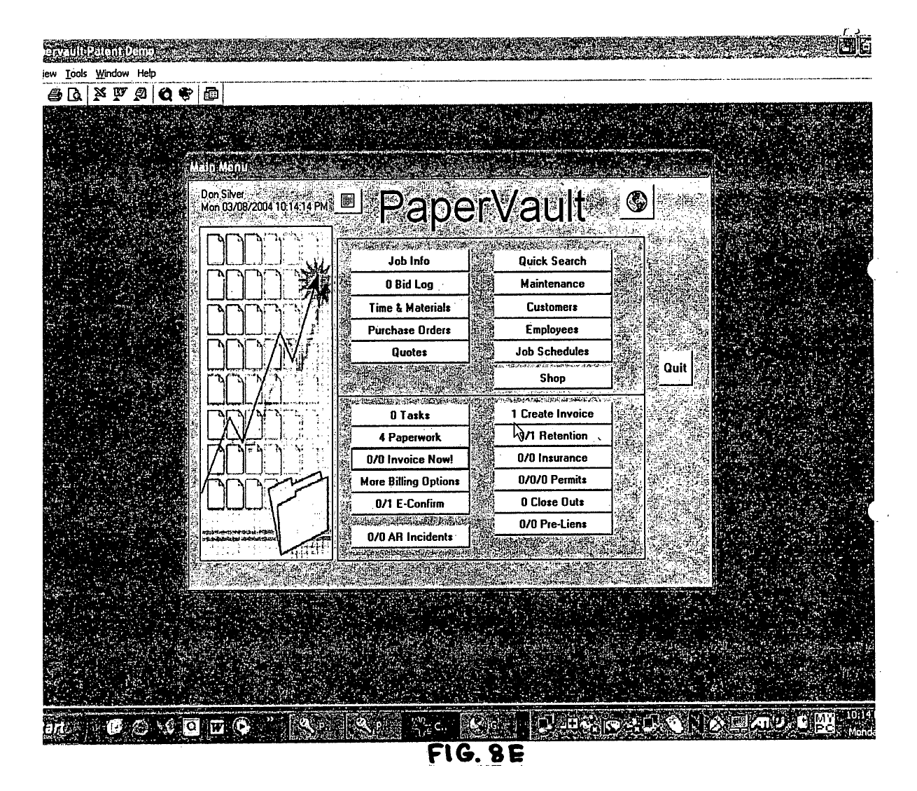

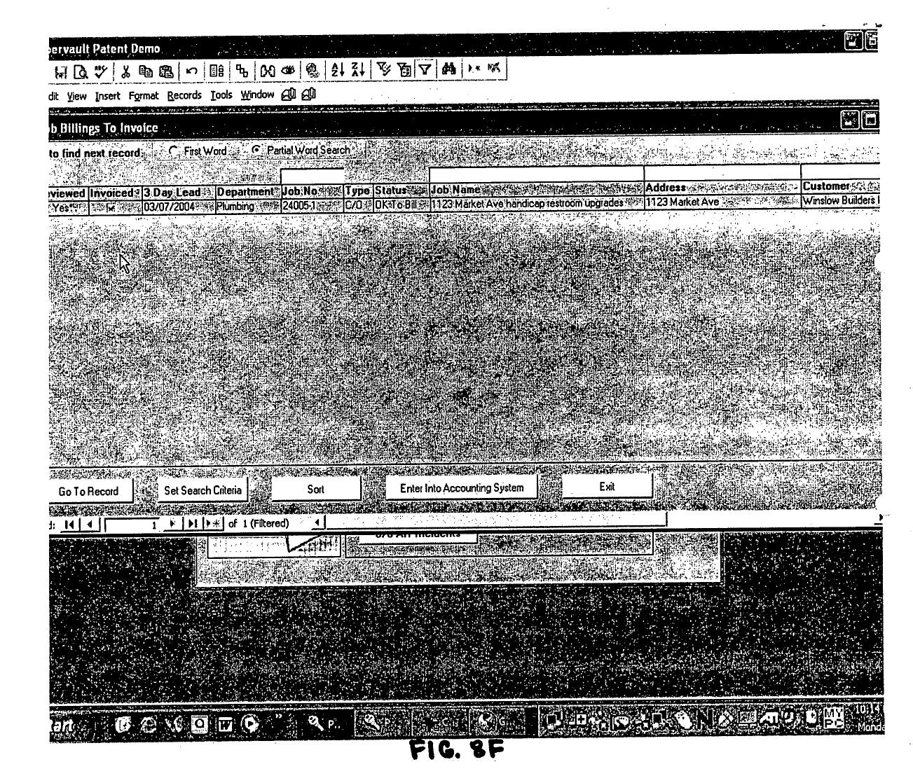

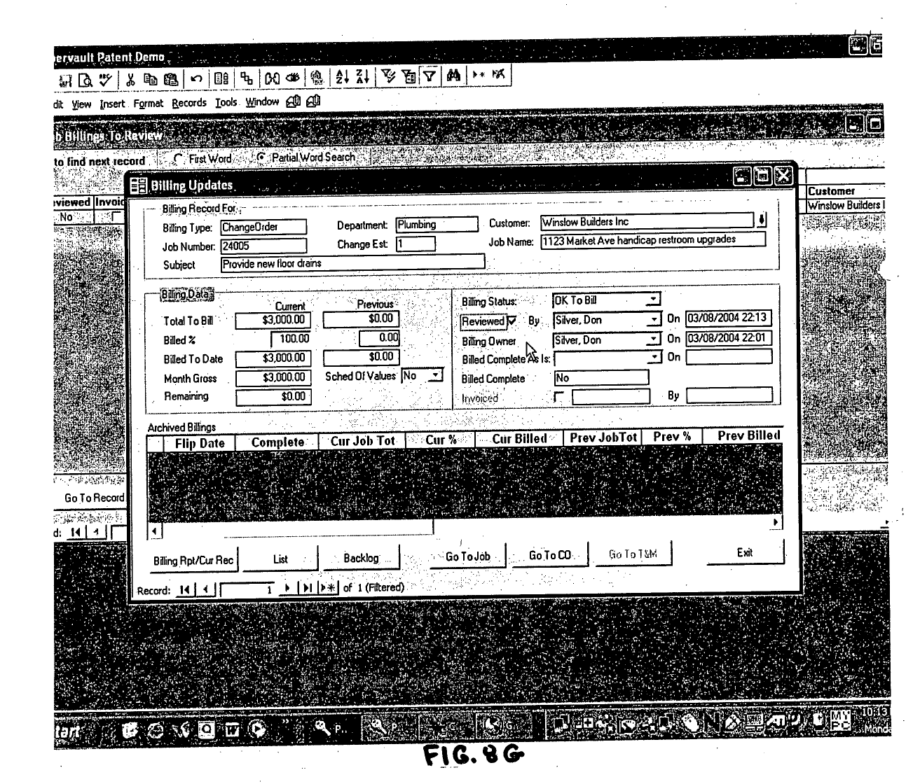

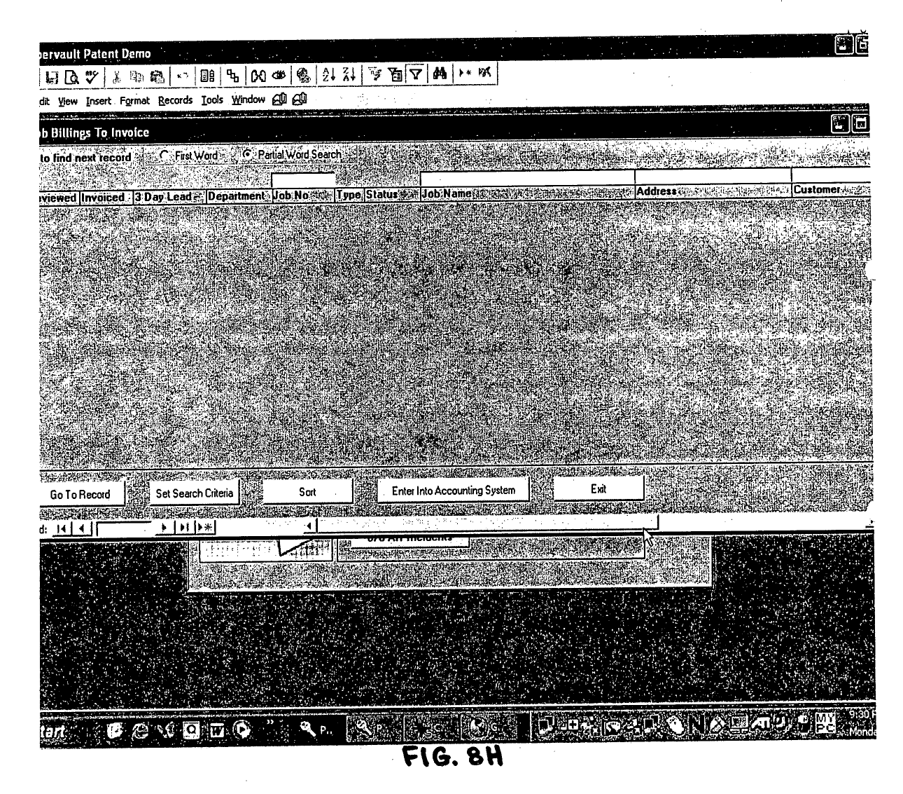

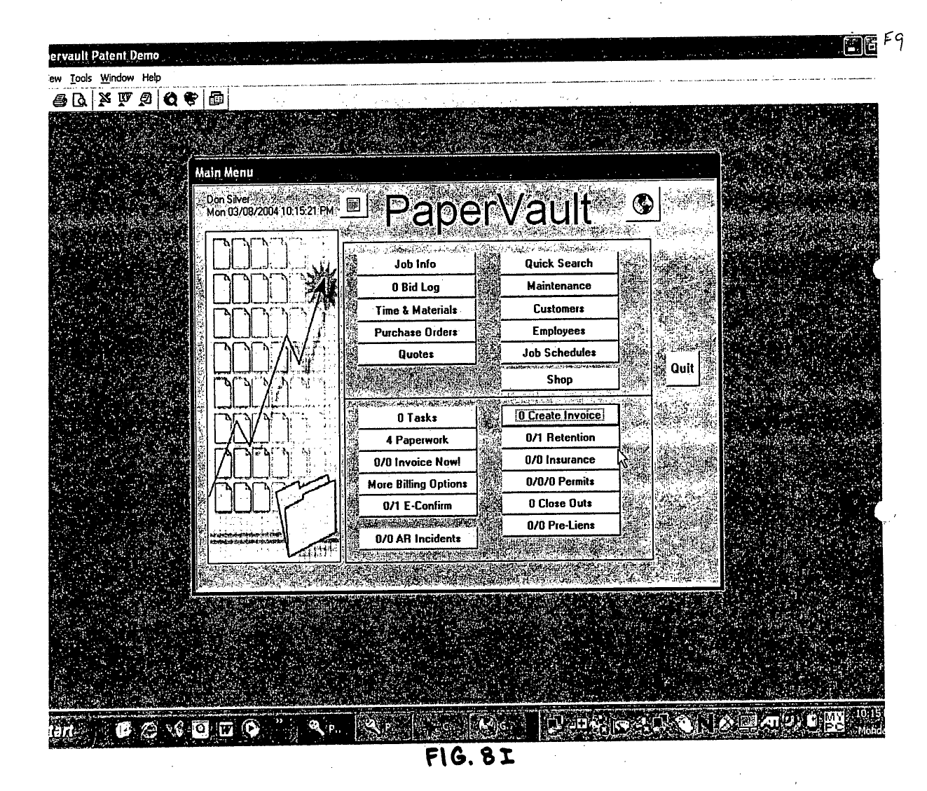

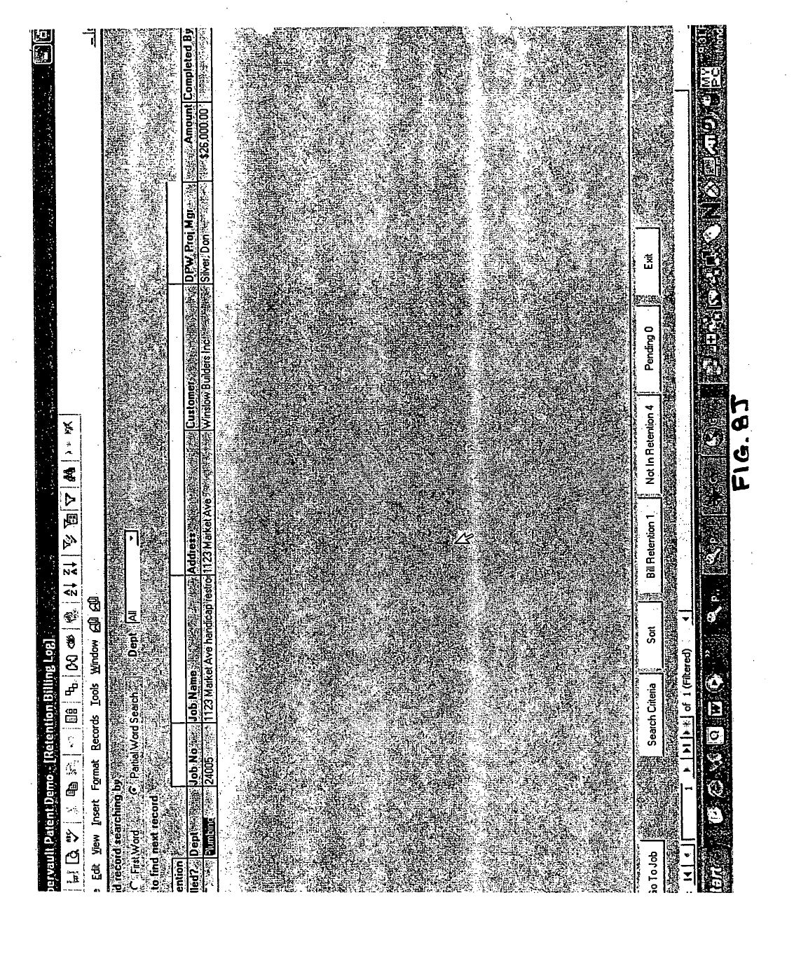

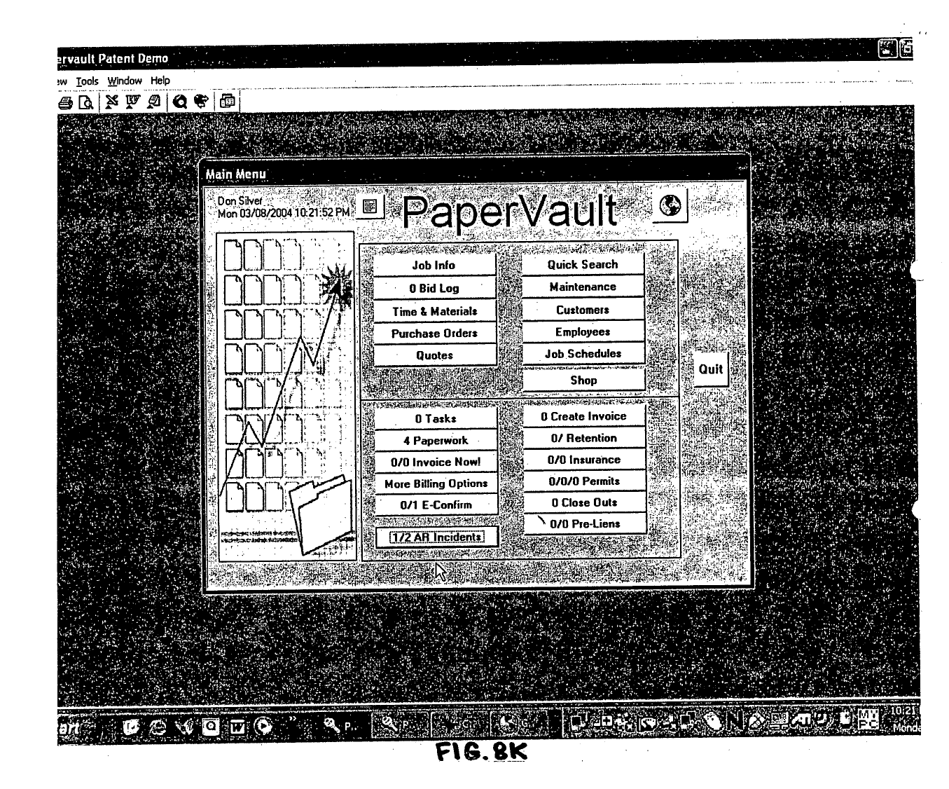

The program also permits accounting department personnel to quickly, easily and intuitively invoice jobs, as shown by the illustrative screen images of FIG. 8.

FIG. 8A is a Main Menu screen showing that three jobs need to be invoiced by accounting, as indicated by the counter “3” on the Create Invoice control.

FIG. 8B shows a screen that results when the Create Invoice control is selected by the user. The screen is a Jobs Billings to Invoice log showing three jobs to invoice.

FIG. 8C shows a Billings Update popup window that results when a job is selected from the Jobs Billing to Invoice screen, illustratively the job 24005. The user checks the box to confirm that this item has been invoice in the accounting program, which illustratively is a separate program.

FIG. 8D shows that job 24003 may be invoiced in the same manner.

FIG. 8E is a Main Menu screen that shows the state of the counter associated with the Create Invoice control. The counter drops from three to one, showing that only one job remains in need of entering into the accounting program.

FIG. 8F shows a screen that now results when the Create Invoice control is selected by the user. The screen is a Jobs Billings to Invoice log showing only one more job to invoice. Note that a new change order has been billed by the responsible billing person on a previously billed as “complete” job. It triggers a progress invoice and a retention invoice since it meets the requirements.

FIG. 8G is a popup window that results when the job 24005-1 is selected. The user bills the change order percentage.

FIG. 8H shows a Billings to Invoice screen that results after the last bill is invoiced. The log shows no items to bill.

FIG. 8I is a Main Menu screen that shows the state of the counter associated with the Create Invoice control and the Retention control. The counter on the Create Invoice control drops from one to zero, showing that no more jobs remain in need of entering into the accounting program. The retention shows one item to create.

FIG. 8J shows a Retention Billing Log screen that results when the logon user selects the Retention control. The log shows one item to be billed for retention.

FIG. 8K is a Main Menu screen that shows the state of the counter associated with the Retention control after retention is billed. The counter associated with the Retention control drops from one to zero, showing that no more items remain in need of retention billing.

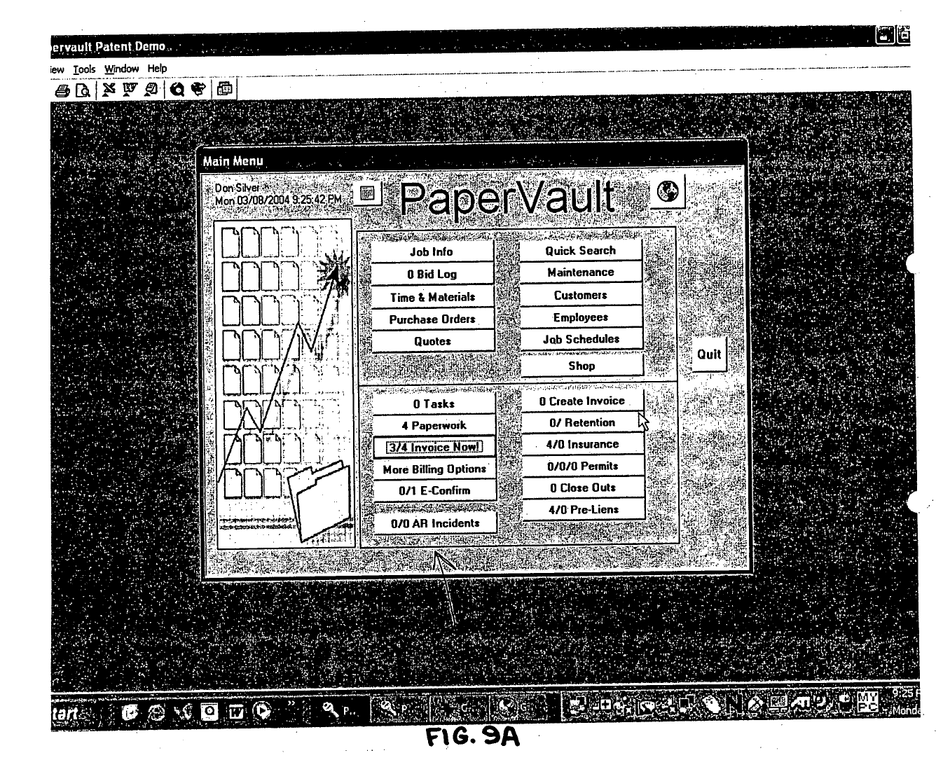

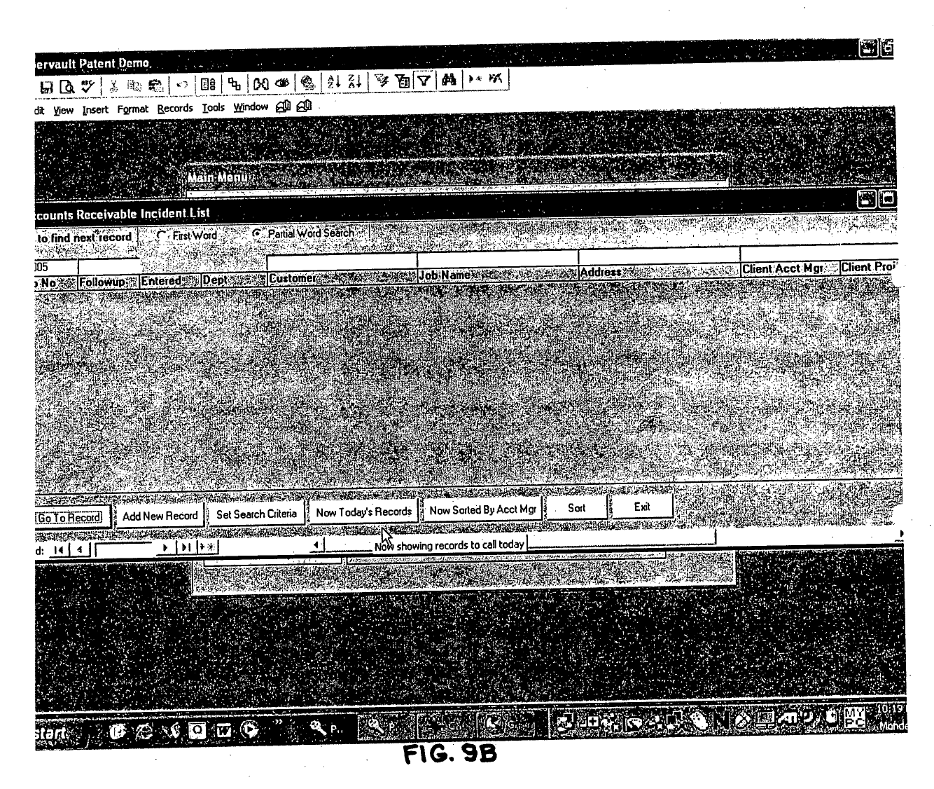

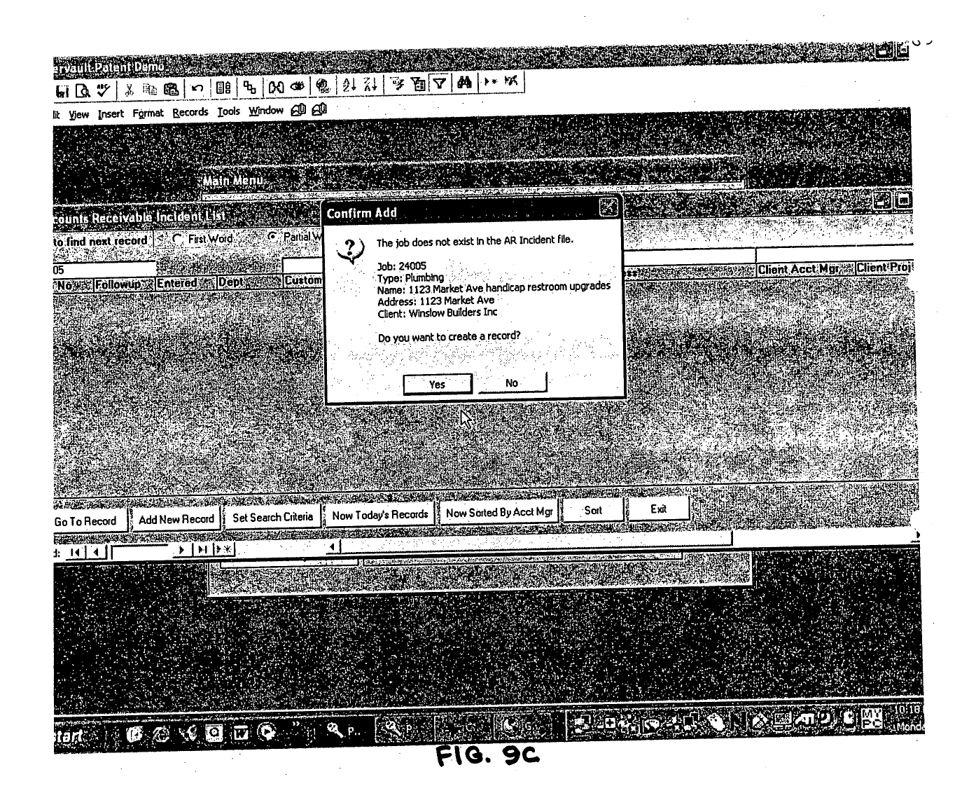

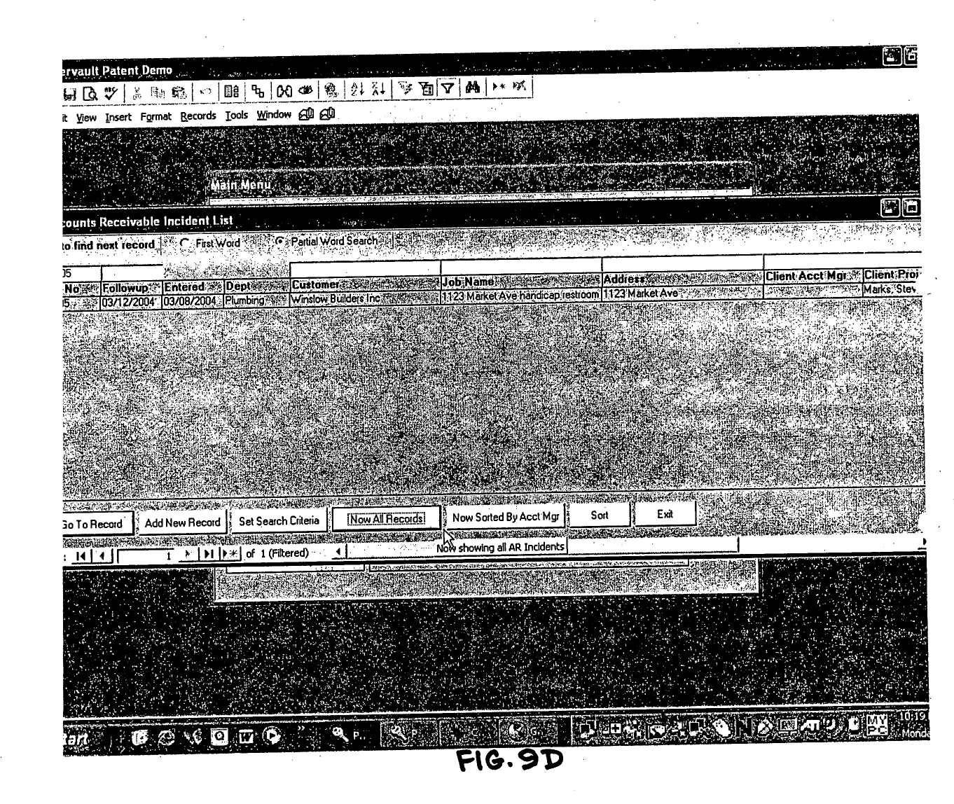

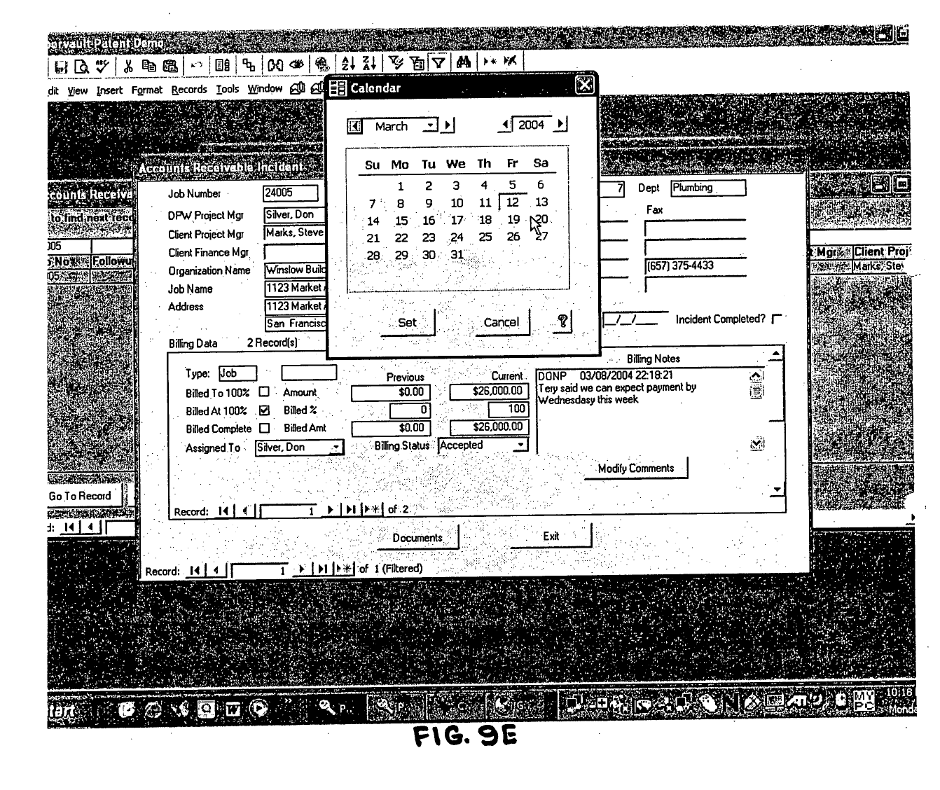

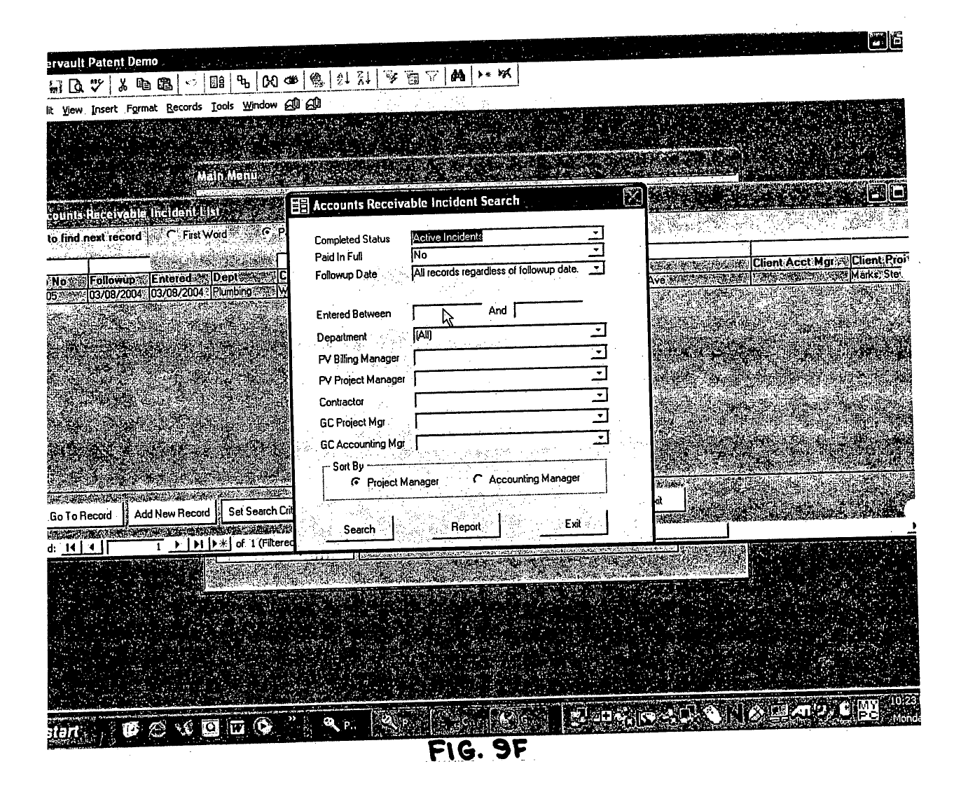

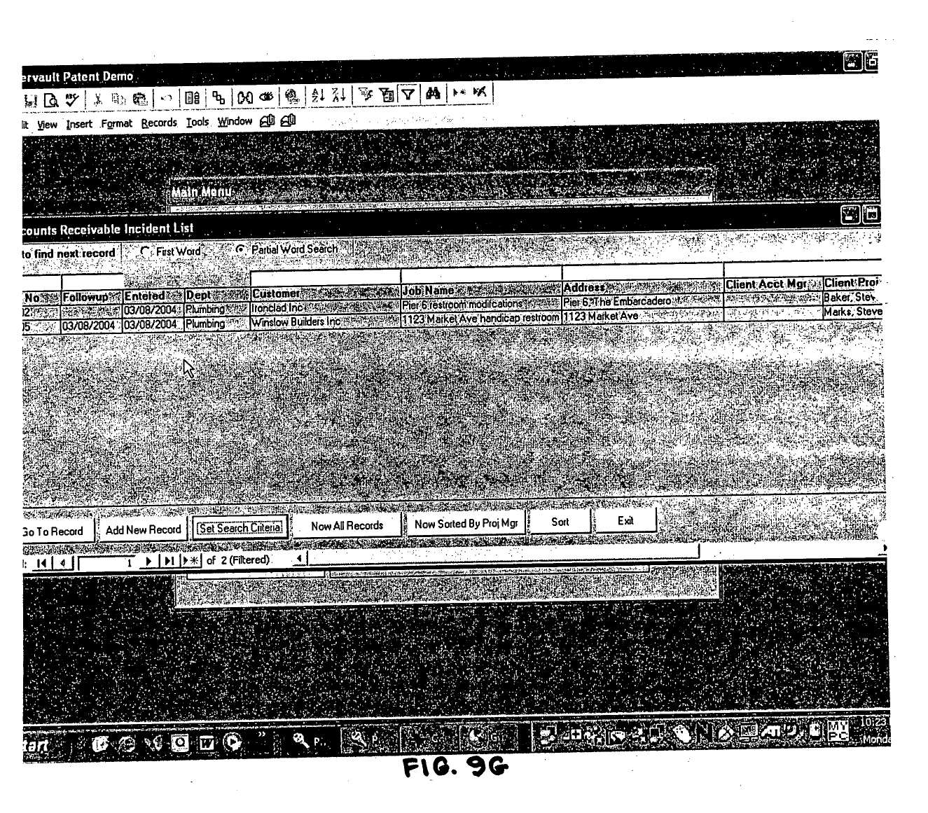

The program also permits collections personnel to quickly, easily and intuitively manage collection of payments due, as shown by the illustrative screen images of FIG. 9.

FIG. 9A is a Main Menu screen that shows a counter 0/0 associated with an AR Incidents control, which provides user access to an Accounts Receivable Log. While not exactly a project administration function, the AR Incidents control is placed near the Project Administration area for convenience, but slightly spaced apart. The Accounts Receivable Log is tied closely to the job and billing screens, and allows the user to log all conversations, access documents, set follow-up phone call dates, and generally facilitates other actives involved in managing the task of collecting money. All call notes are visible at the job screen.

The counter associated with the Main Menu screen is a double counter. The left side of the counter is logon user specific (where the logon user is a project manager) and shows those calls scheduled for today that relate to the logon user's jobs. The right side are all account receivable calls scheduled for phone calls today, including the logon user's calls. None are scheduled for today as shown by the counter.

FIG. 9B shows an Accounts Receivable Incident List that results from selection of the AR Incidents control. It shows that no calls are scheduled today.

FIG. 9C shows a screen that is helpful in adding a new AR incident. If the AR incident does not exist on the list, it is added. It displays with it all previous notes for collection attempts for this job.

FIG. 9D shows the Accounts Receivable Incident List after the job has been added.

FIG. 9E shows two popup windows. A first popup window, an Accounts Receivable Incident window, which is obtained by selecting one of the items from the Accounts Receivable Incident List of FIG. 9D. A second popup window results from selecting a date control in the first popup window and allows the user to set a follow-up date for when the user wishes to call back. The user documents the call in the notes field.

FIG. 9F shows an Accounts Receivable Incident Search that is displayed by selecting the Set Search Criteria control on the Accounts Receivable Incidents List of FIG. 9D. The user may do specific searches for AR incidents based on various criteria.

FIG. 9G shows the results of the Accounts Receivable Incident Search of FIG. 9F. Another accounts receivable incident has been found. It will be appreciated that the Accounts Receivable Incidents list is useful not only to collection personnel, but also to accounting person and project management personnel.

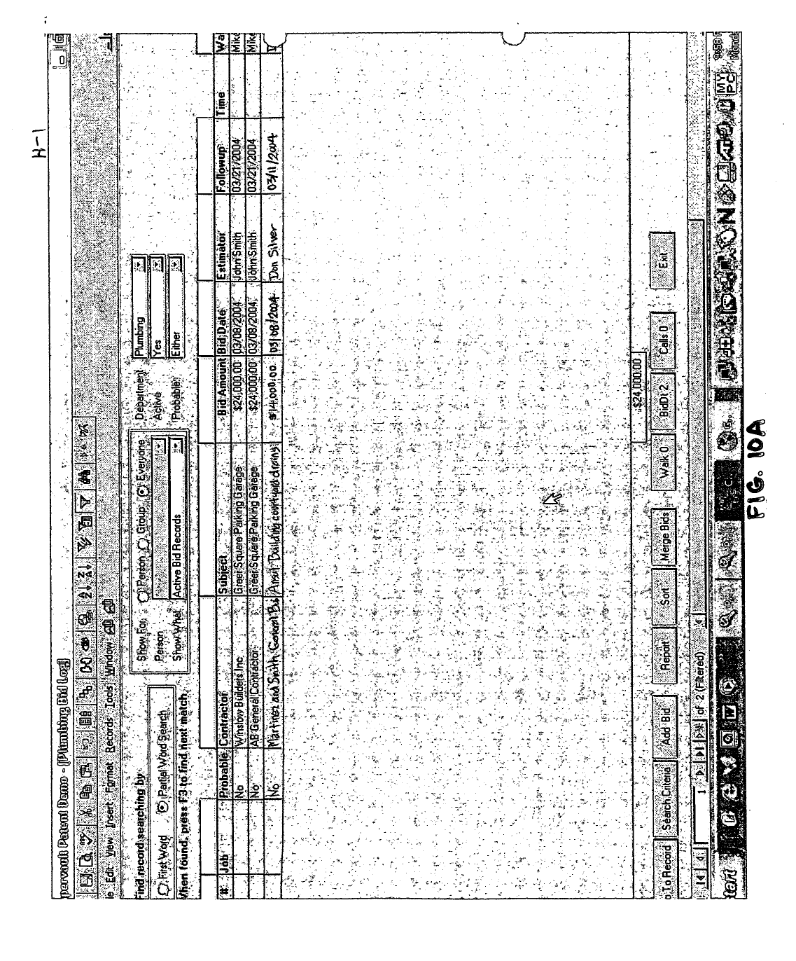

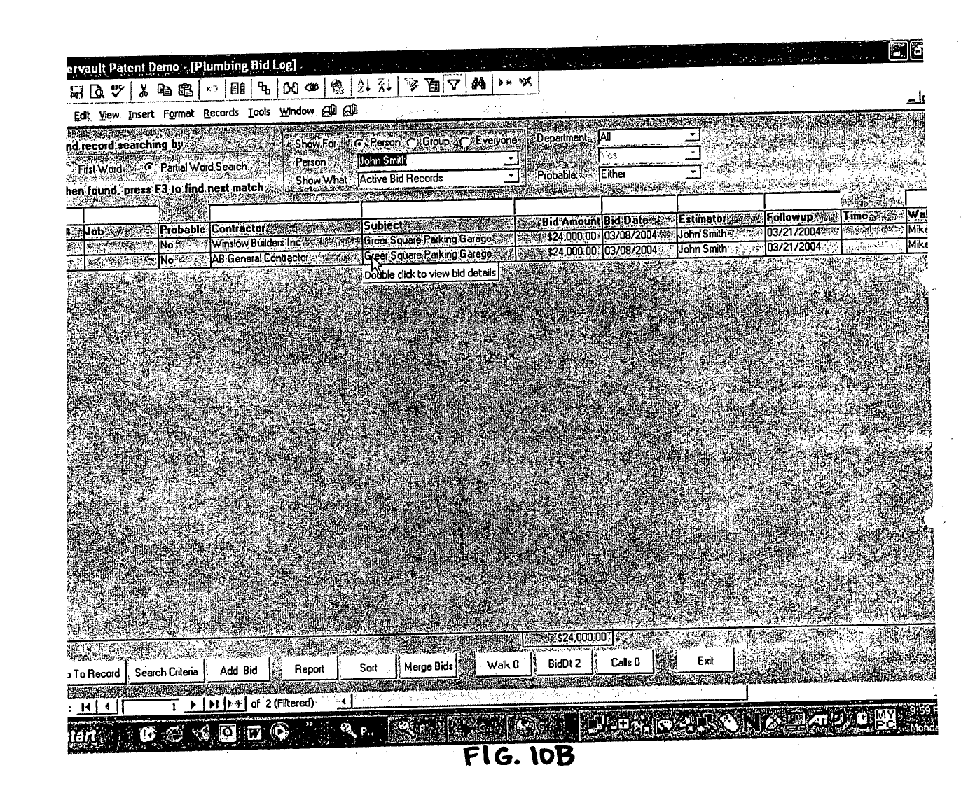

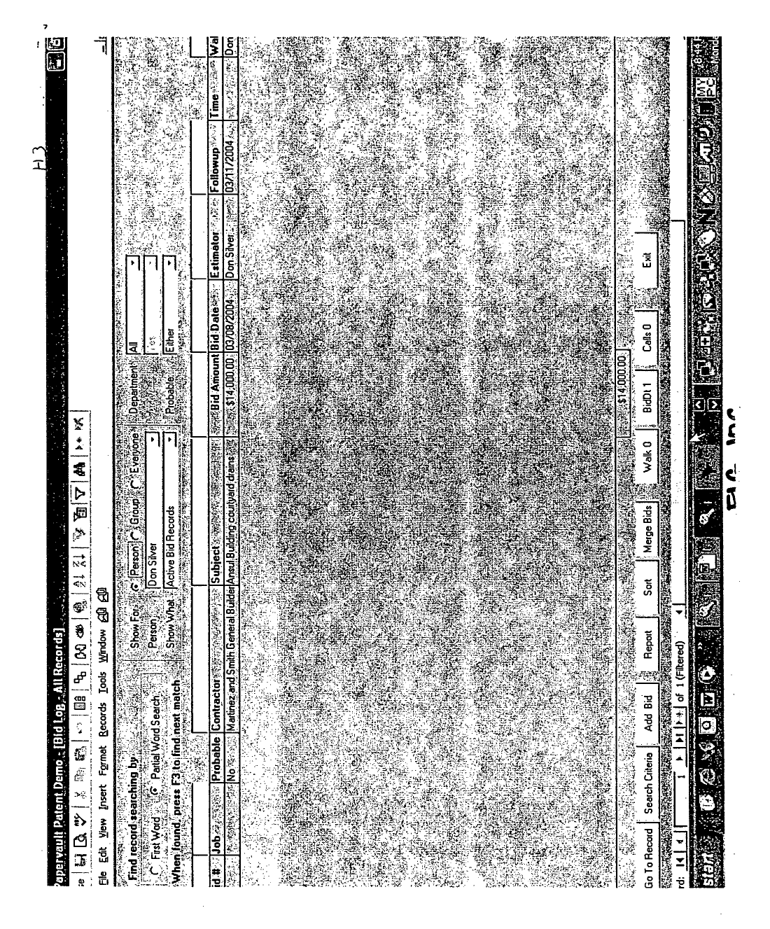

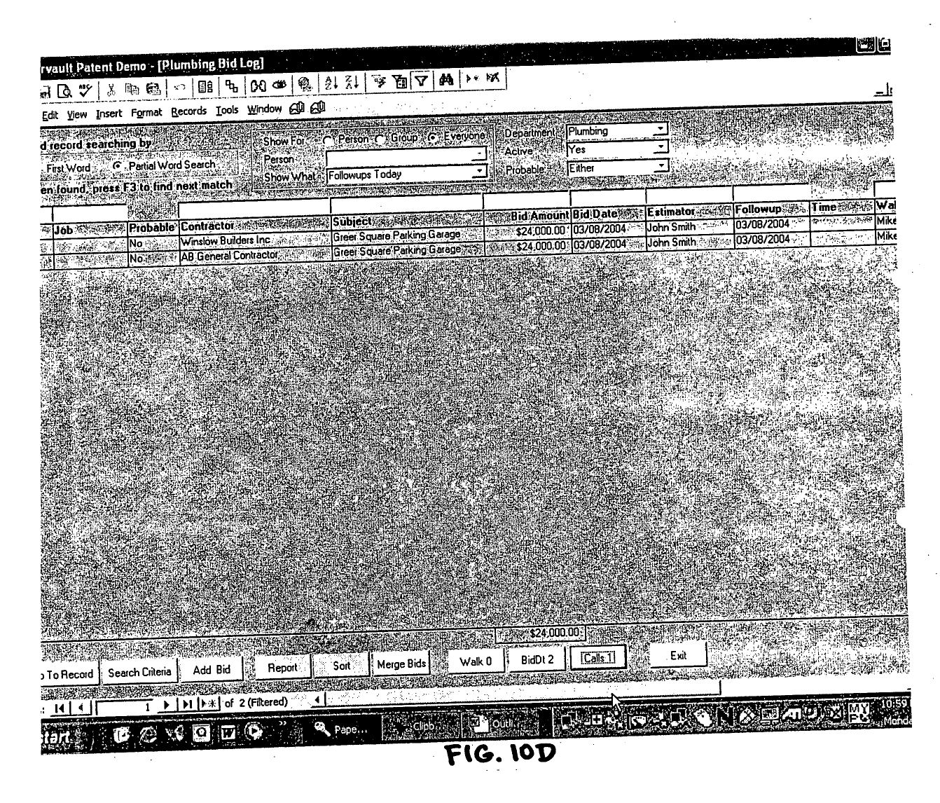

The program also provides a variety of specific interactive reports for login users, as shown by the illustrative screen images of FIG. 10.

FIG. 10A is a Plumbing Bid Log screen, which shows everyone and their active bid records.

FIG. 10B is a Plumbing Bid Log screen for John Smith, which shows his active bid records. Note the various counters along the bottom, which are specific to his bid tasks for this particular day. Counters are provided, for example, for walk-through, bids and follow-up calls to determine bid results. Notes can be kept and follow-up dates set or dates can be changes. The counters all respond as needed to assist the logon users.

FIG. 10C is a Plumbing Bid Log screen for Don Silver, which shows his active bid records. Note the counters at the bottom.

FIG. 10D is a Plumbing Bid Log screen filtered by today's follow ups listing calls to try to get bid results. Note that the Call counter is set at 1, which is because there is only one bid number involved, even though there are two customers to call.

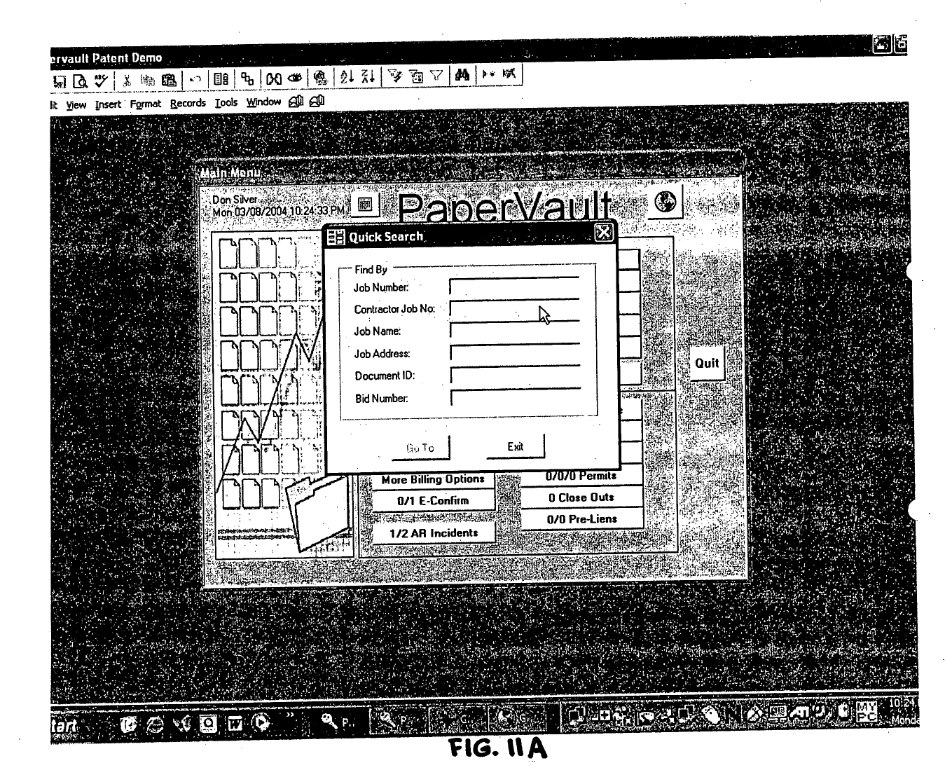

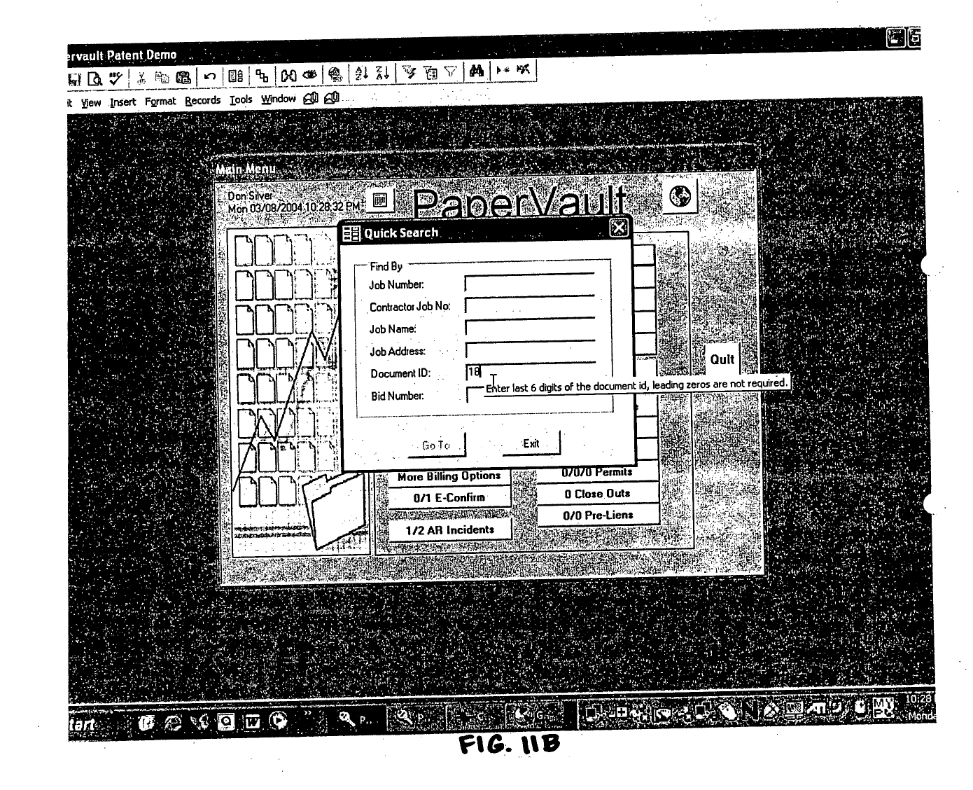

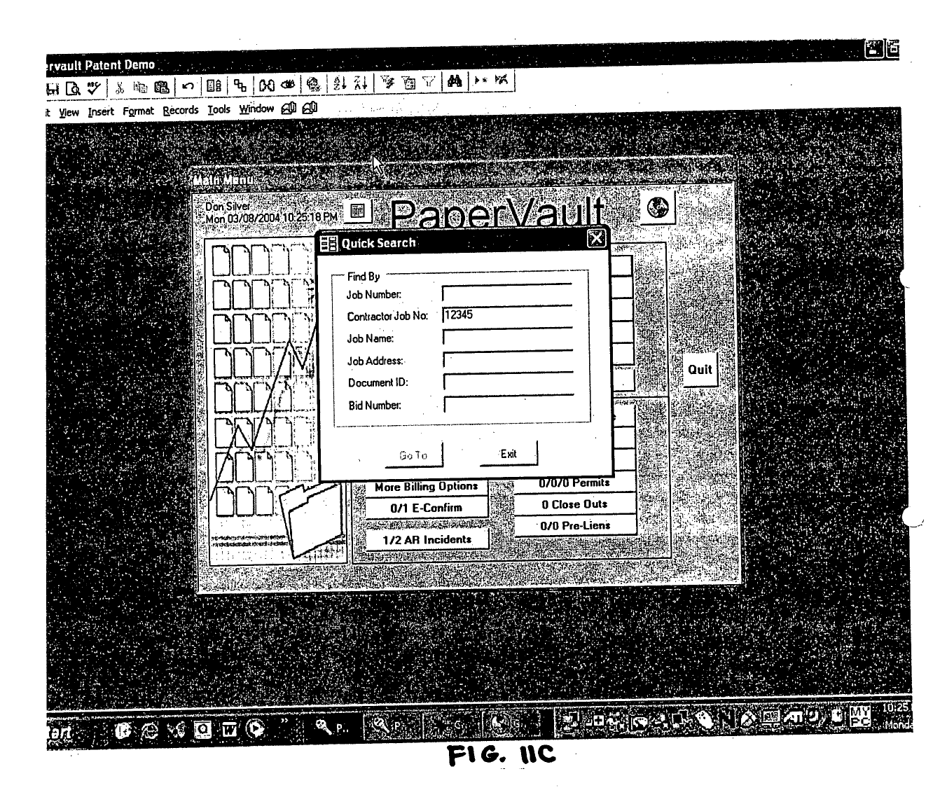

The program also provides a variety of quick search options, as shown by the illustrative screen images of FIG. 11.

FIG. 11A shows a Quick Search form in a popup window, which is obtained by selecting the Quick Search control in the Data Base Functions area.

FIG. 11B shows the form of FIG. 9A which contains a unique ID number entered by the user. Preferably, all new documents are assigned a unique ID number.

FIG. 11C shows that may also be conducted by contractor's job number. Other search criteria include job number and other methods.

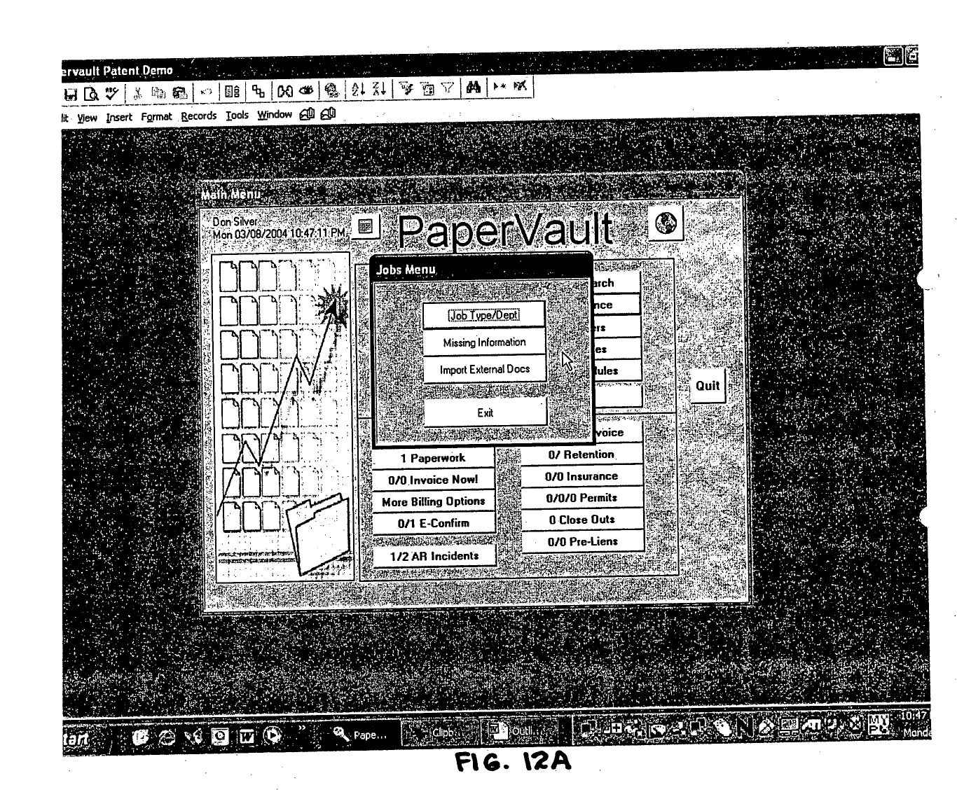

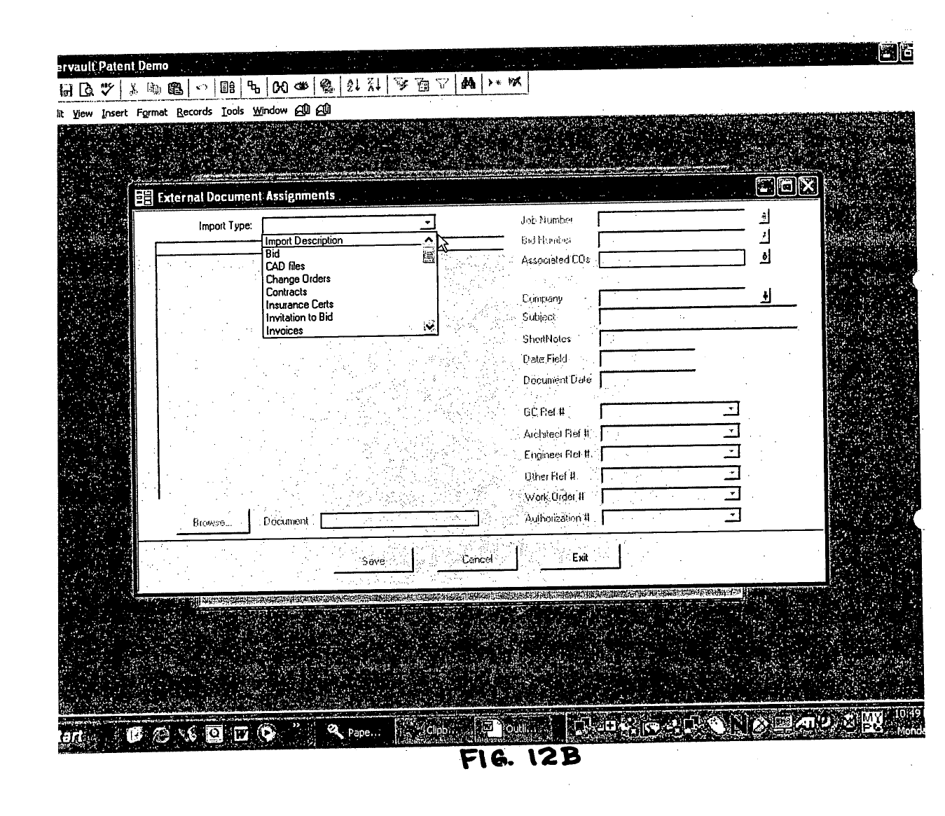

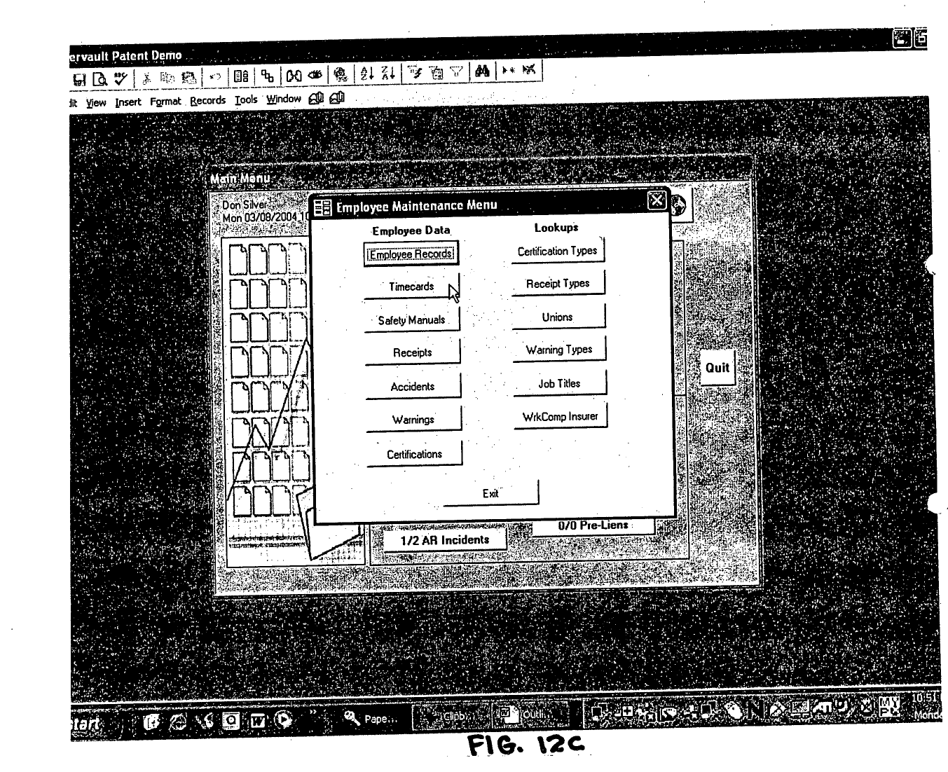

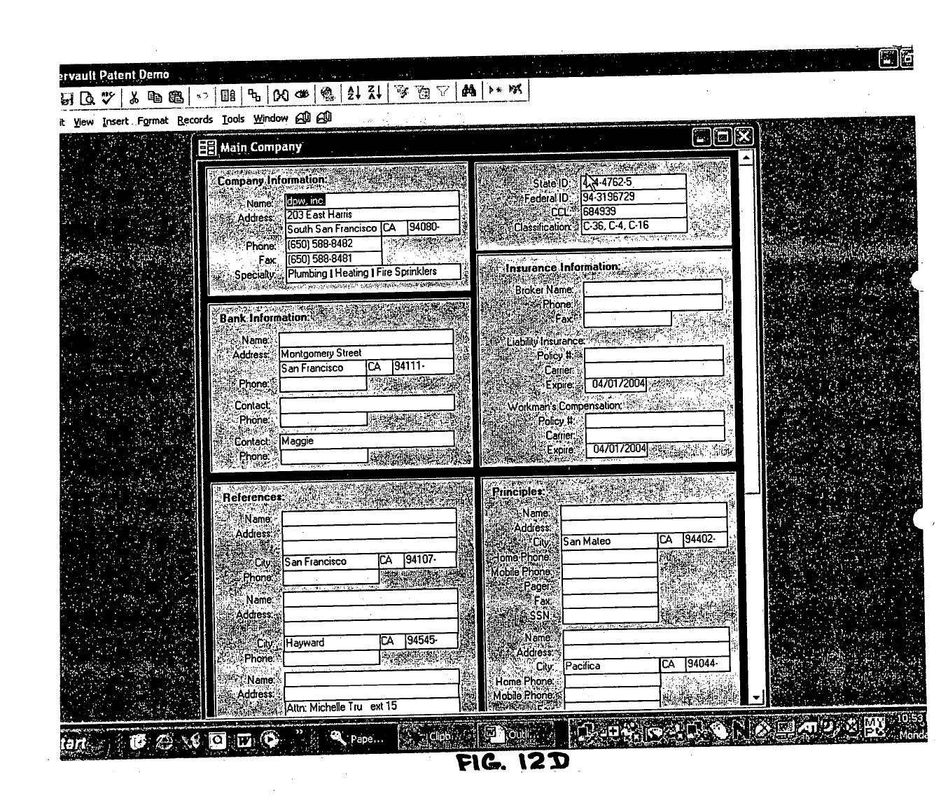

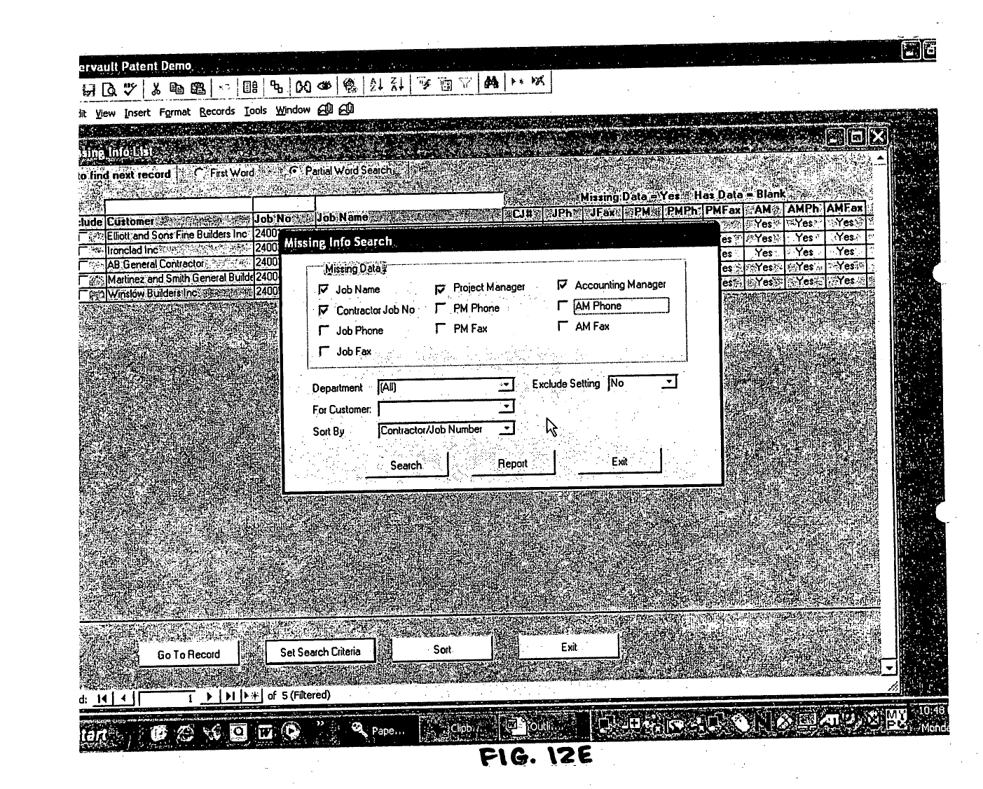

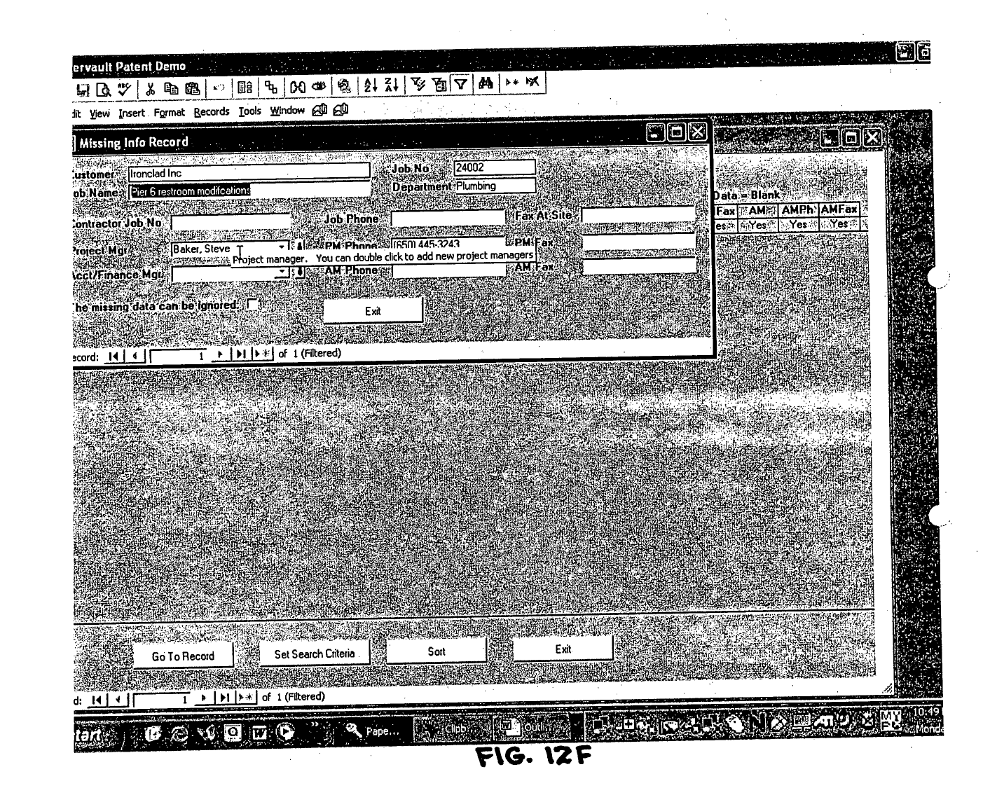

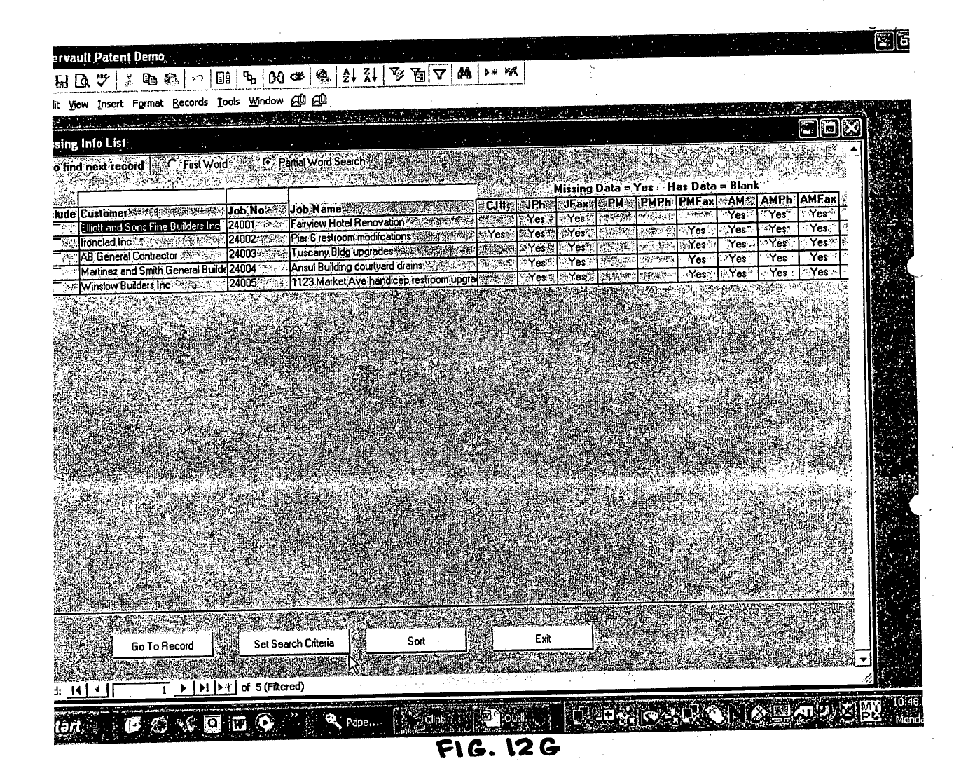

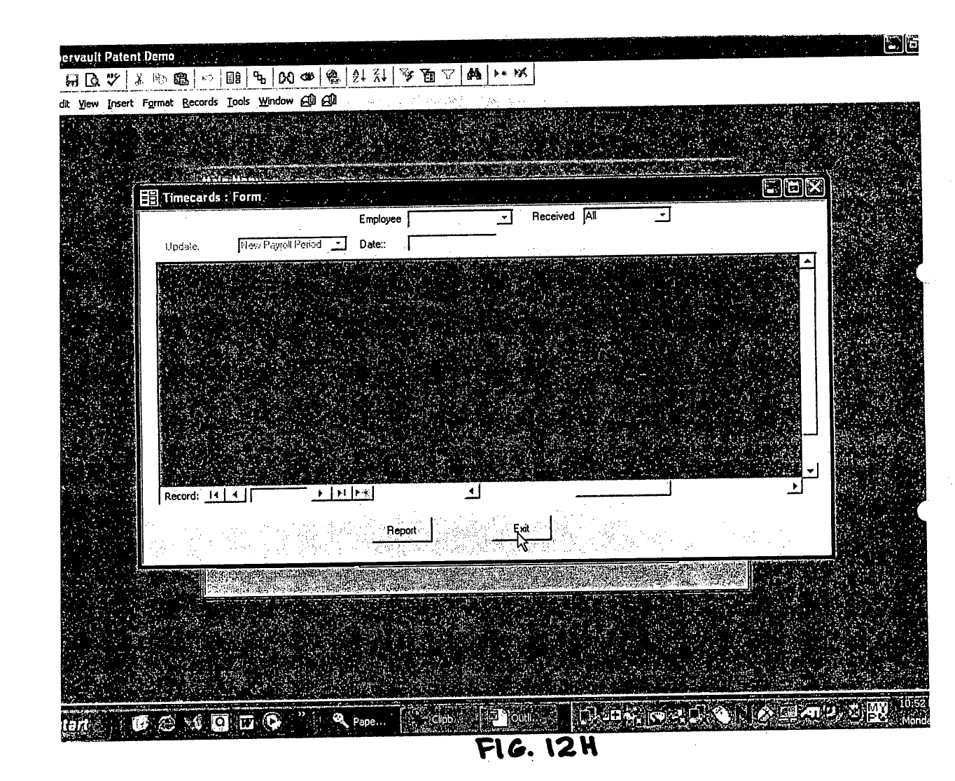

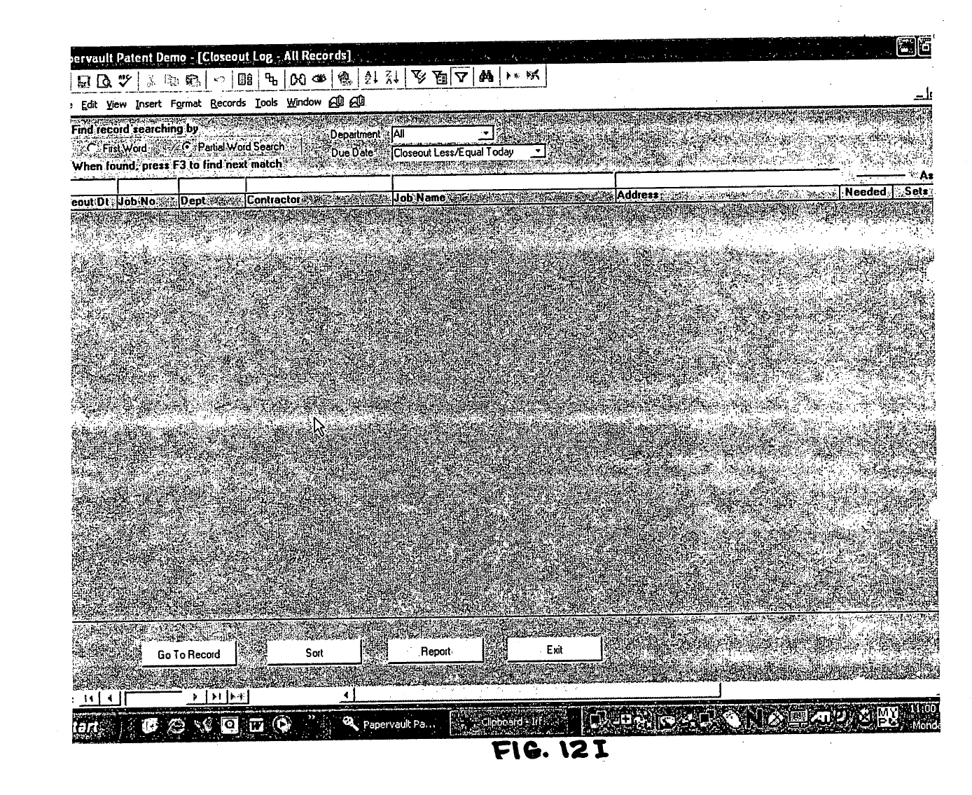

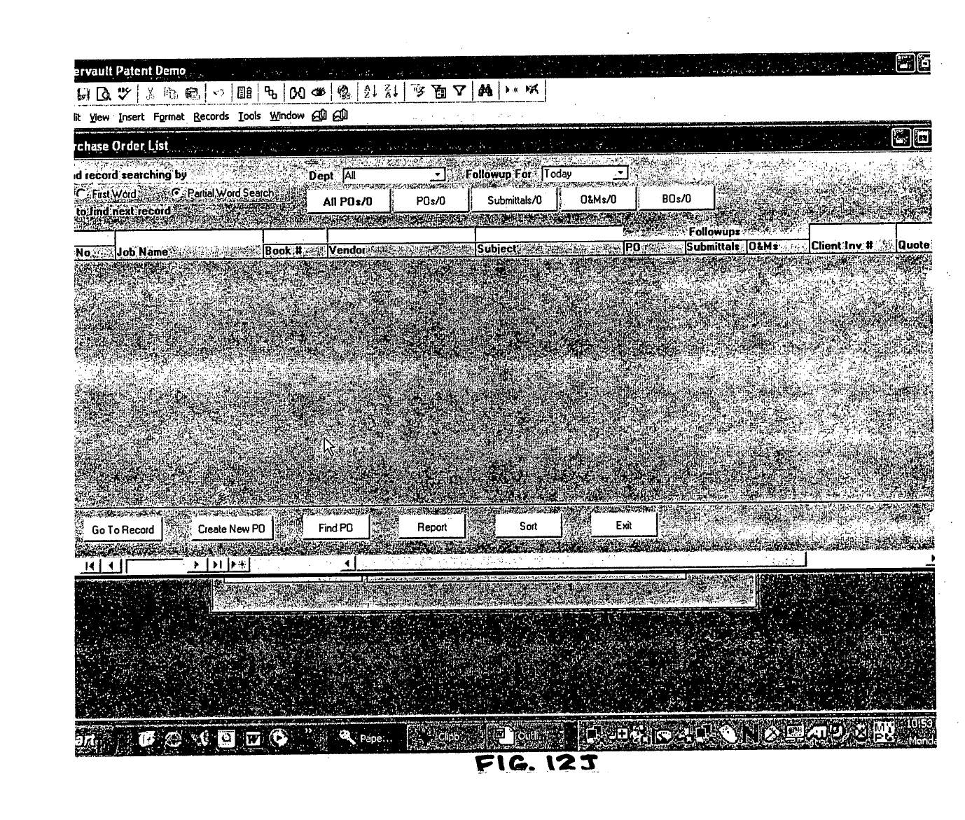

The program also provides for a variety of administrative functions, as shown by the illustrative screen images of FIG. 12.

FIG. 12A shows a screen having a Jobs Menu popup window resulting from selection of the Maintenance control in a Main Menu screen. Some of the possible functions provided for are the abilities to bring into the system scanned documents, to search for missing information at job screens, and to have an administrative person call and collect the missing information which is needed to properly mange the jobs. Labeled controls “Import External Docs,” “Missing Information,” and “Job Type/Dept” are provided for these functions.

FIG. 12B shows an External Document Assignments screen that results from selection of the Import External Docs control on the Jobs Menu. The screen allows the user to select a document type so that all documents in that folder are then displayed. Properties can be assigned and the document then saved.

FIG. 12C shows an Employee Maintenance Menu screen that results from selection of the “Employees” control in a Main Menu screen.

FIG. 12D shows a Main Company screen that results from selection of the globe icon control in the upper right of the Main Menu screen. This form is for the entry of company information.

FIG. 12E shows a Missing Info Search popup window that results from selection of the Missing Information control accessible from the Maintenance control in the Data Base Functions area. The user selects the type of information he wishes to verify. Much of the phone information is missing in this example.

FIG. 12F shows a Missing Info Record screen that results from the search. The screen has fields to fill in, and the information entered into this form is carried to the customer records for all to use.

FIG. 12G shows a Missing Info List that results from a particular search.

FIG. 12H shows a Timecards form, which is brought up through the Employees control of a Main Menu screen. This provides a method to track timecards and receipts to make sure the large crews have submitted them to allow payroll to do their work in a timely fashion.

FIG. 12I shows a Closeout Log screen resulting from selection of a Close Out control on a Main Menu screen. Closeout documents are tracked like other tasks.

FIG. 12J shows a Purchase Order List screen resulting from selection of a Purchase Orders control on a Main Menu screen. Purchase orders are tracked by vendor and job. Pickups and deliveries are created and monitored. Tools are accounted for in this area of the program as well.

Advantageously, many features of the program are consistently implemented and available throughout various screens of the program.

Emails may be sent right away or delayed. They can be edited for such purposes as more clarity or additional content.

All logs and lists may be sorted using the sort button, and also set for descending or ascending presentation.

Almost every screen can be captured using the task feature. Screen capture creates a document that can be assigned to one's self or to another, almost like an email, and a follow-up date can be set. When clicking the “go to record” button, the user is taken to the precise screen where the incident was “created from”. The user may start working at this point in the program.

Various task controls are included in the toolbar at the top of most of the screens. As illustratively shown in FIG. 10A, three controls are grouped together and positioned just above the text “Tools Window.” The leftmost, which has a large rectangle occupying the left half and a small triangle and two rectangles vertically arranged on the right half, causes a new task screen to be displayed. The middle, which has three small rectangles arranged diagonally, causes a list of all incomplete tasks to be displayed. The rightmost, which has two head profiles facing one another, causes a list of all tasks in the company to be displayed with their dependencies.

The Insurance area has a place to manage workers compensation claims and liability claims, and to print OSHA logs using information mined from the workers compensation information.

Email is stored at the job or bid record, instead of a normal “inbox.”

Additional advantageous and useful features include the following.
Any type of email template to be created so that a letter or email can be sent using any template. All of the fields in the program are available to place into the template. The fields will be filled in with specific info from the screens. These will look similar to the email confirmations.
A shop scheduling tool that allows for assigning drivers to pickup and deliver materials. These assignments are associated to the purchase orders, which in turn are connected to the jobs. Any pickup automatically requires a delivery to somewhere; the alternative is to drive around forever with the material. Deliveries for today, tomorrow, future and unscheduled may all be viewed. Dates can be provided for these assignments and counters respond accordingly
A tool tracking component is linked to the Purchase order. Tool and material request are sent to our office. When we place an order for materials the program knows the job number we are working with. We take advantage of this and assign major tools or other items that we are interested in tracking. We are able to quickly “tag” items from a structured (and easily modifiable) list. By tagging the items and then closing the screen, we can do easy searches later for any type of item within a certain time frame, by job, etc. It is an easy way to recall information such as” where are all the pipe threading machines? I know we have 10 of them but where did they all go? In this case the user simply searches for the tool from a drop down list and if desired, a date range can be entered and a list is provided of all the locations where the tool was sent. We allow for a tool category such as ladders, sub-categories such as 6′ and 8′ ladders and tracking or serial numbers can be created if desired. Searches can locate items based on any of these criteria.
When we need to do a job cleanup or remove everything from a job after we have completed our work, we can view or print a tool list and make sure we get the important items back to the shop. It is easy to lose ladders, threaders, gang boxes, and other tools when working on a large number of jobs each year. This is especially true in high rise buildings where we may be working on many jobs on different floors over the course of a year.

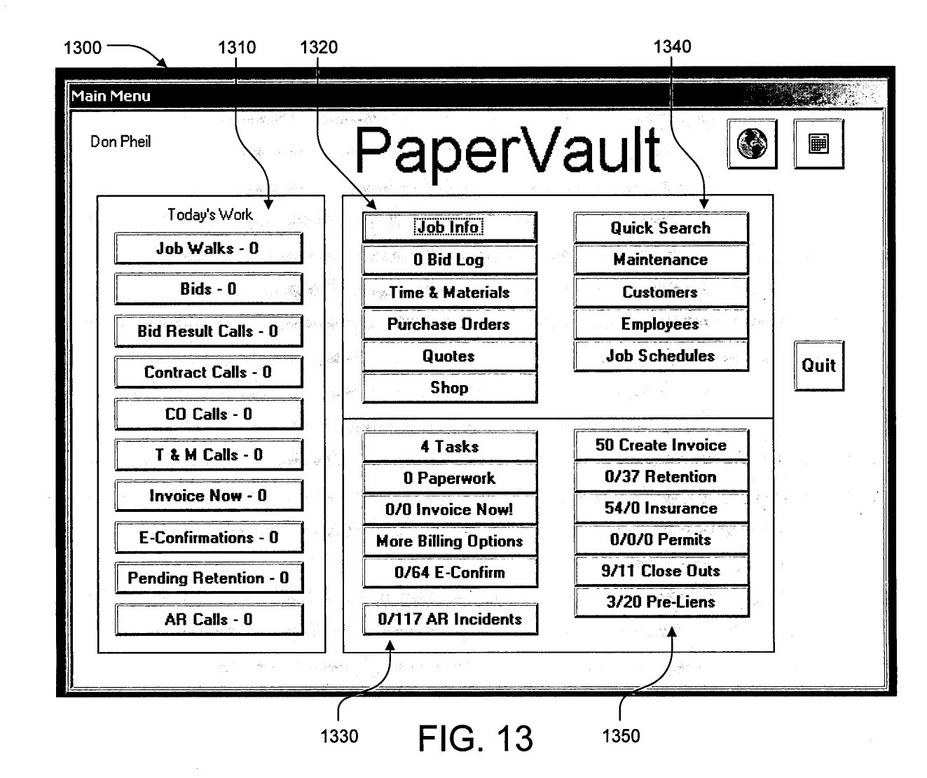

FIG. 13 is a screen image of a Main Menu screen 1300 having a Today's Work Summary Area 1310, in addition to four specific operational areas such as those discussed previously, namely Bids & Jobs area 1320, Project Administration area 1330, Data Base Functions area 1340, and Office Administration area 1350. The Work Summary Area 1310 collects together and displays those counters and controls that allow the logged-on user to conveniently and quickly visualize all work requiring that user's attention during a particular time period, illustratively on the log in day. Moreover, the controls associated with the counters allow the logged-on user direct and quick access to specific tasks, in some cases without the need to navigate through other screens.

The counters and controls (illustratively buttons) in the Work Summary Area 1310 generally relate to personal tasks that are scheduled to be performed by the logged-on user acting in his assigned job capacity or capacities, usually within a particular time period. Although other types of counters and controls may be displayed in the Work Summary Area if desired, this is not preferred because it may detract from the usefulness of the Work Summary Area. One approach is to display a standard set of counters and controls suitable for all major job capacities, such as estimator, project manager, and billing clerk, wherein a zero value is displayed on counters that are not relevant to the logged-in user or to his job capacity or capacities. Another approach is to display a set of counters and controls that is specific to the logged-on user as an individual and in accordance with his job capacity or capacities. Counters and controls irrelevant to the logged-on user simply are not displayed. In any event, the counters and controls in the Work Summary Area 1310 may correspond to counters and controls on any of the various task-specific screens of the user interface, as well as to counters and controls on the Main Menu screen 1300 itself to facilitate the display of particular information and activation of the particular functionality.

A counter in the Work Summary Area 1310 may correspond to a single counter for a personal task or to the left counter of a dual counter for a personal task. In other instances, a counter in the Work Summary Area 1310 may correspond to the left counter of a dual counter for an administrative task, where the left counter is personal to the logged-on user but dependent on completion of administrative tasks whose number is reported in the right counter. Other correspondences are possible as well, depending on how counters are used elsewhere in the user interface.

Following is a description of the illustrative set of counters and controls, illustratively buttons, shown in the Work Summary Area 1310 of FIG. 13.

On any particular day, activities such as walk-throughs, bid tasks, and bid follow-up calls may be required. The logged-on user can conveniently and directly visualize these tasks from counters in the Today's Work area 1310, namely the Job Walks counter, the Bids counter, and the Bid Result Calls counter. Moreover, the logged-on user can use the associated buttons to quickly and directly display the relevant list windows for further action. Alternatively, the logged-on user may access corresponding counters Walk, BidDt, and Calls in the Plumbing Bid Log screen shown in FIG. 3A through the Bid Log button in the Bids & Jobs area 1320 of the Main Menu screen 1300. The counter associated with the Bid Log button is the sum of these three counters.

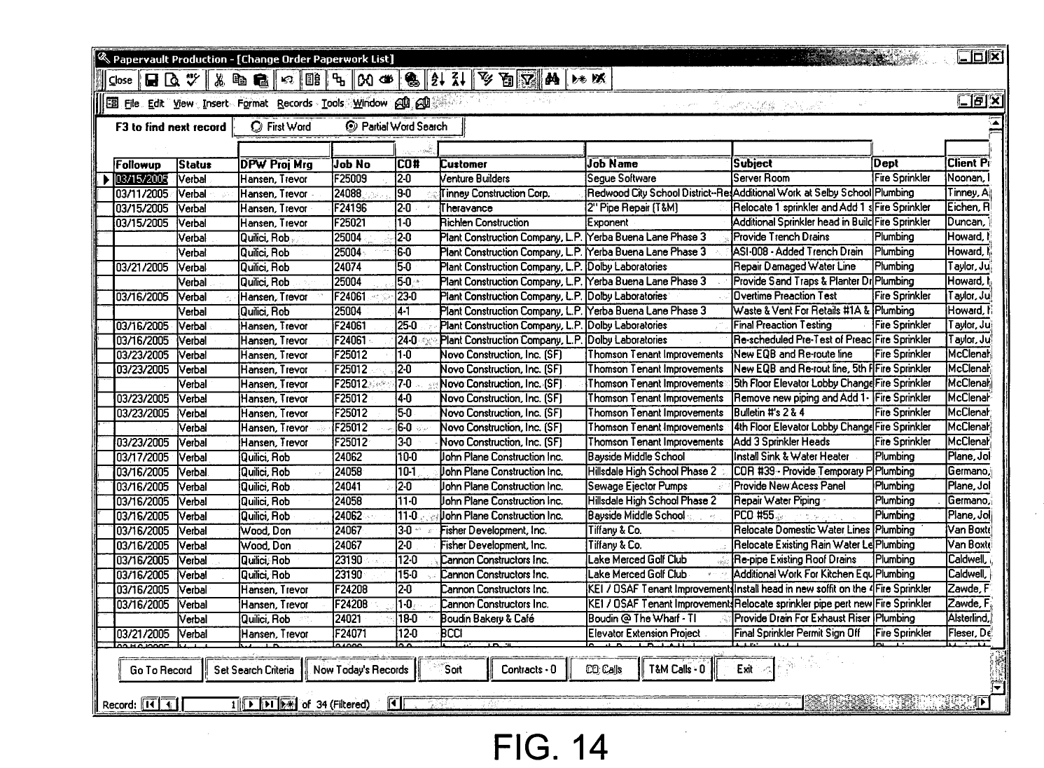

On any particular day, calls may be required to follow up on completion of contract documentation (Contract Calls), completion of change order documentation (CO Calls), and determination of unresolved time and materials billings (T&M Calls). The logged-on user can conveniently and directly visualize these tasks from counters in the Today's Work area 1310, namely the Contract Calls counter, the CO Calls counter, and the T&M Calls counter. Moreover, the logged-on user can use the associated buttons to quickly and directly display the relevant list windows for further action. Alternatively, the logged-on user may access corresponding counters Contracts, CO Calls, and T&M Calls in the Change Order Paperwork List shown in FIG. 14 through the Paperwork button in the Project Administration area 1330 of the Main Menu screen 1300. The counter associated with the Paperwork button is the sum of these three counters.

The Invoice Now counter in the Today's Work area 1310 corresponds to the left counter of the Invoice Now! control in the Project Administration area 1330, which is the number of jobs the logon user must bill three days out (where the logon user is a responsible billing person), or the number of jobs requiring a review of change orders before they can be billed (where the logon user is a project manager).

The E-Confirmations counter corresponds to the left counter of the E-Confirm control in the Project Administration area, which is the number of items requiring email confirmation by the logon user.

The Pending Retention button corresponds to the left counter of the Retention button, which is personal to the project manager and indicates the number of jobs that could be retention-billed were it not for pending, verbal, or OK to bill change orders. These basically are items that are not complete with regard to paperwork. The right counter of the Retention button is the number of jobs requiring retention billing, which is an administrative task.

The AR Calls counter corresponds to the left counter of the AR Incidents control in the Project Administration area 1330, which is the number of items requiring account receivable follow-up calls by the logon user.

E-confirmations is the generation of an email, filled in with topic specific information, after certain processes have been done. Illustrative processes for generating automatic email include (a) setting a change order to “verbal;” (b) receiving verbal permission to bill a change order; and (c) confirming a new job. When we set a change order to “verbal,” upon exit of that screen, an email presents itself with change order specific information. The text may be reviewed and modified, and the sending may be delayed to a later date or canceled altogether. When we receive verbal permission to bill a change order but have not yet actually received the written change order, an email presents itself to confirm the conversation and remind the party that we expect to be paid for the item. Normally the item is not billed until the written change order is generated. When we are called and told to start a new job and the contract will be issued soon, we setup the new job and upon exit of the job screen we are prompted by an email screen to send out a confirmation. In the confirmation we also request insurance requirements for the job and modify the default text if needed.

The description of the invention and its applications as set forth herein is illustrative and is not intended to limit the scope of the invention. Variations and modifications of the embodiments disclosed herein are possible, and practical alternatives to and equivalents of the various elements of the embodiments are known to those of ordinary skill in the art. These and other variations and modifications of the embodiments disclosed herein may be made without departing from the scope and spirit of the invention.

1. A system for managing tasks required of a trade subcontractor in the construction industry, the trade contractor having a plurality of users, the system comprising:
means for furnishing a plurality of bids for a job to a plurality of contractors;
means for, upon acceptance of one of the plurality of bids by one of the contractors, converting the accepted bid to a job;
means for generating the tasks in response to the conversion of the accepted bid into the job;
means for associating each of the tasks with one of the users on the basis of the user's identity and job capacity;
means for maintaining a plurality of counters for each of the users of the tasks associated therewith in respective task categories;
means for displaying to each of the users when logged on the counters maintained therefor, in association with respective controls for the respective task categories;
means for displaying to each of the users when logged on the total number of tasks in the respective task categories, in association with the respective controls for each of the task categories;
means for furnishing a list to the logged on user of the tasks associated therewith in one of the task categories, in response to selection of the control therefor;
means for providing a capability to the logged on user to act upon the list furnished thereto in the list furnishing step; and
means for adjusting the counter for the logged on user upon action thereby on the list furnished thereto.

2. A user interface for facilitating management of tasks required of a trade subcontractor in the construction industry by various users associated with the subcontractor, the user interface having a main menu with a Bids and Jobs area, a Project Administration area, and an Office Administration area and comprising:
a bid log control disposed in the Bids and Jobs area for managing a log of bids and converting successful ones of the bids into jobs, a first one of the counters being a number of active bids based on identity of a first user, and the first counter being associated with the bid log control;
a billing control disposed in the Project Administration area for initiating progress billings for the jobs, a second one of the counters being a number of jobs requiring billing during a particular time period based on identity of a second user, a third one of the counters being a number of jobs requiring billing during a particular time period for the trade subcontractor, and the second and third counters being associated with the billing control;
an invoicing control disposed in the Office Administration area for invoicing progress billings for the jobs, a forth one of the counters being a number of jobs requiring invoicing during a particular time period, and the fourth counter being associated with the invoicing control;
a retention control disposed in the Office Administration area for invoicing retention billings for the jobs, a fifth one of the counters being a number of jobs requiring retention invoicing during a particular time period, and the fifth counter being associated with the retention control; and
a close out control disposed in the Office Administration area for closing out jobs, a sixth one of the counters being a number of jobs requiring close out during a particular time period, and the sixth counter being associated with the close out control.

3. A user interface for facilitating management of tasks required of a trade subcontractor in the construction industry by various users associated with the subcontractor, the user interface having a main menu with a Bids and Jobs area, a Project Administration area, and an Office Administration area and comprising:
a bid log control disposed in the Bids and Jobs area for managing a log of bids and converting successful ones of the bids into jobs, a first one of the counters being a number of active bids based on identity of a first user, and the first counter being associated with the bid log control;
a confirming correspondence control disposed in the Project Administration area for initiating sending of correspondence confirming the conversion of the successful bids into the jobs, a second one of the counters being a number of confirming correspondence requiring sending during a particular time period based on identity of a second user, a third one of the counters being a number of all confirming correspondence requiring sending during a particular time period for the trade subcontractor, and the second and third counters being associated with the confirming correspondence control;
an insurance control disposed in the Office Administration area for initiating insurance applications for the jobs, a forth one of the counters being a number of jobs requiring new insurance applications during a particular time period, a fifth one of the counters being a number of incomplete insurance applications during a particular time period, and the fourth and fifth counters being associated with the insurance control;
a permits control disposed in the Office Administration area for initiating permit applications for the jobs, a sixth one of the counters being a number of jobs requiring new permit applications during a particular time period, a seventh one of the counters being a number of incomplete permit applications requiring check numbers during a particular time period, an eighth one of the counters being a number of incomplete permit applications requiring permit numbers during a particular time period, and the sixth and seventh and eighth counters being associated with the insurance control; and
a pre-liens control disposed in the Office Administration area for initiating pre-lien documents for the jobs, a ninth one of the counters being a number of jobs requiring new pre-lien documents during a particular time period, a tenth one of the counters being a number of incomplete pre-lien documents during a particular time period, and the ninth and tenth counters being associated with the pre-lien control.
